(19) United States
(12) Patent Application Publication
(10) Pub. No.: US 2025/0206354 A1
(43) Pub. Date: Jun. 26, 2025

(54) SAFE AND SCALABLE MODEL FOR CULTURALLY SENSITIVE DRIVING BY AUTOMATED VEHICLES USING A PROBABILISTIC ARCHITECTURE

(71) Applicant: Mobileye Vision Technologies Ltd., Jerusalem (IL)

(72) Inventors: John Weast, Portland, OR (US); Ignacio J. Alvarez, Portland, OR (US); Maria Soledad Elli, Hillsboro, OR (US); Tal Serphos, Jerusalem (IL)

(73) Assignee: Mobileye Vision Technologies Ltd., Jerusalem (IL)

(21) Appl. No.: 18/847,546

(22) PCT Filed: Apr. 10, 2023
(86) PCT No.: PCT/IB2023/053639

§ 371 Date: Sep. 16, 2024

Related U.S. Application Data
(60) Provisional application No. 63/329,092, filed on Apr. 8, 2022.

(51) Int. Cl. B60W 60/00; B60W 30/095; B60W 50/00; G06F 17/18

(52) U.S. Cl. CPC B60W 60/00276; B60W 30/095; B60W 60/0011; G06F 17/18; B60W 2050/0028; B60W 2554/4041; B60W 2556/20

(57) ABSTRACT

The invention relates to a method and system which determine certainty, e.g. an aleatoric certainty score, as well as an uncertainty score, e.g. an epistemic uncertainty, based on input data. The input data includes static and dynamic data. A trained behavioral model generates trajectory predictions and the certainty and uncertainty score. A vehicle-based function is controlled based in the certainty score and the uncertainty score, e.g. increase following distance or hand over to a human driver.

### CROSS-REFERENCE TO RELATED APPLICATIONS

The present application claims priority to and the benefit of U.S. provisional application No. 63/329,092, filed on Apr. 8, 2022, the contents of which are incorporated herein by reference in their entirety.

### TECHNICAL FIELD

Aspects described herein generally relate techniques implementing behavioral modeling to apply culturally sensitive behavioral tuning to driving policies implemented by autonomous vehicles (AVs) and, more particularly, to the use of probabilistic machine learning model training and implementation to perform trajectory estimation and planning as part of such driving policies.

### BACKGROUND

Driving safely is cultural. For example, human drivers in New York drive differently than human drivers in Iowa. Aside from safety, a main challenge for the widespread deployment of Automated Vehicles (AV's) is cultural acceptance. Popular opinion is strongly against the deployment of AVs, and a significant factor in that reluctance is a concern that AVs drive like brainless robots as opposed to local human drivers. In other words, the ability to scale AVs globally is critically related to the ability of AVs to adapt their driving behavior in a way that is considered culturally acceptable in the area in which the AV is operating.

### BRIEF DESCRIPTION OF THE DRAWINGS/FIGURES

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

FIGS. 1A and 1B illustrate two state of the art approaches for creating behavioral models.

FIG. 2 illustrates an example overview of local behavioral modeling system, in accordance with one or more aspects of the present disclosure.

FIG. 3 illustrates additional details of an example local behavioral modeling system, in accordance with one or more aspects of the present disclosure.

FIG. 4 illustrates an example maneuver sequence process used as part of a local behavioral modeling system, in accordance with one or more aspects of the present disclosure.

FIGS. 5A-5B illustrate an example behavioral model input/output diagram, in accordance with one or more aspects of the present disclosure.

FIG. 6 illustrates an example maneuver taxonomy state diagram, in accordance with one or more aspects of the present disclosure.

FIG. 7 illustrates an example of Lanelet elements in a map with attributes including regulatory elements and allowed maneuvers, in accordance with one or more aspects of the present disclosure.

FIGS. 8A and 8B illustrate an example visual representation of an example behavioral model graph dataset, in accordance with one or more aspects of the present disclosure.

FIGS. 9A and 9B illustrate example API querying processes for extracting data from a stored behavioral model graph dataset, in accordance with one or more aspects of the present disclosure.

FIG. 10 illustrates an example of an ensembling process, in accordance with one or more aspects of the present disclosure.

FIG. 11 illustrates an example of a computing device, in accordance with one or more aspects of the present disclosure.

FIG. 12 illustrates an example of another computing device, in accordance with one or more aspects of the present disclosure.

FIG. 13 illustrates an example vehicle in accordance with one or more aspects of the present disclosure.

FIG. 14 illustrates various example electronic components of a safety system of a vehicle, in accordance with one or more aspects of the present disclosure;

FIG. 15 illustrates an example trajectory maneuver computational process, in accordance with one or more aspects of the present disclosure.

FIG. 16 illustrates an example trajectory and maneuver analysis flow, in accordance with one or more aspects of the present disclosure.

FIGS. 17A-17C illustrate an example of the limitations of conventional deep learning systems.

FIGS. 18A-18B illustrate an example of misclassified model predictions and an accompanying uncertainty map, in accordance with one or more aspects of the present disclosure.

FIG. 19 illustrates an example flow for generating certainty and uncertainty scores, in accordance with one or more aspects of the present disclosure.

FIG. 20 illustrates an example behavioral cloning model, in accordance with one or more aspects of the present disclosure.

FIG. 21 illustrates an example ensemble process that may be implemented by a trained behavioral model, in accordance with one or more aspects of the present disclosure.

FIGS. 22A-22B illustrate the difference in performance of a trained behavioral model utilizing feedback provided via the uncertainty score, in accordance with one or more aspects of the present disclosure.

FIGS. 22C-22D illustrate the difference in performance of trained behavioral models providing accurate predictions, in accordance with one or more aspects of the present disclosure.

FIGS. 22E-22F illustrate the difference in performance of trained behavioral models providing inaccurate predictions, in accordance with one or more aspects of the present disclosure.

FIG. 23 illustrates an example process flow, in accordance with one or more aspects of the disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

### I. Culturally-Sensitive Behavior Model Training and Implementation

Again, current AV systems have failed to adequately mirror human behavior in a manner that reflects local driving behaviors across different regions and cultures. Depending on the approach employed in the development of the AV decision logic, adaptations to cultural norms can vary from difficult (for parametric/rule-based systems) to almost impossible (in the case of data-learned dependencies) due to the exponential nature of hyper-parameter tuning. This is unsurprising, as even for human drivers adapting their driving style when travelling is challenging, as their own judgement must discern (and interiorize) what other drivers do and what is considered “normal.”

Different local driving styles also impact the conditions under which AVs operate, introducing different safety challenges in each geolocation. Modeling the differences in driver behaviors between different regions can also lead to a simpler analysis of system failure rates and more accurate predictions of geo-specific performance levels. Conventional attempts to achieve this include localized testing and fine tuning. Such approaches perform test/trial deployments, during which AV developers make first hand observations about the response of human drivers (as well as vulnerable road users) to the AV, and then make manual adjustments to the driving policy algorithms to mimic human driver behavior to better fit in with human drivers on the roads in that specific area in which they are testing.

However, such localized testing and fine tuning techniques are not scalable, as understanding the differences in various locations can only occur after practical deployment. Thus, localized testing and fine tuning cannot perform efficient planning for “simpler” deployment locations. For instance, assume that after 2 years an AV that has been tested on the road is now sufficiently optimized to fit in with human drivers and drive like everyone else in a specific area. To deploy the AV anywhere else (or at least anywhere else with sufficiently different driving behavior) the training process must be repeated, with the same expensive AV test fleet, and with all of the same time-consuming modifications. And even if the process could be optimized and take only 6 months instead of 2 years, this still requires pre-deployment of the AV to a new area along with safety drivers and engineers to manually learn the new driving style of people in the new area, who may not drive the same as people in the previous area.

Another conventional attempt to perform regional AV model training includes the use of machine learning techniques such as Reinforcement Learning (RL), in which reward functions are specified, a goal to learn is determined, and/or the behavior of the AV is dynamically adjusted to match the local behavior patterns, with the idea that in doing so the AV will learn to how to drive like a local based on observed behavior. However, this process involves training using large amounts of observations, which usually needs to be repeated when locations exhibit different behavioral distributions, when behaviors are not existent in the original training dataset, or when contextual cues (e.g. signs, road markings, etc.) are significantly different than in the original dataset.

Moreover, RL based approaches for learning from humans are notoriously problematic. On one hand, RL needs interaction with the environment to learn a policy for a particular case (i.e. a geographical region), and therefore, interaction with a representative set of real human drivers is needed. Moreover, interaction with the “real world” may also present its own dangers if a baseline driving policy is different from real human driver, which may lead to causing accidents to occur before the driving policy ‘learns’ enough to do better. In some cases, simulation can help in this aspect by adding Human-in-the-loop simulation into the RL training pipeline, in which the policy is learned via human interaction (learning by demonstration). This approach is also referred as “off-policy” RL. However, these approaches suffer from the same problems as mentioned before, i.e. the policy has to be trained by a representative portion of the population from each geolocation where the AV will be deployed.

On the other hand, when the policy continues to be updated with each interaction with the environment, namely on-policy RL, the problem now becomes that the policy learning cannot be done in a controlled manner and, therefore, the “teachers” (i.e. interactions with the environment) simply cannot be trusted at all times. The problem with on-policy RL approaches is with respect to a trust that the “teachers” will be altruistic and will not try to game the system. When human drivers know they are dealing with an AV (which likely they will due to special license plates or visual identifiers), people may try to game the AV for maximum advantage: cutting off the AV much more than they would a normal human driver, stepping in-front of the AV as a vulnerable road user much more than a vulnerable road user ever would if it were a human driven car, etc.

Thus, none of the current approaches have been sufficient to enable widespread global scalability of AVs without significant cost and expense. Therefore, to address these issues, the aspects described herein utilize techniques to derive local driving behaviors from naturalistic data, which are then incorporated as guidance into the behavioral layer of an AV for adaptation to local traffic. Moreover, the local driving behaviors are implemented into the AV performance validation process. Furthermore, techniques are disclosed for scaling this process via automatic crowdsourced behavioral data aggregation from human-driven vehicles and map information. Still further, the creation of a spatial-behavioral relational database is disclosed that provides interfaces for efficiently querying geo-bounded local driving information, enabling customization of automated vehicle driving policies to local norms, and enabling traffic behavior analysis.

To do so, and as further discussed below, the aspects described herein extract behavioral characteristics in a defined area (e.g. geo-fenced, roadway type, etc.) and combine the behavioral characteristics with the safety guarantees of a safety behavioral model (also known as a safety driving model or SDM, as further discussed below), providing the observed behavioral characteristics as input to the driving policy to apply culturally-sensitive behavioral tuning without violating safety guarantees.

In accordance with the aspects further described herein, the behavioral modeling may be achieved by a variety of methods. One such method is by leveraging crowdsourced data, such as the data gathered by many (e.g. millions) of human driven vehicles on the road today. Another method is to leverage telematics information obtained by insurance companies or other providers who precisely monitor the driving style of their drivers. With such methods, a model may be trained offline without risk of malicious intent, and to understand what the acceleration, braking, steering, and other temporal-related characteristics that define a pattern of “normal” driving in a certain location, or even more precisely a specific road type or segment in a specific location.

By using the resulting driving style model (using geographical or road type segmentation) inputs can be provided into the behavioral layer of an AV's particular driving policy, so that the AV will be able to take input (in the form of constraints or suggestions) in such a way that the resulting motion planning will resemble a local driver from the moment it hits the road—even without any actual “driving experience” of the AV in that location. Thus, the aspects described herein, which may model driving behavior from crowdsourced data, enable pre-deployment evaluation of system performance in different locations as well as a geo-specific definition of comfort driving. The aspects described herein thus promote rapid deployment by identifying the safest locations to deploy and drive in those locations in a locally defined manner from the initial deployment of the AVs.

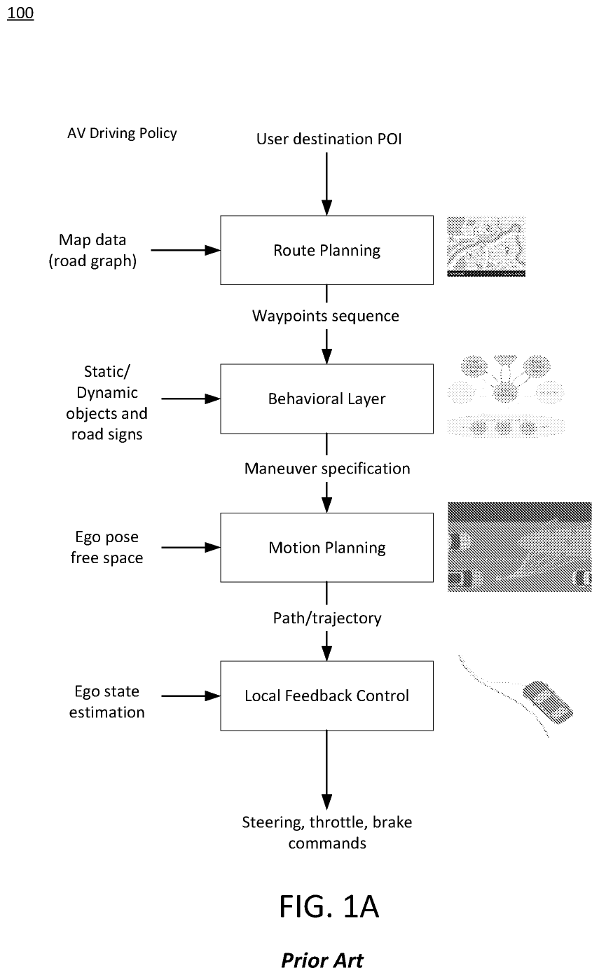

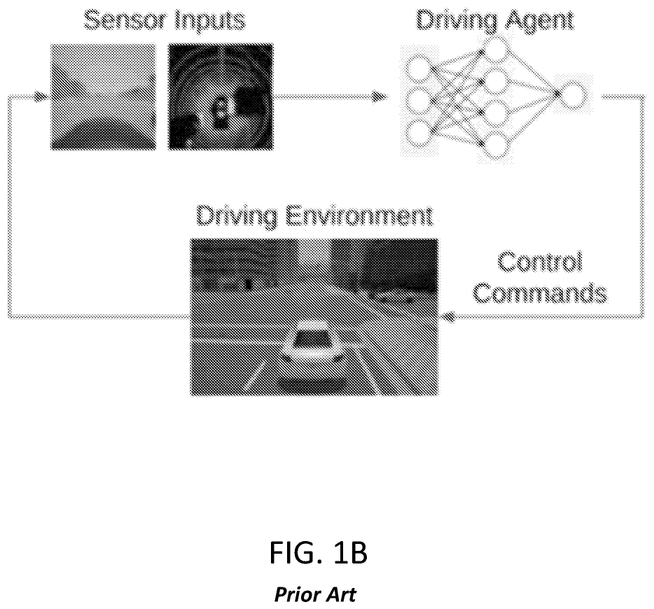

FIGS. 1A and 1B illustrate two state of the art approaches for creating behavioral models. In the approach shown in FIG. 1A, a behavioral model is created using a hierarchically-structured AV system approach with route planning, behavioral decision making, local motion planning, and feedback control submodules. In the approach shown in FIG. 1B, a behavioral model is created using an end-to-end (E2E) approach, in which all or some of the previous modules are hidden as latent representations in a complex neural network construct.

In the hierarchically-structured AV system approach as shown in FIG. 1A, after a route plan has been found specifying a sequence of selected road segments, the behavioral layer is then responsible for selecting the appropriate driving behaviors at any point in time based on the perceived behaviors of other traffic participants, road conditions, and possible signals from infrastructure. Driving behaviors may include everything from the rate of acceleration, slope of the braking profile, aggressiveness of lateral movements, use of the horn, turning signals, etc. The challenge of specifying how an AV should behave has been traditionally solved using finite state machines coupled with different heuristics to encompass driving rules and safety concerns. However, driving conditions, especially those in urban scenarios, are characterized by a large number of interactions with road agents (vehicles, vulnerable road users, etc.) whose behavior cannot be predicted without uncertainties. The uncertainties in the behavior of other road agents is usually considered at the behavioral layer using probabilistic planning formalisms such as Markov decision processes or partially observable Markov decision processes (POMDP).

For the E2E approach as shown in FIG. 1B, on the other hand, the driving decision logic is abstracted under a single neural network construct trained from raw or processed sensor input and labeled expert control data. For example, a network may be trained using camera inputs and conditioned on high-level commands to output steering and acceleration, thus enabling an E2E network to follow route-like guidance (e.g. turn right/left). Solutions include the use of a Generative Adversarial Imitation Learning (GAIL) approach for optimization of a policy overcoming some cascading errors to produce stable trajectories over long time horizons. Learning methods to produce behavioral models require large amounts of training data, which is easy to create in synthetic (simulated) driving environments such as Car Learning to Act (CARLA), but these usually have performance issues when applied to real driving environments. This problem is known as the “domain transfer challenge.”

Other E2E approaches solve this issue by abstracting the network from raw sensor data and feeding abstracted information to cope with the lack of realism in simulators of both sensor and vehicle dynamics. A similar approach includes presenting the network with a synthesized environment (e.g. a world model representation), which is trained via imitation from expert driving. Perturbations to the expert input are then injected to augment the driving policy with loss learnings from resulting bad behaviors.

This previous work shows that it is possible to learn flexible (and potentially generalizable) behavioral models from data. However, learning behavioral driving models from real world data at scale remains an issue despite these advances. Current research is focused on developing generalizable, universal safe driving policies that can perform safely and efficiently in multiple domain. But common sense suggests that there is no such thing as a “universal” driver that behaves like a “local” anywhere in the world. As a result, such approaches are limiting, and ultimately require significant local customization and tuning, limiting the speed and scale of deployment.

The aspects described herein propose a scalable method to determine behavioral characteristics in a geofenced area from crowdsourced observations in combination with the safety guarantees of a safety behavioral model such as a safety driving model (SDM). As used herein, an SDM may include any suitable type of model that facilitates, guides, or otherwise defines a manner in which an AV may operate in a particular environment and under a particular set of conditions, such as the use of safety restrictions under which the AV operates within an environment, for example. For instance, an SDM may include an open and transparent mathematical model that functions as a set of objectives to be followed to ensure autonomous vehicle safety, which has been developed to address safety considerations for autonomous vehicles. The SDM thus represents guidelines to be followed that mimic basic principles humans follow when driving, such as defining dangerous situations, the cause of dangerous situations, and how to respond to them. SDMs define specific parameters and techniques with respect to safety considerations or safety restrictions to be universally followed for AVs in an attempt to standardize their behavior. For example, an SDM may include a definition of acceptable safe or minimum distances that, when met, allows an AV to safely merge into flowing traffic. As another example, the SDM may define a safe distance for an AV to maintain behind another vehicle.

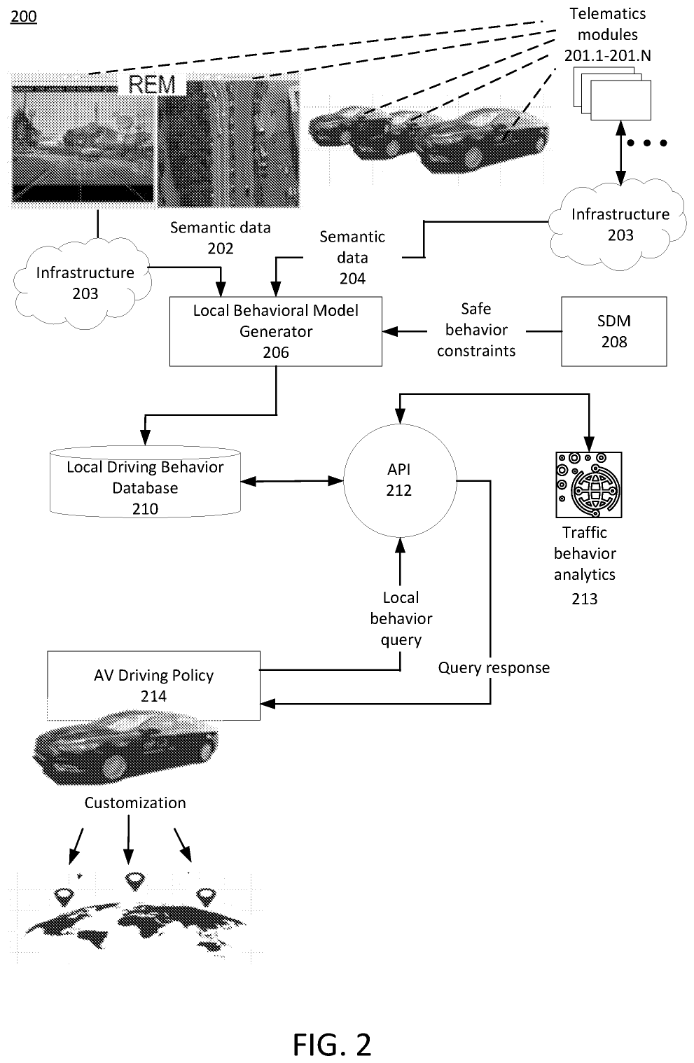

FIG. 2 illustrates an example overview of a local behavioral modeling system, in accordance with one or more aspects of the present disclosure. The local behavioral modeling system 200 as shown in FIG. 2 includes the aggregation of static semantic data, which may be associated with static or stationary landmarks and may be associated with a location, road scene, or any suitable environment to be navigated (e.g. map data, lane boundaries, traffic signs, etc.) as well as dynamic semantic data, which may include temporally sequential semantic data from dynamic (e.g. moving, mobile, or movement-capable) road actors (e.g. vehicles, trucks, vulnerable road users, etc.). The local behavioral model generation 206 is performed via classification of dynamic data in distinct driving maneuvers in the road segments (or map tiles), as further discussed herein. Trained behavioral models are then curated using the SDM 208 as constraints on the training data to ensure that unsafe behaviors are not learned. The behavioral models are then organized in a database structure in the local driving behavior database 210. An application programming interface (API) 212 may be utilized by a deployed vehicle as discussed in further detail below, to perform queries on the local parameters associated with the behavioral models stored in the local driving behavior database 210, which may be defined in accordance with a current road segment or other suitable geolocation. Additionally or alternatively, other computing devices such as those identified with third parties, state and local municipalities, etc., may likewise perform queries on the local parameters associated with the behavioral models stored in the local driving behavior database 210 to obtain traffic behavior analytics, as further discussed herein.

The details of local behavioral modeling system 200 shown in FIG. 2 will be further discussed herein. However, in general, the aspects include using specific types of data to provide inputs into the behavioral layer of an AV's Driving Policy 214 via the API 212, so that the AV is able to take input (e.g. in the form of constraints or suggestions) in such a way that the resulting motion planning will resemble a local driver from the moment it hits the road. For instance, the data used as inputs may represent geo-bounded data associated with a particular location(s) such as a road, intersection, region, etc., and may optionally further include data identified with various driving styles for different times of day (e.g. rush-hour vs. the weekend, day vs. night, etc.), that coincide at the respective locations. In an example implementation, this solution can behave like a semantic layer on a high-definition map used by the vehicle during the driving task to receive relevant behavior information.

To do so, aspects include the local behavioral modeling system implementing feedback provided by any suitable number N of driver telematics modules 201.1-201.N, which may be installed in various vehicles and/or road infrastructure sources in various geolocations. These vehicles may include, for instance, human-driven vehicles, whereas the road infrastructure sources may include, for instance, road signs and/or other suitable types of “smart” infrastructures that may report static-based metrics. The telematics modules 201.1-201.N may, for example, be implemented as a component that is integrated in a vehicle and/or road infrastructure source, or a component (e.g. a mobile device) that may be located within a vehicle or otherwise identified with a vehicle and configured to monitor, generate, and transmit various metrics indicative of each vehicle's driving style/behavior. Alternatively, and as noted above, the source of the dynamic semantic information may include other sources such as leverage telematics information obtained by insurance companies or other providers who precisely monitor the driving style of their drivers.

Examples of such metrics may include, for instance, driving metrics reported by vehicles and/or static metrics reported by road infrastructure sources, including acceleration metrics such as an acceleration profile (i.e. slope of acceleration curve), braking metrics such as a braking profile (i.e. slope of braking curve), steering metrics such as a steering profile (i.e. slope of steering curve when changing lanes), lane position, throttle pedal angle, brake pedal angle, average distances between an ego vehicle and other agents in different road types for all observable agents (i.e. highway, urban roads, intersections, etc.). Additionally or alternatively, the telematics modules 201.1-201.N may support the receipt of data and/or other wireless transmissions, such as updating the vehicle's behavioral model, software updates, etc. Thus, the telematics modules 201.1-201.N may be implemented as any suitable type of processing circuitry, hardware and/or software components to implement this functionality, including using known techniques to do so. In various aspects, the telematics modules 201.1-201.N may correspond to any suitable type of device that may be installed as part of any suitable type of vehicle (e.g. human-driven, AV, ADAS, etc.). Additionally or alternatively, the telematics modules 201.1-201.N may form part of an existing ADAS and/or AV driving system that is configured to make observations and collect data with respect to driving behavior, locations, objects at various locations, road types, etc.

In various aspects, the local behavioral modeling system 200 also includes a network infrastructure 203, which functions as an interface between the telematics modules 201.1-201.N to provide the dynamic semantic data to the local behavioral model generator 206, as well as the static semantic data, which may be provided via the telematics units 201.1-201.N or other suitable sources as discussed herein. The semantic data 202, 204 may include any suitable combination of dynamic data and static data, which may be provided by any combination of different types of infrastructure 203, telematics modules 201, etc., in various aspects. In an aspect, the network infrastructure 203 may be implemented as a cloud-based crowdsource aggregation infrastructure, but the aspects described herein are not limited to this implementation and any suitable type of infrastructure and/or interface may be implemented for this purpose. For example, the network infrastructure 203 may be implemented as any suitable configuration of wireless access points, base stations, or other communication networks that enable receipt of the semantic data 202, 204, as well as forwarding, processing, formatting, and/or transmitting the data associated with the semantic data 202, 204 to the local behavioral model generator 206.

Thus, in various aspects, the network infrastructure 203 facilitates collecting, at scale, the driver telematics information from any vehicle equipped with one of the telematics modules 201.1-201.N. Although a small number of vehicles and telematics modules 201.1-201.N are shown in FIG. 2, aspects include the number of vehicles and corresponding telematics units 201 being several million or more, which may be referred to herein as a vehicle “fleet” providing various metrics for this purpose. For instance, the telematics modules 201.1-201.N may be implemented by vehicles implementing advance driver-assistance system (ADAS) technology and/or AVs all over the world, and may form part of a fleet of vehicles that may implement the SDM 208 or other various types of suitable driving models. As an additional example, when implemented as part of an AV or ADAS-equipped vehicle, the telematics modules 201.1-201.N may be implemented as part of or the entirety of such an existing AV or ADAS system identified or otherwise used by such a vehicle. This may include, for instance, the ADAS and/or AV systems themselves and/or any components, sensors, etc. associated with such systems (e.g. cameras, light detection and ranging (lidar(s)), radio detection and ranging (radar(s)), ultrasonic sensors, processing systems, communication systems, etc.

In an aspect, the local behavioral modeling system 200 also includes a local behavioral model generator 206, which is configured to generate a driving behavior model representing driving behavior. The local behavioral model generator 206 may be configured as one or more processors, hardware, and/or software components, and form part of any suitable type of infrastructure or platform that receives the semantic data 202, 204, which is then processed to output a local behavioral model that is stored in the local driving behavior database 210. For example, the local behavioral model generator 206, local driving behavior database 210, and API 212 may be implemented as processing circuitry and/or software associated with one or more server computers, a data center, or other suitable processing devices that may operate as part of the network infrastructure 203, as separate processing components that communicate with the network infrastructure 203 (e.g. cloud-based servers and/or computers), or a separate network infrastructure not shown in the Figures. In other aspects, the local behavioral model generator 206, local driving behavior database 210, and API 212 may be implemented locally by an AV or other suitable type of vehicle, such as an electronic control unit (ECU) or other suitable processing components. Additionally, aspects include any combination of the local behavioral model generator 206, local driving behavior database 210, and API 212 being implemented locally as part of an AV or other suitable vehicle and as cloud-based or remote implementations.

Aspects include the local behavioral model generator 206 generating the local behavioral model implementing the safe behavior constraints provided by the SDM 208. Again, the SDM 208 represents guidelines to be followed that mimic basic principles humans follow when driving, such as defining dangerous situations, the cause of dangerous situations, and how to respond to them. The local behavioral model generated via the local behavioral model generator 206 is also a mathematical representation with respect to the physical characteristics that describe the way human driven vehicles behave. Thus, the local model generator 206 may record deviations from a global behavioral standard and communicate the deviations when such a deviation occurs and for driving behavior that deviates from the global behavioral standard. Thresholds and tolerances may be established and implemented to streamline any updates (and communication bandwidth as well as other resources required for such updates). For example, the level of accuracy of measurements may be reflected in the thresholds to avoid making updates that are a result of measurement accuracy constraints.

For instance, the local behavioral model may identify, using the semantic data 202, 204, metrics such as how fast vehicles accelerate after a green light, how long vehicles wait at full stop before proceeding at a stop sign, how many seconds to change lanes, how aggressively vehicles brake, and how much distance are typically provided to other drivers or other non-vehicle actors such as vulnerable road users, for example, which may include pedestrians, cyclists, or any other suitable non-vehicle actors that may be vulnerable to actions taken by road vehicles.

Each of these factors make up a driving “personality” that is represented by the local behavioral model, which is most often culturally relevant due to cultural and environmental cues. The aspects described herein generate the local behavioral model to provide a driving style model that describe what it means to drive like a local but having the constraints and characteristics defined by the SDM 208. In other words, the SDM defines parameters that determine the boundaries of safety with respect to an objectively safe standard. A local driving style may be ultimately reflected by the generation of the behavioral model operating within guidelines that are bound by the safe behavior constraints identified by the SDM 208 (e.g. how fast a vehicle accelerates, brakes, steers, takes corners, etc.). In various aspects, this mathematical model of the local behavioral model can be constructed in different ways. For instance, aspects include generating the local behavioral model using a list of parameters (e.g. jerk, throttle pedal angle, etc.), finite state machines coupled with different heuristics to encompass driving rules and safety concerns, or probabilistic planning formalisms such as Markov decision processes.

In an aspect, the local behavioral modeling system 200 also includes a local behavior database 210, which may be implemented as any suitable type of storage device that stores models having a particular structure that is based on geo-spatial and maneuvering relationships, as further discussed herein. For example, the local behavior database 210 may host or otherwise store existing models and their relationships in a space-graph database containing spatial and maneuver relationships, which is further discussed in detail below. To do so, the local behavior database 210 may include any suitable number and type of communication interfaces to receive the local behavioral models generated via the local behavioral model generator 206 as well as supporting data communications with the API 212. In an aspect, once the behavioral models are generated and stored in the local driving behavior database 210, the API 212 may be implemented to enable querying from traffic behavior analytics 213. For instance, the traffic behavior analytics 213 may represent a third party or a state or local government that requests information regarding specific driving metrics for a specific region. The aspects described herein facilitate such queries of the local driving behavior database 210 via the API 212.

For example, and as further discussed below, the aspects described herein may support the storage of data in the local driving behavior database 210 to support the query and extraction of any suitable type of data that may be useful to various government authorities, municipalities, etc. In particular, because the local driving behavior database 210 may store data in accordance with various regional levels, this may be particularly useful for different municipalities in accordance with a desired region and granularity. For instance, behavioral queries may be performed at multiple scale levels (e.g. road segment, local area, municipality, city, county, state, country, etc.). As an example, a state government may desire to obtain information related to driving behavior along intrastate highways, whereas a smaller town may desire information regarding cyclist behavior. As yet another example, a larger city may desire information related to abnormal driving behavior at certain points/locations within the city such as intersections, which may lead to a root cause of such behavior such as poor infrastructure, traffic light cycles that are too short, inadequate signage, etc. In an aspect, the node link structure described herein, which may be used for the local driving behavior database 210, provides a meta-geographical model that enables behavioral queries at multiple scale levels (e.g. road segment, local area, municipality, city, county, state, country, etc.) to provide such information.

In an aspect, the local behavioral modeling system 200 also includes, for each vehicle implementing the local behavioral models, a querying interface configured to facilitate agents using the local behavior database 210 for location-based parameter extraction or geo-bounded analytics. The querying interface is illustrated in FIG. 2 between the AV driving policy block 214, which is implemented via a particular AV using communications in accordance with the API 212, which thus functions to enable querying of the local behavior database 210 and, via the API 212, also enables queries for any suitable parameters associated with the driving behavioral models or the behavioral models themselves such as driving style parameters, traffic agent prediction, and traffic behavior analytics, for instance. The API 212 may be implemented in accordance with any suitable number and/or type communication protocols, data communication interfaces, etc., which may include known APIs and/or API structures. For example, the AV driving policy block 214 may be implemented by one or more local AV components (e.g. one or more electronic control unit(s) ECU(s)), which are used by each AV to perform autonomous navigation functions using a local behavioral model. In this way, an AV may use the API 212 to query for one or more local driving style parameters that are then incorporated into its own behavioral layer. Doing so results in a motion planning task that will mimic driving like a local.

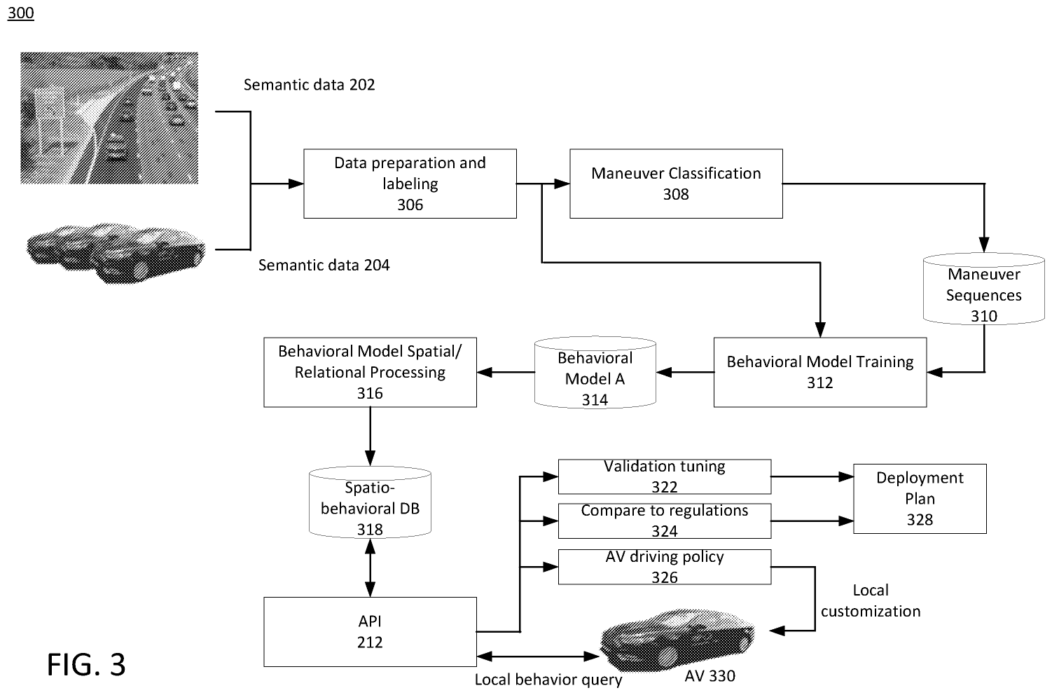

FIG. 3 illustrates an example local behavioral modeling system, in accordance with one or more aspects of the present disclosure. The local behavioral modeling system 300 as shown in FIG. 3 demonstrates a flow diagram from raw data capture to model creation, and provides additional detail with respect to the local behavioral modeling system 200 and the generation of the local behavioral model as discussed with reference to FIG. 2. In an aspect, once a local behavioral model of a driving style for a particular location has been created, the local behavioral model can then be distributed using the same crowd-sourcing infrastructure to gather the data, and the vehicles can deploy the driving style “on the fly,” without the need for a major software update.

The local behavioral modeling system 300 as shown in FIG. 3 provides additional details with respect to the behavioral model generation in two stages, which includes data preparation and model training. The local behavioral modeling system 300 as shown in FIG. 3 includes several processes that are similar or identical to those discussed above with respect to the local behavioral modeling system 200 as shown in FIG. 2. Therefore, the details associated with these processed will not be repeated for purposes of brevity. As discussed above with respect to FIG. 2, the local behavioral modeling system 300 may include various stages, or blocks, which perform the functions as described herein. This may be implemented, for instance, via any suitable type of processing circuitry associated with one or more server computers or other suitable processing devices that may operate as part of the underlying infrastructure, or as remote and/or separate processing components that communicate with the infrastructure (e.g. cloud-based servers and/or computers). In an aspect, the local behavioral modeling system 300 includes the collection of semantic data 202, 204 via an appropriate infrastructure (not shown in FIG. 3), as discussed above with reference to FIG. 2. The stages, or blocks, 306, 308, 310, 312, 314, and 316, however, provide additional detail with respect to the manner of operation of the local behavioral model generator 206 as shown in FIG. 2.

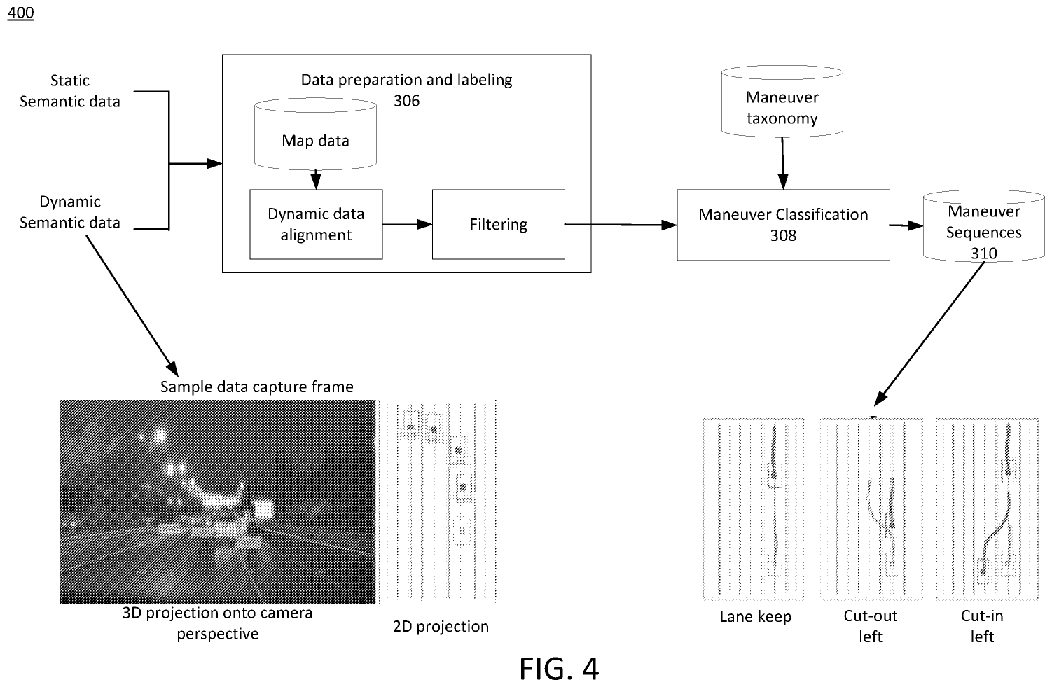

More specifically, the first stage includes preparing and labeling the received semantic data 202, 204, which may include static semantic data and dynamic semantic data, as part of the data preparation and labeling stage 306. This may include, for instance, identifying or classifying specific types of driving and/or static metrics as discussed herein, which determines if and how specific components of the collected metrics are to be used as part of the behavioral model. This process is depicted with additional detail in FIG. 4, which illustrates a maneuver sequence process in accordance with one or more aspects of the present disclosure. As an illustrative example, the data preparation and labeling stage 306 may aggregate the static semantic data and dynamic semantic data, which may include road actor labeled data crowdsourced from the vehicle fleet or other sources, e.g. via the telematics modules 201.1-201.N. This processing may include, for instance, localization, alignment to map tiles and lanes, as well as filtering for model training, as shown in FIG. 4.

Next, in the maneuver classification stage 308, the prepared and labeled data is used to divide sequential object tracks into distinct driving maneuver segments in each determined map tile. For example, maneuver classification may be performed on sequential data recordings in which a maneuver label from the maneuver taxonomy database as shown in FIG. 4 is matched (e.g. lane-keeping, car-following, cut-out, cut-in, turn-left, etc.) depending on the position of the ego vehicle and other surrounding vehicles from an initial timestamp to the end time of the sequence. Thus, as shown in FIG. 4, aspects include crowdsourcing dynamic actor data (e.g. dynamic semantic information) from road agents, which is then aligned to lanes, filtered, and classified and stored per maneuver in the maneuver sequences database 310.

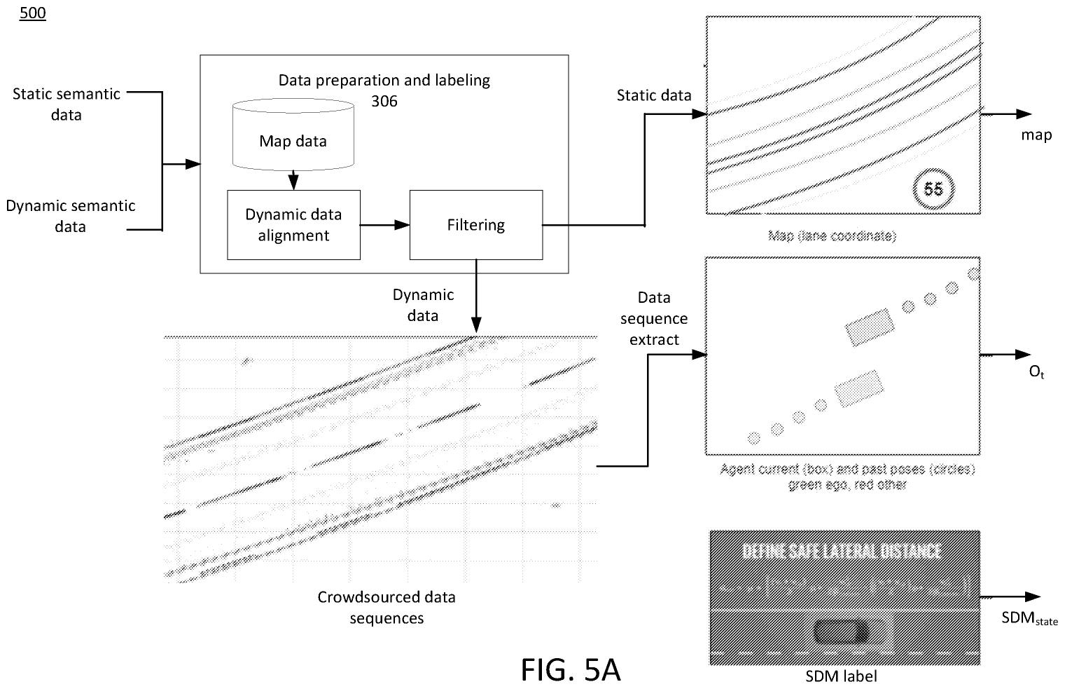

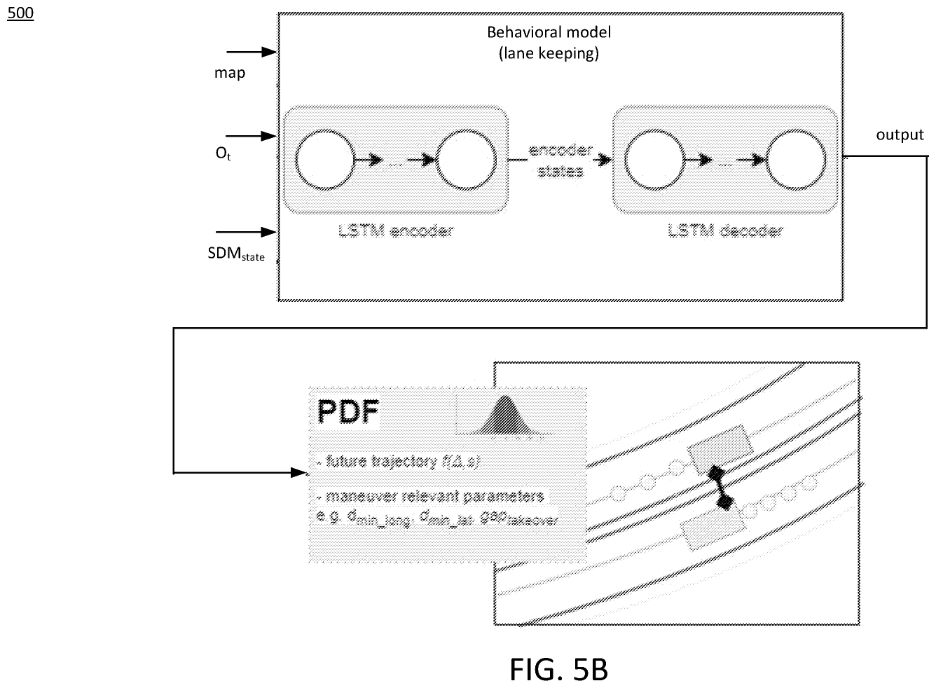

Referring back to FIG. 3, once the maneuvering sequences are stored in the maneuver sequences database 310, aspects include training the behavioral model in the behavioral model training stage 312 in accordance with a particular maneuvering sequence. The details associated with this training phase are further shown in FIGS. 5A-5B. For example, the data preparation and labeling stage 306 outputs static data from filtered static semantic data and dynamic data from filtered dynamic semantic data as shown in FIG. 5A. Thus, the model receives the static scene information from the map as shown in FIGS. 5A-5B, which includes lane geometry descriptions, identifiers, lane hierarchy representations, etc.

Moreover, the filtered dynamic data is sequentially extracted to provide a sequence of data sequences over some period of time that is relevant to a particular static map location. For example, the filtering may be based upon other vehicles previously located at the same map tile, road segment, etc., which have performed a similar or identical maneuver or are involved as part of a similar or identical maneuver. In other words, aspects include, during the training phase, the model receiving as input metrics associated with the previously-extracted maneuvers, with the ego vehicle and a number ‘n’ of other maneuver-related vehicles in a temporally-sequential manner including historic delta observations, which may be represented as Oₜ={{{eₚₒₛₑ, Δₚₒₛₑ}, {νₚₒₛₑ¹, Δνₚₒₛₑ¹}, . . . {νₚₒₛₑⁿ, Δνₚₒₛₑⁿ}}, as shown in FIGS. 5A-5B. For instance, in the notation described above, eₚₒₛₑ may represent a position of the ego vehicle, Δₚₒₛₑ may represent the difference (delta) from the prior temporal position of the ego vehicle, νₚₒₛₑ¹ may represent the velocity of another vehicle, Δνₚₒₛₑ¹ may represent a velocity differential with respect to the ego vehicle, and so on.

In addition, the behavioral model receives with each input an SDM label SDMₛₜₐₜₑ for the current state as training feedback to limit the output behaviors to safe observed behaviors as defined by SDM safety formulas. As shown in further detail in FIG. 5B, the behavioral model is trained or otherwise generated for a lane keeping maneuver is composed, in this example, of two Long-term Short-term Memory neural networks (LSTM), which may function in accordance with known LSTM neural networks, for example. The inputs described herein to generate the behavioral models are provided by way of example and not limitation, and any suitable type of data may be used based upon the particular type of driving behavior that is to be defined at particular locations and/or under other various driving contexts such as the time of day, the day or the week, during different types of weather, etc. Thus, the behavioral models may be generated using any set of suitable data such that queries may be made in accordance with the types of input used, as further discussed herein.

The use of LSTM neural networks is provided by way of example and not limitation, and aspects include the use of any suitable type of machine learning techniques and/or architectures. Moreover, although the models are referred to as being trained throughout the disclosure, this is for ease of explanation and used by way of example and not limitation. The aspects described herein may implement any suitable type of behavioral model construct including those that may be trained as well as any other suitable types of behavioral models, which do not necessarily need to be trained but may instead use sets of constraints applied to their inputs to generate the desired output data. For example, the aspects described herein may implement rule-based models, regression models, support vector machines, state machines petri nets, etc., which may (but do not necessarily require) learning from training data sets.

However, the use of LSTM over traditional RNNs, hidden Markov models, and other sequence learning methods may be particularly advantageous as LTSMs are less sensitive to temporal delay length, and thus can process and predict time series given time lags of unknown duration and for data of various size and density. This enables the trained behavioral model to be highly flexible on the duration of delta history needed for the output predictions and also the future time that the behavioral model can predict trajectories. In an aspect, and as shown in in FIG. 5B, the behavioral model outputs the predicted trajectory of the ego agent, given in the form of a probability density function with the likelihood of positions of ego vehicle e_{pred}^{t}=(xₜ, yₜ) i for the future f time points t={t_{c+1}, . . . , t_{c+f}} predicted from the maneuver-learned position posterior. In an aspect, for each maneuver, the output may also be additionally or alternatively accompanied with characteristic parameters such as longitudinal and lateral minimum distances or minimum gap (to initiate cut-out maneuver), or other suitable parameters as defined by the SDM.

In an aspect, for training the LSTM behavioral model, the following mean squared error (MSE) loss function is implemented in accordance with Equation 1 below as follows:

$$L = \frac{1}{f * N} {\sum }_{t = tc + 1}^{tc + f} {\sum }_{i = 1}^{N} {SDM}_{state}^{t} ‖ ( {e}_{pred}^{t} - {e}_{true}^{t} ) ‖ 2 \qquad Eqn . l$$

where t={t_{c+1}, t_{c+2}, . . . , t_{c+f}} is a time point in the future, e^{t}_{pred} is the predicted coordinate for the ego vehicle at time t, and e^{t}ₜᵣᵤₑ is the ground truth. SDMₛₜₐₜₑ∈[0,1] is a weighted “discount” for dangerous states as measured by the SDM. In an aspect, the LSTM behavioral model is then trained using a stochastic gradient descent optimizer. This training process is repeated for each of the existing maneuver sequence observations in a particular road segment (e.g. a map tile), which corresponds to the static data. For instance, referring back to FIG. 3, the example behavioral model discussed with respect to FIGS. 5A-5B may correspond to a lane keeping model, which is labeled as “behavioral model ‘A’” at block 314 in FIG. 3. Thus, in this example, the behavioral model A enables the prediction of lane keeping maneuvers for other vehicles at the same location in the future and, because the behavioral model is linked to the geolocation in accordance with the static map data, this trained behavioral model facilitates other vehicles doing so in a manner that mirrors other drivers at that same location. The behavioral training model process described herein may be repeated for any suitable number of different maneuvers and locations to generate a set of trained behavioral models covering a particular geographic region of any suitable size and/or shape. With continued reference to FIG. 3, aspects include storing the generated behavioral models in an integrated manner in the spatio-behavioral database 318 by applying behavioral model spatial/relational processing at block 316, which enables geo-bounded querying as further discussed herein.

As shown in FIG. 3, the spatio-behavioral database 318 stores the behavioral models and accompanying parameters, which have a spatial relationship structure that is established via data processing at block 316. For example, the output of the maneuver behavioral models described with reference to FIGS. 5A-5B, which are stored in the behavioral model database 314, may function as a starting point for the creation of a spatio-behavioral model database 318 that aggregates the locally-learned behavioral models in a relational structure. Thus, each of the behavioral model database 314 and the spatio-behavioral database 318 may be identified with the local driving behavior database 210 as shown and described with reference to FIG. 2. Although FIG. 2 illustrates a single database for storing both the locally-learned behavioral models (e.g. stored in database 314) and the spatio-behavioral structure of the locally-learned behavioral models (e.g. stored in database 318), this is for brevity and ease of explanation, and the aspects described herein may store the locally-learned behavioral models and the spatio-behavioral structure of the locally-learned behavioral models in the same storage location or separate locations, in various aspects.

The AV driving policy 326 may thus be identified with the AV driving policy block 214 as shown in FIG. 2. The AV driving policy block 326 may include an AV driving policy, which is evaluated via the validation tuning block 322 against a specific set of metrics (i.e. safety benchmark) before or during deployment of the AV policy in a target environment (e.g. in a specific country or region). Moreover, the compare to regulations block 324 may represent the process through which the outcome of a local behavior query is evaluated against existing rules of the road, which may comprise of a number of legal traffic rules applicable in a geo-fenced driving area. The deployment plan block 328 may thus represent the specification of where (geographically) the AV vehicles are to drive in order to be tested, collect extra data, operate commercially (which includes the previous validation tuning), checks of performance against regulation, other fleet management considerations, etc.

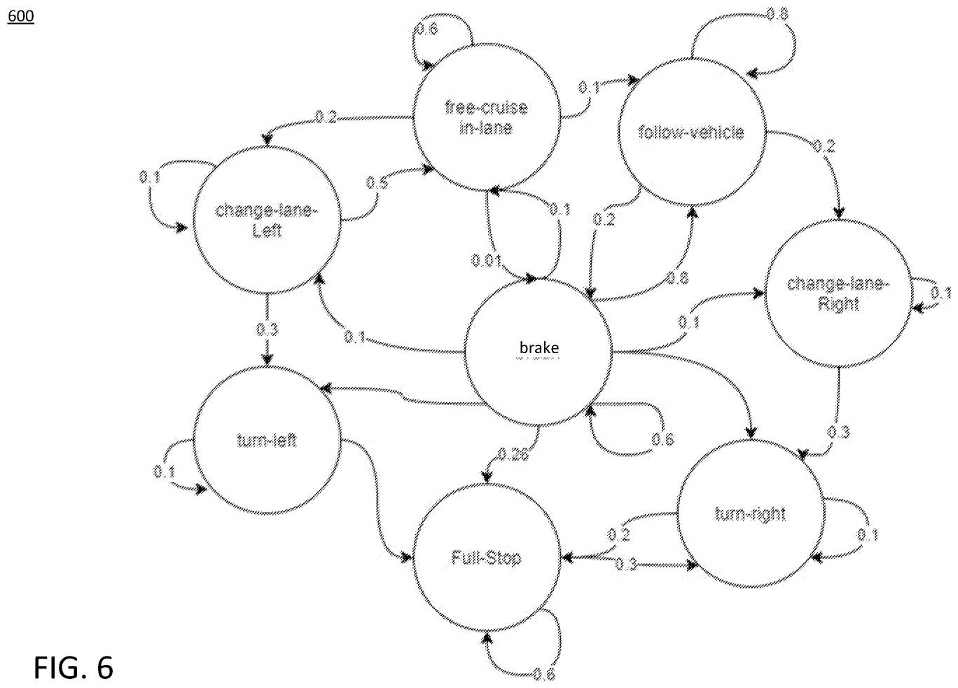

In any event, aspects include using at least two types of relational attributes to store the behavioral models within the spatio-behavioral database 318. The examples provided herein are by way of example and not limitation, and aspects include any suitable relational attributes being used for this purpose. As an example, the first relational attribute includes the relation that one maneuver has with other maneuvers at a particular geolocation. An example taxonomy of maneuver types and transition probabilities is represented in FIG. 6, in which behavioral models are represented as nodes, and the likelihood of one maneuver transitioning into another maneuver at time t+1 is represented in links (or edges) connecting the various nodes, with the value in each respective link representing a normalized likelihood. Of course, not all road segments or road tiles will enable all maneuvers. Thus, given a complete maneuver taxonomy, only a subset of links may exist and have probabilities higher than 0 based on the crowdsourced naturalistic data.

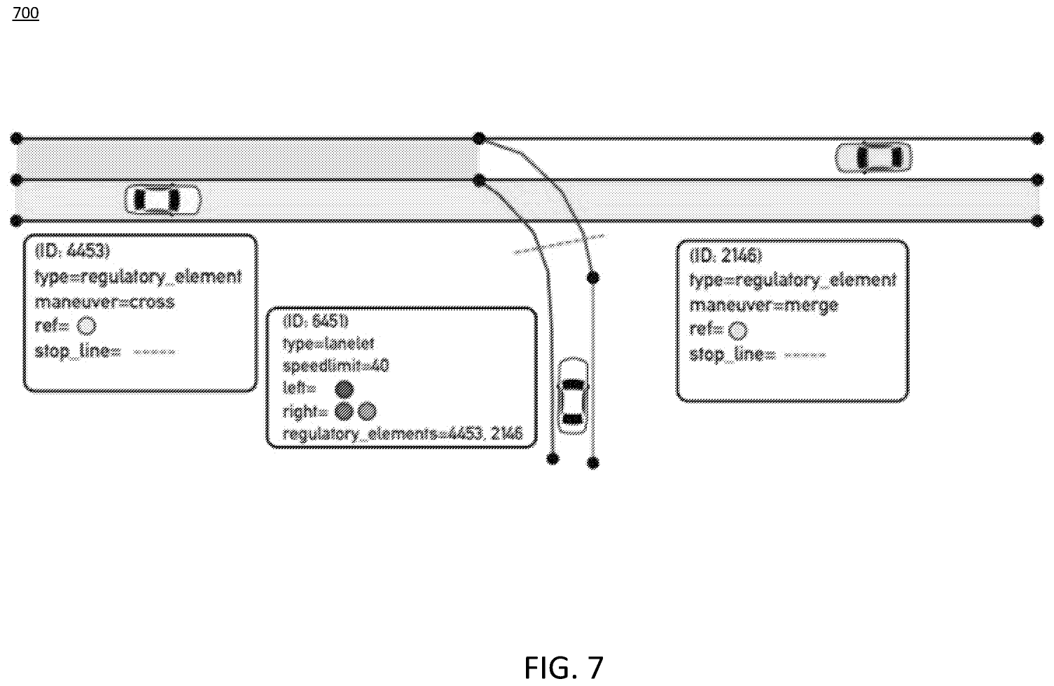

Continuing this example, the second of the relational attributes of importance is expressed by spatial location. For instance, each of the behavioral models may be linked to a particular road segment, and road segments may be linked to each other based on the road topology. This concept is applied in existing map data structures. For example, OpenStreetMap models the environment with topological maps using nodes, ways, and relations, in which ways denote lists of nodes (polylines), and relations consist of specified node roles or properties. The same idea is implemented in other map formats used for autonomous driving. For example, and with reference to FIG. 7, “lanelets” express road segments using a graph of adjacent polylines, which also include other information such as regulatory speed limits or allowed maneuver types as node attributes.

In an aspect, the behavioral model spatial/relational processing block 316 processes the generated behavioral models at scale, which are then stored in the spatio-behavioral database 318. To do so, aspects include the behavioral model spatial/relational processing block 316 using two types of nodes to establish a graph-based database structure and relationship among the various behavioral road models. For instance, the behavioral model spatial/relational processing block 316 may establish road nodes that represent map descriptors such as polylines, which have relationship links to similar nodes by means of adjacencies and position, and may contain road attributes such as the above regulatory elements, directionality, priority of the lane, etc. The behavioral model spatial/relational processing block 316 may also establish behavioral nodes that contain links to the road nodes (locations) in which the respective training data was collected, as well as links to other behavioral nodes with values as maneuver transition probabilities.

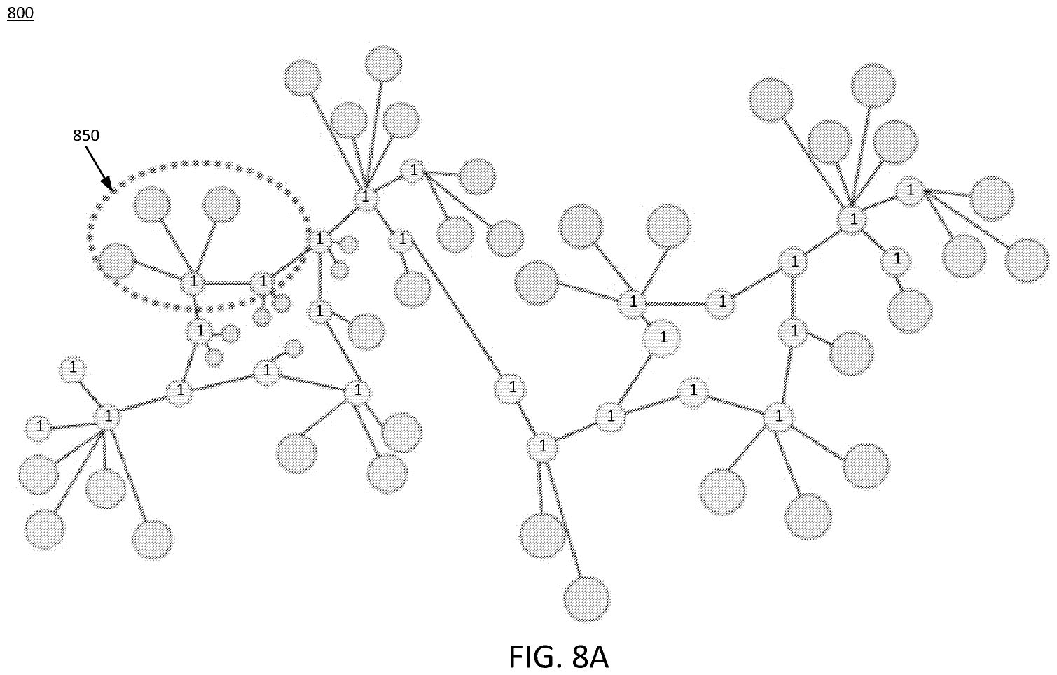

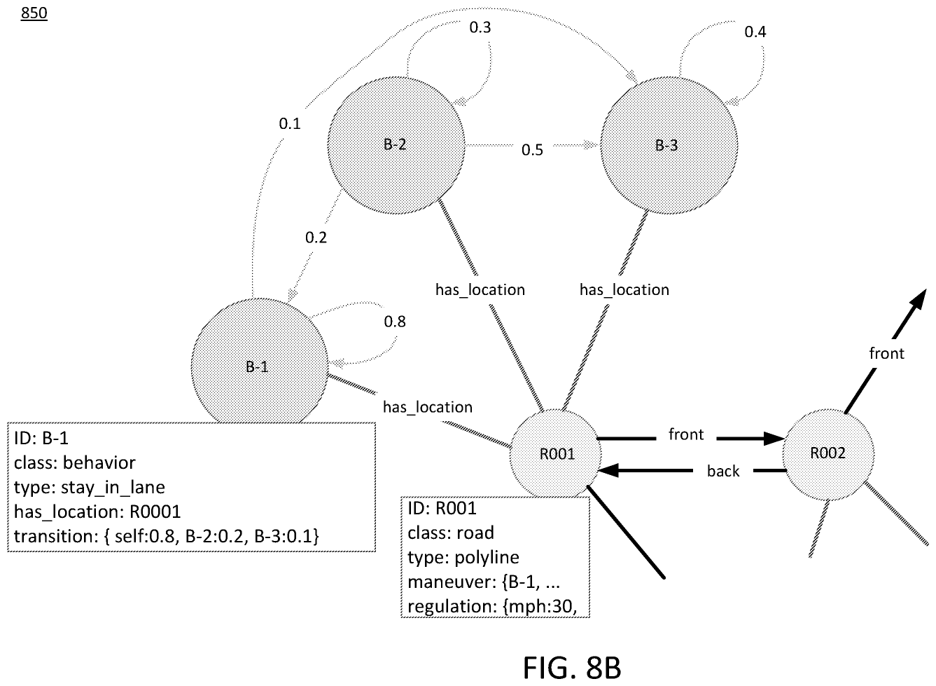

A visual representation of a snapshot of an example behavioral model graph dataset for a map section is shown in FIGS. 8A-8B, which depicts an example visualization of the graph database structure for the behavioral models stored in the spatio-behavioral database 318. As shown in FIG. 8A, the road nodes are labeled with a ‘1’ and the adjacency relations are represented as a connection between the road nodes. The behavioral nodes are represented as the unlabeled circles in FIG. 8A, and the connections between the road nodes and the behavioral nodes represent the locality property. As shown in further detail in FIG. 8B, the links connecting the various behavioral nodes represent a maneuver transition probability. The behavioral model graph dataset 800 shown in FIG. 8A may thus constitute a collection of behavioral models for particular maneuvers, which are spatially-linked to corresponding locations (e.g. road segments, tiles, etc.). The behavioral model graph dataset 800 shown in FIG. 8A is by way of example, and of course may include any suitable number of road nodes and behavioral nodes to cover a suitable region of any suitable size (e.g. an intersection, several streets, an entire city, etc.). The spatio-behavioral database 318 may store any suitable number of behavioral models in the behavioral model graph dataset format for any suitable number of such regions.

Thus, the various behavioral nodes represent a behavioral model associated with a specific type of maneuver that was trained in accordance with the dynamic and static data as discussed above with reference to FIGS. 5A-5B. With reference to FIG. 8B, the portion of the behavioral model graph 850 includes three behavioral nodes B-1, B-2, B-3 connected to a road node R001. Thus, the road node R001 represents a particular location associated with the map that is derived from the static data discussed above with reference to FIG. 5A, for instance. This road node R001 may thus represent a particular geographic location such as a road segment or map tile, for instance, for which various maneuver taxonomies may be associated. These different maneuver taxonomies are represented in FIG. 8B as the respective behavioral nodes B-1, B-2, and B-3. As an illustrative example, the behavioral node B-1 may represent a vehicle remaining in the current lane, behavioral node B-2 may represent a vehicle cutting out left, and the behavioral node B-3 may represent the vehicle cutting in left, as shown in FIG. 4 as the maneuver sequences 310 that have been classified via the maneuver classification 308.

The arrows between the various behavioral nodes represent, for the particular maneuver taxonomy, transition probabilities that represent the probability that the vehicle will transition from one type of maneuver (e.g. one associated with B-1) to another maneuver (e.g. one associated with B-3), which is a 10% probability in this example. As an illustrative example, if a first vehicle has been following a second vehicle for ten minutes and the second vehicle is identified as slowing down, the first vehicle may have a particular probability of overtaking the second vehicle at a particular instance in time. Of course, the structure and transition probabilities may evolve over time in a dynamic manner as additional data is collected, and thus the example shown in FIG. 8B represents the transition probabilities for various maneuver transitions with a correlated location (road node) based upon a particular instance in time for which the behavioral model is trained and as applicable to a vehicle querying the behavioral model in a location-based manner. In other words, while the links between the road nodes will likely not change very often (e.g., for road construction, detours, etc.), the links between behavioral nodes are dynamic in nature and may change as new naturalistic data is captured to reflect the actual behaviors and transitions between maneuvers.

Thus, and turning back to FIG. 8A, the set of behavioral models stored in the spatio-behavioral database 318 may have a structure provided by the example shown, such that each particular location (e.g. road tile or road segment as represented by the road nodes labeled with a 1) may be associated with a set of particular maneuvers represented by the linked behavioral nodes (unlabeled). Thus, as a vehicle moves between different geographic locations, the vehicle may utilize different portions of the behavioral model that is identified with the vehicle's corresponding location with respect to a road node.

This structure enables an AV to query the spatio-behavioral database 318 via the API 320 for a local behavior using a specific location of the vehicle that matches a specific road node in the behavioral model, as shown in FIG. 3 for example. The queries discussed herein may be performed in real-time or offline, recognizing latency limits for queries that require data aggregation across multiple models, although these types of queries generally do not have real-time application needs. To do so, in an aspect the behavioral model graph dataset may be implemented as a layer on top of existing map data-structures such as lanelets, OpenDrive, or Road Experience Management (REM), which allows for queries on dynamic traffic behaviors. Examples are provided in further detail below with respect to the various use cases and employed mechanisms (e.g. via API 212) for querying the spatio-behavioral database 318 and extracting useful information. In an aspect, the node link structure described above provides a meta-geographical model that enables behavioral queries at multiple scale levels (e.g. road segment, local area, municipality, city, county, state, country, etc.). Aspects include the spatio-behavioral database 318 storing, in addition to the location data associated with the road nodes, any suitable type of contextual parameters related to driving at specific geolocations such as, for instance, the time of day, weather conditions, etc. Additionally or alternatively, the spatio-behavioral database 318 may store separate behavioral model graph datasets to facilitate queries for data using one or more of a specific location, time of day, day of the week, weather conditions, etc., which may then provide data representing driving behavior in accordance with the specific data or parameters that is/are queried.

As described herein, the behavioral model graph dataset may store valuable data that may be extracted for various purposes. This may include, for instance, the aforementioned traffic behavior analytics as shown FIG. 2. Additionally or alternatively, the behavioral model graph dataset may be queried via any suitable type of API (e.g. the API 212 as shown in FIG. 2) to extract data by users, human-driven vehicles, ADAS systems, and/or AVs.

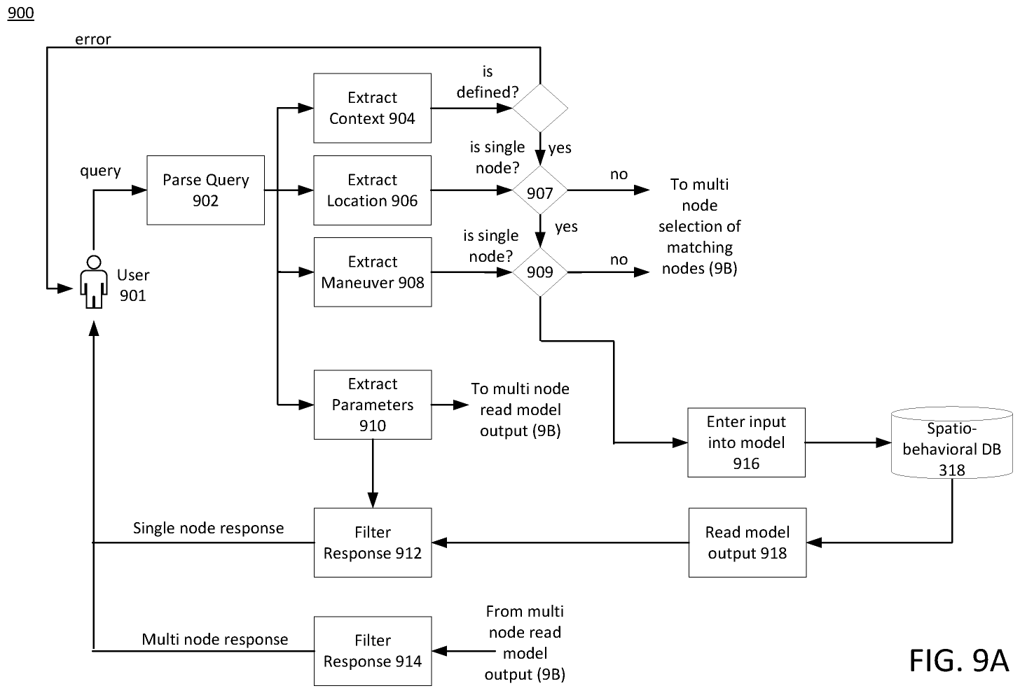

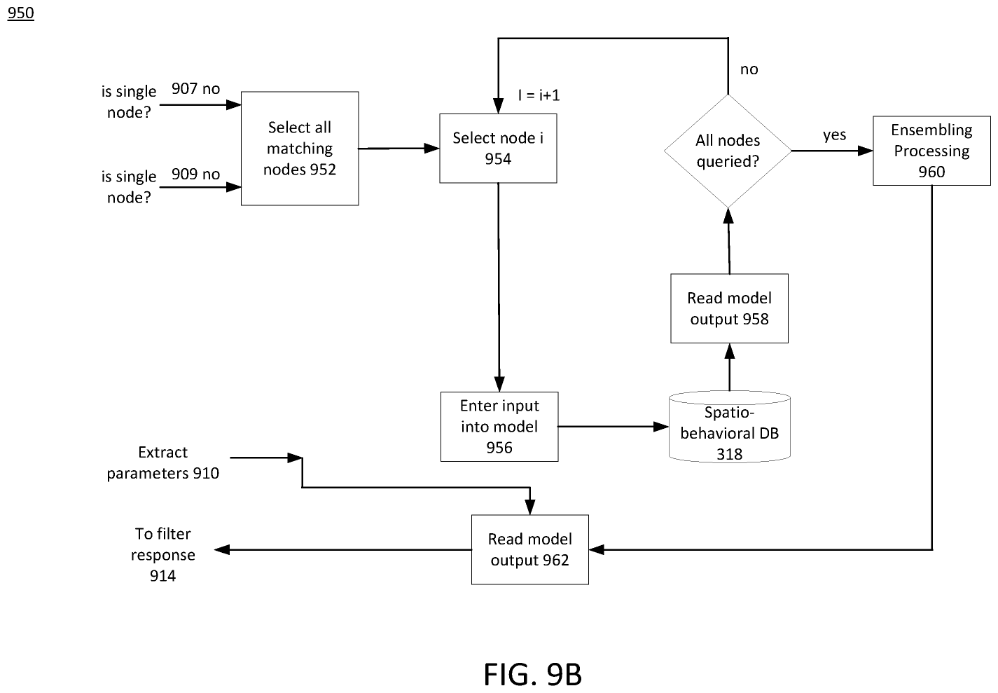

As an example, a query may be linked to, or otherwise based upon, a specific context or application for which specific type of data is specified that is to be extracted from the stored behavioral model graph dataset. A query may be associated with any suitable portion of the stored behavioral model graph datasets, which may include the behavioral models themselves, parameters associated with the behavioral models as discussed herein, inputs and outputs to the behavioral models, locations associated with the behavioral models, etc. For example, in some cases a single node may be queried, such as via an AV at a particular location identified with a road node for instance. However, in other cases a query may be associated with data for a particular region that is requested, and thus may involve querying multiple nodes. In various aspects, both single node and multi-node type queries may be performed with respect to the behavioral model graph dataset stored in the spatio-behavioral database 318. FIGS. 9A and 9B illustrate additional details associated with the API querying process for extracting data from the stored behavioral model graph dataset, with 9A representing an example process for a single node query and FIG. 9B representing an example process for a multiple node query.

As shown in FIG. 9A, the user 901 may represent, for example, a vehicle automation system or a human user performing analytics on the database backend. The query may be constructed in any suitable format, manner, and/or in accordance with any suitable protocol such as a query constructed in SQL-type language, for example, that defines a driving situation (context) with location and maneuver attributes and requested parameters in which the user 901 is interested. The API 212 functions to parse the query at block 902 and, if the driving context (situation) is sufficiently defined, the query will identify the location and maneuvers of interest and any other suitable type of contextual search parameters that may be relevant to determining a specific type of driving behavior at a particular time, place, and under particular conditions such as, for instance, the time of day, weather conditions, etc. The single node queries may include, for example, queries related to parameters that affect the customization of an ego vehicle in a particular instance. Examples of such single node queries in a natural language expression include the following:
What is the average headway distance with following vehicle in same lane and direction for [this] road segment?
What is the average breaking force used when entering [the next] curve?
How long do vehicles wait at [this]4-way intersection when stopped?
What is the average lateral spacing between agents traveling in the same and opposite directions?

Each of these queries may refer to a unique location and maneuver, and so the query can be directed to the particular road node and the linked behavioral node that reflects that maneuver, as shown in FIGS. 8A-8B for instance. Therefore, the information can be extracted from the behavioral model graph dataset stored in the spatio-behavioral database 318. In an aspect, the query includes identifying the behavioral node that satisfies the query predicate, translating the question into the input for the model, and retrieving and filtering the correct answer. Thus, the query may include matching a location defined in the query for a road node behavioral model graph dataset stored in the spatio-behavioral database 318 and the linked behavioral model(s) that match the location and particular maneuver(s) linked to that road node location.

FIG. 9B includes additional details for a multiple node query of the behavioral model graph dataset stored in the spatio-behavioral database 318. In the example shown in FIG. 9B, there are multiple matching nodes, and thus the query is repeated for each of these nodes and an ensemble strategy is performed to aggregate the data from multiple related nodes.

Some examples of multiple node queries may involve either a larger geographical location with interest in one type of maneuver, a single road node but multiple maneuver types, or multiples of both types. Examples of such multi-node queries in natural language include the following:
What is the gap size (distance) for right lane changes in Germany?
What is the average lateral distance in [this] road segment?
What is the average percentage of time driven above the road speed limit in New York City?

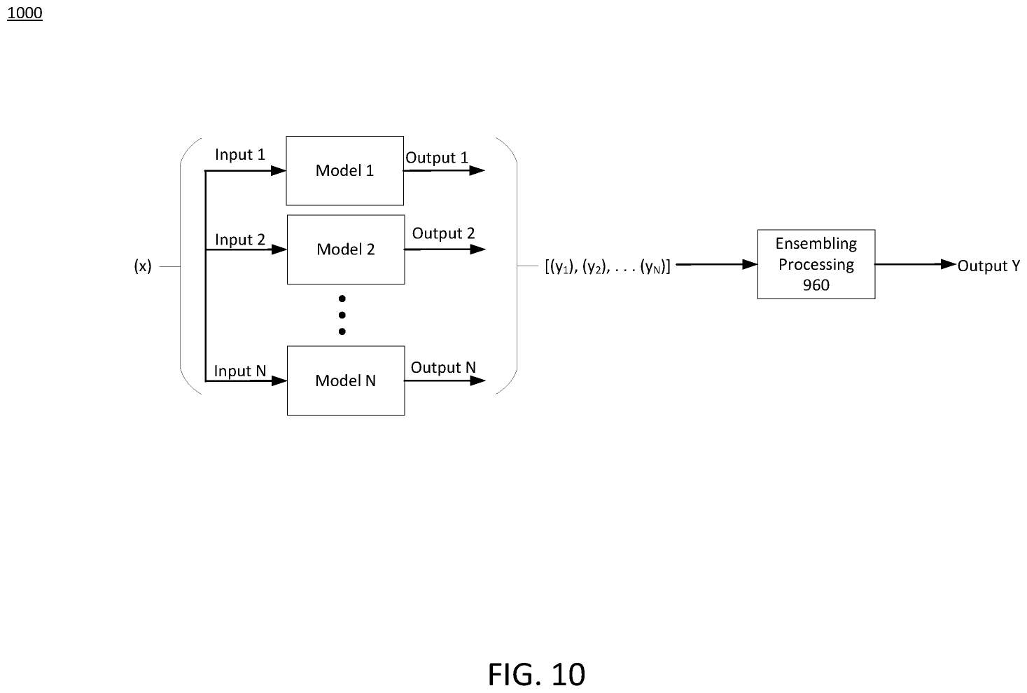

Thus, as shown in FIG. 9B, providing solution to these kinds of queries requires querying multiple behavioral nodes and applying an ensemble logic to combine predictions from the multiple behavioral models. In other words, aspects include the ensembling logic applied at block 960 in FIG. 9B being performed such that each selected behavioral model makes a contribution to the ensemble, which outputs the final prediction that is returned to the user 901 via the reading of the output model block 962 and filtering block 914. Additional details associated with the ensembling process as shown in FIG. 9B at block 960 are provided below with reference to FIG. 10.

The ensembling process performed at block 960 may include the combination of model outputs for a multi node query to construct the query response. Depending on the particular type of query that is made, the aspects described herein may include performing the ensembling in accordance with any suitable strategy or technique. Two examples of ensembling techniques include bagging and boosting, which are described in further detail below, but the aspects herein are not limited to these particular examples. For example, other ensembling strategies could be applied such as learned ensembles using machine learning techniques.

Bagging may be implemented as one example of the ensembling process, which may be particularly useful for queries that request “average” data values, as this technique is focused on reducing the variance of the individual behavioral model predictions. With reference to FIG. 10, depending on the amount of nodes involved, a weighted combination may be applied to each of the behavioral model predictions following Y=Σᵢ₌₁(wᵢ(yᵢ)), with the weights wᵢ being applied either equally or following a predefined logic scheme. For example, more weight may be applied to behavioral models belonging to road segments closer to the current location or those that most closely match the road topology. As another example, a “majority vote,” may be implemented in which Y=arg_{K}max[card(i|w(yᵢ)=k)]. As yet another example of a bagging technique, weighting of the behavioral model outputs y may be performed according to an average time spent on each segment (e.g. the probability mass of driving on the segment).

Boosting may be implemented as another example of the ensembling process, which may particularly useful for queries that request a “maximum” value of a parameter, since each behavioral model in the sequence is fitted giving more importance to what the previous model could not handle, thus creating a strong bias in the distributions of the response. For example, the predictions may be guided using the ensemble learning method adaboost, which may utilize the relationshipY=Σᵢ₌₁^{N}(cᵢ×(yᵢ), in which cᵢ represents the sequence coefficients and yi represents the model predictions. When large number of models are involved, this solution might become too complex, and thus approximation techniques may be applied such as those described in Merler, S., Caprile, B., & Furlanello, C. (2007); Parallelizing AdaBoost by weights dynamics. Computational statistics & data analysis, 51(5), 2487-2498.

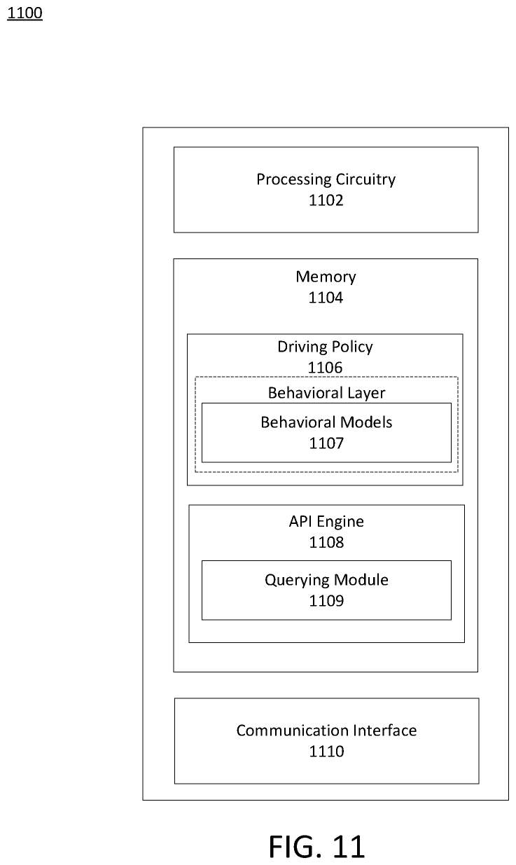

FIG. 11 illustrates an exemplary computing device, in accordance with various aspects of the present disclosure. The computing device 1100 (also referred to herein as local processing circuitry or a local processing system) may be implemented as part of a human-driven, ADAS vehicle, and/or AV as discussed herein, which uses a driving policy to navigate and make decisions regarding specific maneuvers and when to execute specific maneuvers in accordance with a trained behavioral model. Again, the aspects described herein are not limited to the examples described herein, and the functions performed by the computing device 1100 in this example may additionally or alternatively be performed by other components of a vehicle in which the computing device 1100 is implemented.

In an aspect, the computing device 1100 may be implemented in different ways depending upon the particular application, type, and use with respect to the vehicle in which it is installed or otherwise forms a part. For instance, computing device 1100 may be identified with one or more portions of a vehicle's safety system. Continuing this example, the computing device 1100 may include processing circuitry 1102 as well as the one or more memories 1104. The computing device 1100 may be integrated as part of a vehicle in which it is implemented, as one or more virtual machines running as a hypervisor with respect to one or more of the vehicle's existing systems, as a control system of an AV, an ECU of the AV, etc. As another example, the computing device 1100 may be implemented as a computing system to facilitate queries for traffic behavior analytics 213, as discussed herein.

Thus, the computing device 1100 may be implemented using existing components of an AV's safety system or other suitable systems, and be realized via a software update that modifies the operation and/or function of one or more of these processing components. In other aspects, the computing device 1100 may include one or more hardware and/or software components that extend or supplement the operation of the AV's safety system or other suitable systems. This may include adding or altering one or more components of the AV's safety system or other suitable systems. In yet other aspects, the computing device 1100 may be implemented as a stand-alone device, which is installed as an after-market modification to the AV in which it is implemented.

The computing device 1100 may also form a part of (or the entirety of) a telematics module 201.1-201.N as discussed herein with respect to FIG. 2, for example. Regardless of the particular implementation, to perform the various functionality as described herein, the computing device 1100 may include processing circuitry 1102, a memory 1104, and a communication interface 1110. The components shown in FIG. 11 are provided for ease of explanation, and aspects include the computing device 1100 implementing additional, less, or alternative components as those shown in FIG. 11.

In various aspects, the processing circuitry 1102 may be configured as any suitable number and/or type of computer processors, which may function to control the computing device 1100 or other components of the vehicle in which it is implemented. Processing circuitry 1102 may be identified with one or more processors (or suitable portions thereof) implemented by the computing device 1100. For example, the processing circuitry 1102 may, for example, be identified with one or more processors such as a host processor, a digital signal processor, one or more microprocessors, graphics processors, microcontrollers, an application-specific integrated circuit (ASIC), part (or the entirety of) a field-programmable gate array (FPGA), etc.

In any event, aspects include the processing circuitry 1102 being configured to carry out instructions to perform arithmetical, logical, and/or input/output (I/O) operations, and/or to control the operation of one or more components of computing device 1100 to perform various functions associated with the aspects as described herein from the perspective of a vehicle that utilizes trained behavioral models in a locally-relevant manner. For example, the processing circuitry 1102 may include one or more microprocessor cores, memory registers, buffers, clocks, etc., and may generate electronic control signals associated with electronic components to control and/or modify the operation of one or more components of the computing device 1100 and/or vehicle in which it is implemented as discussed herein. Moreover, aspects include processing circuitry 1102 communicating with and/or controlling functions associated with the memory 1104 and/or the communication interface 1110.

In an aspect, the memory 1104 stores data and/or instructions such that, when the instructions are executed by the processing circuitry 1102, the processing circuitry 1102 performs various functions as described herein. The memory 1104 can be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 1104 can be non-removable, removable, or a combination of both. For example, the memory 1104 may be implemented as a non-transitory computer readable medium storing one or more executable instructions such as, for example, logic, algorithms, code, etc.

As further discussed below, the instructions, logic, code, etc., stored in the memory 1104 are represented by the various modules as shown in FIG. 11, which may enable the aspects disclosed herein to be functionally realized. Alternatively, if the aspects described herein are implemented via hardware, the modules shown in FIG. 11 associated with the memory 1104 may include instructions and/or code to facilitate control and/or monitor the operation of such hardware components. In other words, the modules shown in FIG. 11 are provided for ease of explanation regarding the functional association between hardware and software components. Thus, aspects include the processing circuitry 1102 executing the instructions stored in these respective modules in conjunction with one or more hardware components to perform the various functions associated with the aspects as further discussed herein.

In an aspect, the executable instructions stored in the driving policy module 1106 may facilitate, in conjunction with the processing circuitry 1102, storing and/or accessing the stored behavioral model for a specific maneuver at a particular location, which may be in response to a query performed via the API engine 1108 and querying module 1109. Thus, behavioral models 1107 stored in the memory 1104 may be trained or otherwise generated (e.g. offline) in accordance with a particular maneuver to be performed by AVs at a corresponding geolocation, as discussed herein. Of course, the behavioral models 1107 may be stored in another memory location or otherwise accessed by the AV in various ways. Based upon the particular location of the AV and the maneuver being performed, the AV may access the behavioral models 1107 in real-time (e.g. if the behavioral models 1107 have been previously or recently updated) or update the behavioral models 1107 using a transmitted query and response via an API before doing so, as discussed herein.

For instance, aspects include the behavioral models 1107 stored in the memory 1104 being trained or otherwise generated offline. An updating process may then implement a curation of data from various data sources (e.g. the static and dynamic semantic data), which may be crowdsourced as described herein with reference to FIG. 3, for instance (e.g. the crowdsourced naturalistic data). The behavioral model generation process may thus update the behavioral models for a particular spatial region as new semantic data is received. This is done to reflect changes in observed behavior over time. In this way, it is ensured that any queries for data associated with the behavioral models is done on the most up-to-date models, which are either stored in memory 1104 and/or obtained via queries (e.g. for data associated with the behavioral models stored in the spatio-behavioral database 318). Optionally, aspects include the memory 1104 and/or spatio-behavioral database 318 storing older behavioral models, and a combination of outputs from such older behavioral models may then be used to provide historic analysis such as trends, for instance.

Again, the driving policy 1106 may represent various mathematical models that instruct an AV how to navigate or otherwise execute trained maneuvers, which may include a driving style that is based on locally-derived dynamic data as discussed herein. The driving policy 1106 may thus include the various parameters associated with the AVs SDM, as well as the implementation of the behavioral models 1107 that may include the behavioral layer as shown in FIG. 11. The behavioral models 1107 may include, for example, a set of spatially-linked behavioral models trained as discussed herein, for example, in FIGS. 5A-5B. These may be stored locally in the memory 1104, updated dynamically as the vehicle in which the computing device 1100 is implemented navigates to locations that correspond to the road nodes in the behavioral model graph dataset, or queried and updated on the fly, as discussed herein. The behavioral models 1107 utilized by the AV may be provided as an input to the behavioral layer of the driving policy 1106 to execute a specific maneuver at a specific geolocation and/or under a specific set of conditions, as discussed herein.

To transmit and receive data, aspects include the computing device 1100 implementing a communication interface 1110 (or utilize such interfaces that are part of a vehicle's existing safety system or other suitable systems or components). The communication interface 1110 may operate to enable communications in accordance with a suitable communication protocol. The communication interface may function to support the functionality described herein with respect to the telematics modules 201.1-201.N, e.g. to transmit dynamic semantic data from moving actors associated with a particular environment to be navigated by AVs. For instance, the communication interface 1110 may facilitate the transmission of the various metrics indicative of the vehicle's driving style/behavior as discussed herein, which may represent the dynamic semantic data and/or static semantic data used to train the behavioral models and the accompanying behavioral model graph dataset for a map section, map tile, region, etc., stored in the spatio-behavioral database 318.

The communication interface 1110 may facilitate performing queries via an API engine 1108 and the querying module 1109. The API engine 1108 may thus function to, in conjunction with the processing circuitry 1108, determine, format, and transmit a specific type of query, as well as receive, decode, and update the behavioral models 1107 to then execute (e.g. perform a maneuver) using the results of such a query returned from the behavioral model graph dataset, as discussed herein. Thus, the communication interface 1110 may facilitate the vehicle in which it is implemented receiving data in response to API queries to determine a specific type of behavioral model to use for a particular location and maneuver to be performed, as discussed herein.

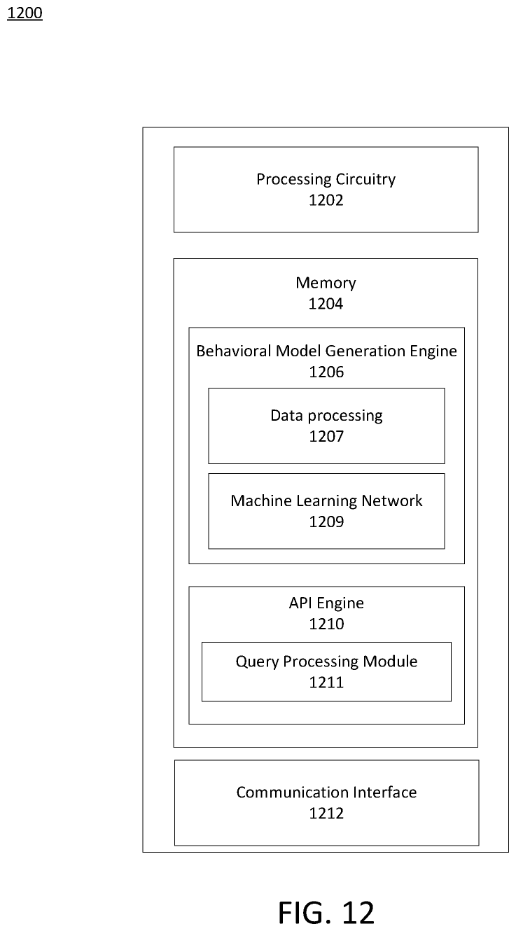

FIG. 12 illustrates an exemplary device, in accordance with various aspects of the present disclosure. The computing device 1200 may be implemented as part of (or the entirety of) an infrastructure component discussed herein, which may perform operations such as receiving transmitted static and dynamic semantic data, training and storing behavioral models, and providing data in response to specific queries of the stored behavioral model graph dataset. For instance, the computing device 1200 may be implemented as various infrastructure or network components such as a server, computer, cloud-based infrastructure component, etc.

In an aspect, the computing device 1200 may include processing circuitry 1202 as well as the one or more memories 1204 and a communication interface 1212. The components shown in FIG. 12 are provided for ease of explanation, and aspects include the computing device 1200 implementing additional, less, or alternative components as those shown in FIG. 12.

In various aspects, the processing circuitry 1202 may be configured as any suitable number and/or type of computer processors, which may function to control the computing device 1200 or other components of the component in which it is implemented. Processing circuitry 1202 may be identified with one or more processors (or suitable portions thereof) implemented by the computing device 1200. For example, the processing circuitry 1202 may, for example, be identified with one or more processors such as a host processor, a digital signal processor, one or more microprocessors, graphics processors, microcontrollers, an application-specific integrated circuit (ASIC), part (or the entirety of) a field-programmable gate array (FPGA), etc.

In any event, aspects include the processing circuitry 1202 being configured to carry out instructions to perform arithmetical, logical, and/or input/output (I/O) operations, and/or to control the operation of one or more components of computing device 1200 to perform various functions associated with the aspects as described herein from the perspective of one or more components that may communicate with one or more vehicles (e.g. AVs). For example, the processing circuitry 1202 may include one or more microprocessor cores, memory registers, buffers, clocks, etc., and may generate electronic control signals associated with electronic components to control and/or modify the operation of one or more components of the computing device 1200 as discussed herein. Moreover, aspects include processing circuitry 1202 communicating with and/or controlling functions associated with the memory 1204 and/or the communication interface 1212.

In an aspect, the memory 1204 stores data and/or instructions such that, when the instructions are executed by the processing circuitry 1202, the processing circuitry 1202 performs various functions as described herein. The memory 1204 can be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 1204 can be non-removable, removable, or a combination of both. For example, the memory 1204 may be implemented as a non-transitory computer readable medium storing one or more executable instructions such as, for example, logic, algorithms, code, etc.

As further discussed below, the instructions, logic, code, etc., stored in the memory 1204 are represented by the various modules as shown in FIG. 12, which may enable the aspects disclosed herein to be functionally realized. Alternatively, if the aspects described herein are implemented via hardware, the modules shown in FIG. 12 associated with the memory 1204 may include instructions and/or code to facilitate control and/or monitor the operation of such hardware components. In other words, the modules shown in FIG. 12 are provided for ease of explanation regarding the functional association between hardware and software components. Thus, aspects include the processing circuitry 1202 executing the instructions stored in these respective modules in conjunction with one or more hardware components to perform the various functions associated with the aspects as further discussed herein.

In an aspect, the executable instructions stored in the behavioral model generation engine 1206 may facilitate, in conjunction with the processing circuitry 1202, training or otherwise generating behavioral models using the static and dynamic sematic data as discussed herein. For example, the data processing module 1207 may include instructions to perform data preparation, labeling, filtering, and maneuver classification as discussed herein with reference to FIGS. 3 and 4. The machine learning network 1209 may, for example, use the results of the processed data via the data processing module 1207 to perform behavioral model generation and/or training in accordance with any suitable type of machine learning techniques. For instance, the machine learning training network 1209 may implement a neural network such as the LSTM as discussed herein with respect to FIGS. 5A-5B to generate maneuver and geolocation specific behavioral models.

In an aspect, the data processing module 1207 may additionally store the generated behavioral models as a behavioral model graph dataset in a suitable storage location, such as the spatio-behavioral database 318, for example, as discussed herein with reference to FIG. 3. Thus, the data processing module 1207 may facilitate in conjunction with the processing circuitry 1202 the conversion of behavioral models to the graph dataset format as discussed herein with reference to FIGS. 8A-8B, for example. The behavioral model graph dataset may be stored locally in the memory 1204 (not shown) or in another accessible location as discussed herein (e.g. via transmission to another database or storage location via the communication interface 1212).

To transmit and receive data, aspects include the computing device 1200 implementing a communication interface 1212. The communication interface 1212 may operate to enable communications in accordance with a suitable communication protocol. The communication interface may function to support the functionality described herein with respect to receiving queries and/or other data transmitted by vehicles or other components (e.g. the computing device 1100) to receive the static and dynamic semantic data associated with a particular environment to be navigated by AVs.

In an aspect, the API engine 1210 may function to transmit and receive queries and/or other data via the communication interface 1212. To do so, the querying processing module 1211 may include instructions that, when executed via the processing circuitry 1202, facilitate the decoding of received single and/or multi-node queries, as discussed herein with reference to FIGS. 9A-9B. The querying processing module 1211 may thus interpret a particular query for data and/or parameters associated with the behavioral model graph datasets as discussed herein. For instance, this may include matching a geolocation specified in a query to a geolocation represented by one of the road nodes in the behavioral model graph dataset, and determining the behavioral models and/or other data to extract and transmit in response to the query in accordance with the behavioral nodes connected to the identified road node(s). The querying processing module 1211 may also process queries and, once the appropriate querying information is determined, perform a multi-node query using the ensembling process as discussed herein with respect to FIG. 10.

Once the queried data has been retrieved, the querying processing module 1211 may function in conjunction with the communication interface 1212 to return the queried data via the API performed by the API engine 1210. Thus, the query processing module 1211 may function to, in conjunction with the processing circuitry 1202 and the API engine 1210, format and transmit the results of such a query returned from the behavioral model graph dataset, as discussed herein.

The aspects described herein may advantageously facilitate various applications by way of the storage and querying of the behavioral model graph dataset. For instance, once the results of a query are returned, an automated driving system may employ these results for customizing its behavior by loading the required parameters in its run-time environment. In addition, the results may be employed as a reporting mechanism to derive data-driven differences (gaps) between current driving behaviors and local regulations, or to condition reporting of automated vehicle performance in accordance to local driving behavior. Several examples of practical applications that may utilize the aspects as described herein include adjusting ego behavior, predicting better targets, fine tuning validation results to a geo location, and providing a concrete, data driven case to regulators for pre-deployment regulatory decisions.

### II. Autonomous Vehicle Architecture and Operation

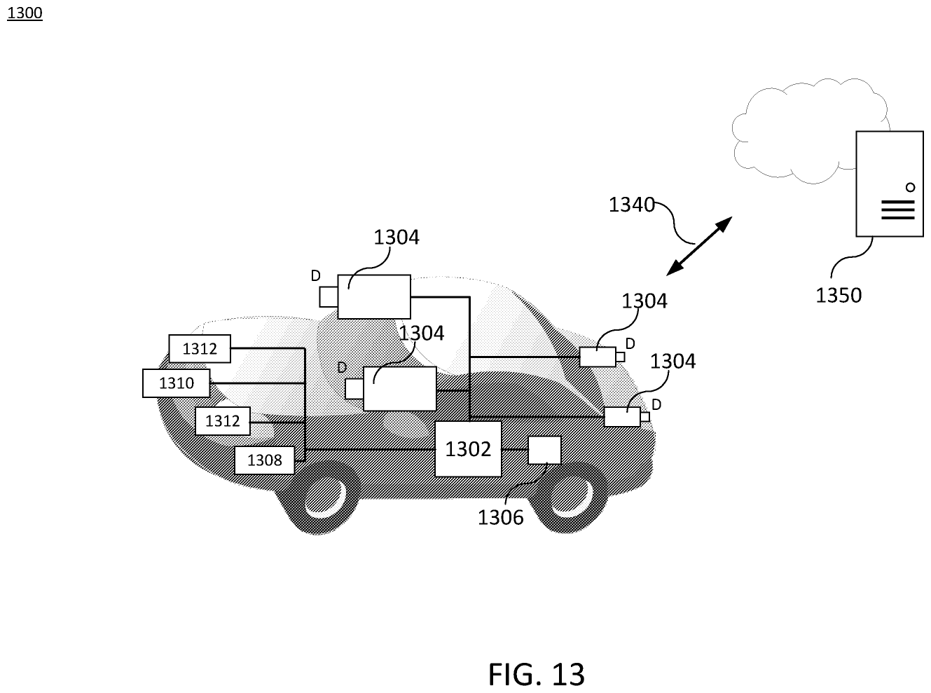

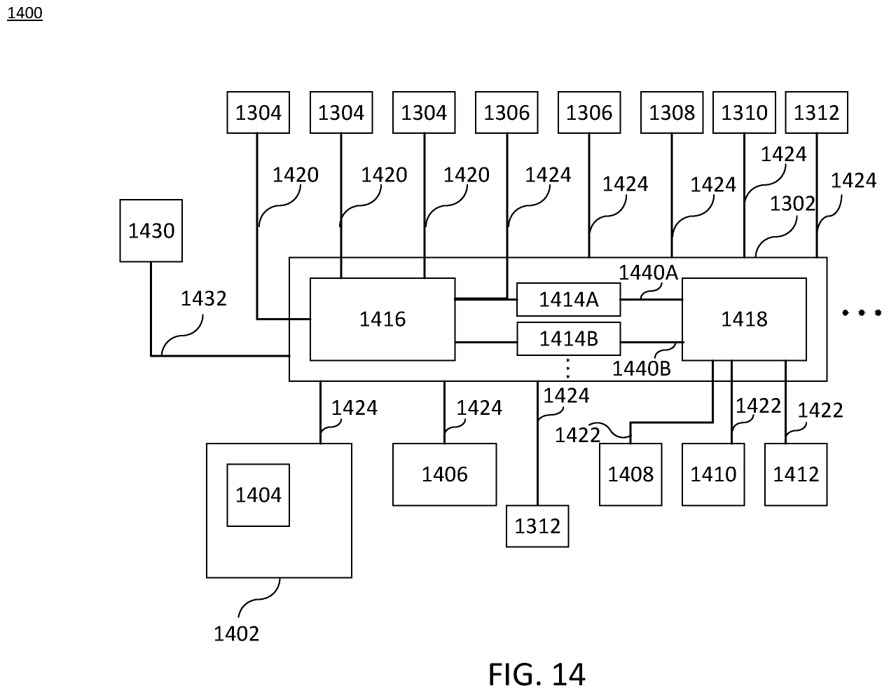

FIG. 13 shows a vehicle 1300 including a safety system 1400 (see also FIG. 14) in accordance with various aspects of the present disclosure. The vehicle 1300 and the safety system 1400 are exemplary in nature, and may thus be simplified for explanatory purposes. Locations of elements and relational distances (as discussed herein, the Figures are not to scale) are provided by way of example and not limitation. The safety system 1400 may include various components depending on the requirements of a particular implementation and/or application, and may facilitate the navigation and/or control of the vehicle 1300. The vehicle 1300 may be an autonomous vehicle (AV), which may include any level of automation (e.g. levels 0-5), which includes no automation or full automation (level 5). The vehicle 1300 may implement the safety system 1400 as part of any suitable type of autonomous or driver assistance control system, including AV and/or advanced driver-assistance system (ADAS), for instance. The safety system 1400 may include one or more components that are integrated as part of the vehicle 1300 during manufacture, part of an add-on or aftermarket device, or combinations of these. Thus, the various components of the safety system 1400 as shown in FIG. 14 may be integrated as part of the vehicle's systems and/or part of an aftermarket system that is installed in the vehicle 1300.

The one or more processors 1302 may be integrated with or separate from an electronic control unit (ECU) of the vehicle 1300 or an engine control unit of the vehicle 1300, which may be considered herein as a specialized type of an electronic control unit. The safety system 1400 may generate data to control or assist to control the ECU and/or other components of the vehicle 1300 to directly or indirectly control the driving of the vehicle 1300. However, the aspects described herein are not limited to implementation within autonomous or semi-autonomous vehicles, as these are provided by way of example. The aspects described herein may be implemented as part of any suitable type of vehicle that may be capable of travelling with or without any suitable level of human assistance in a particular driving environment. Therefore, one or more of the various vehicle components such as those discussed herein with reference to FIG. 14 for instance, may be implemented as part of a standard vehicle (i.e. a vehicle not using autonomous driving functions), a fully autonomous vehicle, and/or a semi-autonomous vehicle, in various aspects. In aspects implemented as part of a standard vehicle, it is understood that the safety system 1400 may perform alternate functions, and thus in accordance with such aspects the safety system 1400 may alternatively represent any suitable type of system that may be implemented by a standard vehicle without necessarily utilizing autonomous or semi-autonomous control related functions.

Regardless of the particular implementation of the vehicle 1300 and the accompanying safety system 1400 as shown in FIG. 13 and FIG. 14, the safety system 1400 may include one or more processors 1302, one or more image acquisition devices 1304 such as, e.g., one or more vehicle cameras or any other suitable sensor configured to perform image acquisition over any suitable range of wavelengths, one or more position sensors 1306, which may be implemented as a position and/or location-identifying system such as a Global Navigation Satellite System (GNSS), e.g., a Global Positioning System (GPS), one or more memories 1402, one or more map databases 1404, one or more user interfaces 1406 (such as, e.g., a display, a touch screen, a microphone, a loudspeaker, one or more buttons and/or switches, and the like), and one or more wireless transceivers 1408, 1410, 1412. Additionally or alternatively, the one or more user interfaces 1406 may be identified with other components in communication with the safety system 1400, such as one or more components of an ADAS unit, an AV system, etc., as further discussed herein.

The wireless transceivers 1408, 1410, 1412 may be configured to operate in accordance with any suitable number and/or type of desired radio communication protocols or standards. By way of example, a wireless transceiver (e.g., a first wireless transceiver 1408) may be configured in accordance with a Short-Range mobile radio communication standard such as e.g. Bluetooth, Zigbee, and the like. As another example, a wireless transceiver (e.g., a second wireless transceiver 1410) may be configured in accordance with a Medium or Wide Range mobile radio communication standard such as e.g. a 3G (e.g. Universal Mobile Telecommunications System—UMTS), a 4G (e.g. Long Term Evolution—LTE), or a 5G mobile radio communication standard in accordance with corresponding 3GPP (3rd Generation Partnership Project) standards, the most recent version at the time of this writing being the 3GPP Release 16 (2020).

As a further example, a wireless transceiver (e.g., a third wireless transceiver 1412) may be configured in accordance with a Wireless Local Area Network communication protocol or standard such as e.g. in accordance with IEEE 802.11 Working Group Standards, the most recent version at the time of this writing being IEEE Std 802.11™-2020, published Feb. 26, 2021 (e.g. 802.11, 802.11a, 802.11b, 802.11g, 802.11n, 802.11p, 802.11-12, 802.11ac, 802.11ad, 802.11ah, 802.11ax, 802.11ay, and the like). The one or more wireless transceivers 1408, 1410, 1412 may be configured to transmit signals via an antenna system (not shown) using an air interface. As additional examples, one or more of the transceivers 1408, 1410, 1412 may be configured to implement one or more vehicle to everything (V2X) communication protocols, which may include vehicle to vehicle (V2V), vehicle to infrastructure (V2I), vehicle to network (V2N), vehicle to pedestrian (V2P), vehicle to device (V2D), vehicle to grid (V2G), and any other suitable communication protocols.

One or more of the wireless transceivers 1408, 1410, 1412 may additionally or alternatively be configured to enable communications between the vehicle 1300 and one or more other remote computing devices via one or more wireless links 1340. This may include, for instance, communications with a remote server or other suitable computing system 1350 as shown in FIG. 13. The example shown FIG. 13 illustrates such a remote computing system 1350 as a cloud computing system, although this is by way of example and not limitation, and the computing system 1350 may be implemented in accordance with any suitable architecture and/or network and may constitute one or several physical computers, servers, processors, etc. that comprise such a system. As another example, the remote computing system 1350 may be implemented as an edge computing system and/or network.

The one or more processors 1302 may implement any suitable type of processing circuitry, other suitable circuitry, memory, etc., and utilize any suitable type of architecture. The one or more processors 1302 may be configured as a controller implemented by the vehicle 1300 to perform various vehicle control functions, navigational functions, etc. For example, the one or more processors 1302 may be configured to function as a controller for the vehicle 1300 to analyze sensor data and received communications, to calculate specific actions for the vehicle 1300 to execute for navigation and/or control of the vehicle 1300, and to cause the corresponding action to be executed, which may be in accordance with an AV or ADAS system, for instance. The one or more processors 1302 and/or the safety system 1400 may form the entirety of or a portion of an advanced driver-assistance system (ADAS).

Moreover, one or more of the processors 1414A, 1414B, 1416, and/or 1418 of the one or more processors 1302 may be configured to work in cooperation with one another and/or with other components of the vehicle 1300 to collect information about the environment (e.g., sensor data, such as images, depth information (for a Lidar for example), etc.). In this context, one or more of the processors 1414A, 1414B, 1416, and/or 1418 of the one or more processors 1302 may be referred to as “processors.” The processors can thus be implemented (independently or together) to create mapping information from the harvested data, e.g., Road Segment Data (RSD) information that may be used for Road Experience Management (REM) mapping technology, the details of which are further described below. As another example, the processors can be implemented to process mapping information (e.g. roadbook information used for REM mapping technology) received from remote servers over a wireless communication link (e.g. link 1340) to localize the vehicle 1300 on an AV map, which can be used by the processors to control the vehicle 1300.

The one or more processors 1302 may include one or more application processors 1414A, 1414B, an image processor 1416, a communication processor 1418, and may additionally or alternatively include any other suitable processing device, circuitry, components, etc. not shown in the Figures for purposes of brevity. Similarly, image acquisition devices 1304 may include any suitable number of image acquisition devices and components depending on the requirements of a particular application. Image acquisition devices 1304 may include one or more image capture devices (e.g., cameras, charge coupling devices (CCDs), or any other type of image sensor). The safety system 1400 may also include a data interface communicatively connecting the one or more processors 1302 to the one or more image acquisition devices 1304. For example, a first data interface may include any wired and/or wireless first link 1420, or first links 1420 for transmitting image data acquired by the one or more image acquisition devices 1304 to the one or more processors 1302, e.g., to the image processor 1416.

The wireless transceivers 1408, 1410, 1412 may be coupled to the one or more processors 1302, e.g., to the communication processor 1418, e.g., via a second data interface. The second data interface may include any wired and/or wireless second link 1422 or second links 1422 for transmitting radio transmitted data acquired by wireless transceivers 1408, 1410, 1412 to the one or more processors 1302, e.g., to the communication processor 1418. Such transmissions may also include communications (one-way or two-way) between the vehicle 1300 and one or more other (target) vehicles in an environment of the vehicle 1300 (e.g., to facilitate coordination of navigation of the vehicle 1300 in view of or together with other (target) vehicles in the environment of the vehicle 1300), or even a broadcast transmission to unspecified recipients in a vicinity of the transmitting vehicle 1300.

The memories 1402, as well as the one or more user interfaces 1406, may be coupled to each of the one or more processors 1302, e.g., via a third data interface. The third data interface may include any wired and/or wireless third link 1424 or third links 1424. Furthermore, the position sensors 1306 may be coupled to each of the one or more processors 1302, e.g., via the third data interface.

Each processor 1414A, 1414B, 1416, 1418 of the one or more processors 1302 may be implemented as any suitable number and/or type of hardware-based processing devices (e.g. processing circuitry), and may collectively, i.e. with the one or more processors 1302 form one or more types of controllers as discussed herein. The architecture shown in FIG. 14 is provided for ease of explanation and as an example, and the vehicle 1300 may include any suitable number of the one or more processors 1302, each of which may be similarly configured to utilize data received via the various interfaces and to perform one or more specific tasks.

For example, the one or more processors 1302 may form a controller that is configured to perform various control-related functions of the vehicle 1300 such as the calculation and execution of a specific vehicle following speed, velocity, acceleration, braking, steering, trajectory, etc. As another example, the vehicle 1300 may, in addition to or as an alternative to the one or more processors 1302, implement other processors (not shown) that may form a different type of controller that is configured to perform additional or alternative types of control-related functions. Each controller may be responsible for controlling specific subsystems and/or controls associated with the vehicle 1300. In accordance with such aspects, each controller may receive data from respectively coupled components as shown in FIG. 14 via respective interfaces (e.g. 1420, 1422, 1424, 1432, etc.), with the wireless transceivers 1408, 1410, and/or 1412 providing data to the respective controller via the second links 1422, which function as communication interfaces between the respective wireless transceivers 1408, 1410, and/or 1412 and each respective controller in this example.

To provide another example, the application processors 1414A, 1414B may individually represent respective controllers that work in conjunction with the one or more processors 1302 to perform specific control-related tasks. For instance, the application processor 1414A may be implemented as a first controller, whereas the application processor 1414B may be implemented as a second and different type of controller that is configured to perform other types of tasks as discussed further herein. In accordance with such aspects, the one or more processors 1302 may receive data from respectively coupled components as shown in FIG. 14 via the various interfaces 1420, 1422, 1424, 1432, etc., and the communication processor 1418 may provide communication data received from other vehicles (or to be transmitted to other vehicles) to each controller via the respectively coupled links 1440A, 1440B, which function as communication interfaces between the respective application processors 1414A, 1414B and the communication processors 1418 in this example. Of course, the application processors 1414A, 1414B may perform other functions in addition to or as an alternative to control-based functions, such as the various processing functions discussed herein, providing ADAS alerts, providing warnings regarding possible collisions, etc.

The one or more processors 1302 may additionally be implemented to communicate with any other suitable components of the vehicle 1300 to determine a state of the vehicle while driving or at any other suitable time, which may comprise an analysis of data representative of a vehicle status. For instance, the vehicle 1300 may include one or more vehicle computers, sensors, ECUs, interfaces, etc., which may collectively be referred to as vehicle components 1430 as shown in FIG. 14. The one or more processors 1302 are configured to communicate with the vehicle components 1430 via an additional data interface 1432, which may represent any suitable type of links and operate in accordance with any suitable communication protocol (e.g. CAN bus communications). Using the data received via the data interface 1432, the one or more processors 1302 may determine any suitable type of vehicle status information such as the current drive gear, current engine speed, acceleration capabilities of the vehicle 1300, etc. As another example, various metrics used to control the speed, acceleration, braking, steering, etc. may be received via the vehicle components 1430, which may include receiving any suitable type of signals that are indicative of such metrics or varying degrees of how such metrics vary over time (e.g. brake force, wheel angle, reverse gear, etc.).

The one or more processors 1302 may include any suitable number of other processors 1414A, 1414B, 1416, 1418, each of which may comprise processing circuitry such as sub-processors, a microprocessor, pre-processors (such as an image pre-processor), graphics processors, a central processing unit (CPU), support circuits, digital signal processors, integrated circuits, memory, or any other types of devices suitable for running applications and for data processing (e.g. image processing, audio processing, etc.) and analysis and/or to enable vehicle control to be functionally realized. In some aspects, each processor 1414A, 1414B, 1416, 1418 may include any suitable type of single or multi-core processor, microcontroller, central processing unit, etc. These processor types may each include multiple processing units with local memory and instruction sets. Such processors may include video inputs for receiving image data from multiple image sensors, and may also include video out capabilities.

Any of the processors 1414A, 1414B, 1416, 1418 disclosed herein may be configured to perform certain functions in accordance with program instructions, which may be stored in the local memory of each respective processor 1414A, 1414B, 1416, 1418, or accessed via another memory that is part of the safety system 1400 or external to the safety system 1400. This memory may include the one or more memories 1402. Regardless of the particular type and location of memory, the memory may store software and/or executable (i.e. computer-readable) instructions that, when executed by a relevant processor (e.g., by the one or more processors 1302, one or more of the processors 1414A, 1414B, 1416, 1418, etc.), controls the operation of the safety system 200 and may perform other functions such those identified with the aspects described in further detail below. As one example, the one or more processors 1302, which may include one or more of the processors 1414A, 1414B, 1416, 1418, etc., may execute the computer-readable instructions to implement one or more trained models to thereby perform various vehicle-based functions. To provide an illustrative example, the computer-readable instructions may be stored in any suitable memory (e.g. the memory 1402) and be executed via the one or more processors 1302 to realize the functionality in accordance with any of the trained models as discussed herein. Such models may comprise the vehicle behavioral models as discussed in Section I above, and may be executed in accordance with the SDM parameters as noted herein to ensure that the vehicle-based functions are performed in a safe manner. These models may be trained in accordance with any suitable techniques as discussed herein, and may implement any suitable architecture, including the LTSM architectures as discussed above with respect to Section I and/or the architectures as further discussed below (e.g. those discussed with respect to Section V and onwards).

A relevant memory accessed by the one or more processors 1414A, 1414B, 1416, 1418 (e.g. the one or more memories 1402) may also store one or more databases and image processing software, as well as a trained system, such as a neural network, or a deep neural network, for example, that may be utilized to perform the tasks in accordance with any of the aspects as discussed herein. A relevant memory accessed by the one or more processors 1414A, 1414B, 1416, 1418 (e.g. the one or more memories 1402) may be implemented as any suitable number and/or type of non-transitory computer-readable medium such as random-access memories, read only memories, flash memories, disk drives, optical storage, tape storage, removable storage, or any other suitable types of storage.

The components associated with the safety system 1400 as shown in FIG. 14 are illustrated for ease of explanation and by way of example and not limitation. The safety system 1400 may include additional, fewer, or alternate components as shown and discussed herein with reference to FIG. 14. Moreover, one or more components of the safety system 1400 may be integrated or otherwise combined into common processing circuitry components or separated from those shown in FIG. 14 to form distinct and separate components. For instance, one or more of the components of the safety system 1400 may be integrated with one another on a common die or chip. As an illustrative example, the one or more processors 1302 and the relevant memory accessed by the one or more processors 1414A, 1414B, 1416, 1418 (e.g. the one or more memories 1402) may be integrated on a common chip, die, package, etc., and together comprise a controller or system configured to perform one or more specific tasks or functions.

In some aspects, the safety system 1400 may further include components such as a speed sensor 1308 (e.g. a speedometer) for measuring a speed of the vehicle 1300. The safety system 1400 may also include one or more inertial measurement unit (IMU) sensors such as e.g. accelerometers, magnetometers, and/or gyroscopes (either single axis or multiaxis) for measuring accelerations of the vehicle 1300 along one or more axes, and additionally or alternatively one or more gyro sensors, which may be implemented for instance to calculate the vehicle's ego-motion as discussed herein, alone or in combination with other suitable vehicle sensors. These IMU sensors may, for example, be part of the position sensors 1306 as discussed herein. The safety system 200 may further include additional sensors or different sensor types such as an ultrasonic sensor, a thermal sensor, one or more radar sensors 1310, one or more LIDAR sensors 1312 (which may be integrated in the head lamps of the vehicle 1300), digital compasses, and the like. The radar sensors 1310 and/or the LIDAR sensors 1312 may be configured to provide pre-processed sensor data, such as radar target lists or LIDAR target lists. The third data interface (e.g., one or more links 1424) may couple the speed sensor 1308, the one or more radar sensors 1310, and the one or more LIDAR sensors 1312 to at least one of the one or more processors 1302.

### III. Autonomous Vehicle (AV) Map Data and Road Experience Management (REM)

Data referred to as REM map data (or alternatively as roadbook map data), may also be stored in a relevant memory accessed by the one or more processors 1414A, 1414B, 1416, 1418 (e.g. the one or more memories 1402) or in any suitable location and/or format, such as in a local or cloud-based database, accessed via communications between the vehicle and one or more external components (e.g. via the transceivers 1408, 1410, 1412), etc. It is noted that although referred to herein as “AV map data,” the data may be implemented in any suitable vehicle platform, which may include vehicles having any suitable level of automation (e.g. levels 0-5), as noted above.

Regardless of where the AV map data is stored and/or accessed, the AV map data may include a geographic location of known landmarks that are readily identifiable in the navigated environment in which the vehicle 1300 travels. The location of the landmarks may be generated from a historical accumulation from other vehicles driving on the same road that collect data regarding the appearance and/or location of landmarks (e.g. “crowd sourcing”). Thus, each landmark may be correlated to a set of predetermined geographic coordinates that has already been established. Therefore, in addition to the use of location-based sensors such as GNSS, the database of landmarks provided by the AV map data enables the vehicle 1300 to identify the landmarks using the one or more image acquisition devices 1304. Once identified, the vehicle 1300 may implement other sensors such as LIDAR, accelerometers, speedometers, etc. or images from the image acquisitions device 1304, to evaluate the position and location of the vehicle 1300 with respect to the identified landmark positions.

Furthermore, and as noted above, the vehicle 1300 may determine its own motion, which is referred to as “ego-motion.” Ego-motion is generally used for computer vision algorithms and other similar algorithms to represent the motion of a vehicle camera across a plurality of frames, which provides a baseline (i.e. a spatial relationship) that can be used to compute the 3D structure of a scene from respective images. The vehicle 1300 may analyze the ego-motion to determine the position and orientation of the vehicle 1300 with respect to the identified known landmarks. Because the landmarks are identified with predetermined geographic coordinates, the vehicle 1300 may determine its position on a map based upon a determination of its position with respect to identified landmarks using the landmark-correlated geographic coordinates. Doing so provides distinct advantages that combine the benefits of smaller scale position tracking with the reliability of GNSS positioning systems while avoiding the disadvantages of both systems. It is further noted that the analysis of ego motion in this manner is one example of an algorithm that may be implemented with monocular imaging to determine a relationship between a vehicle's location and the known location of known landmark(s), thus assisting the vehicle to localize itself. However, ego-motion is not necessary or relevant for other types of technologies, and therefore is not essential for localizing using monocular imaging. Thus, in accordance with the aspects as described herein, the vehicle 1300 may leverage any suitable type of localization technology.

Thus, the AV map data is generally constructed as part of a series of steps, which may involve any suitable number of vehicles that opt into the data collection process. For instance, Road Segment Data (RSD) is collected as part of a harvesting step. As each vehicle collects data, the data is classified into tagged data points, which are then transmitted to the cloud or to another suitable external location. A suitable computing device (e.g. a cloud server) then analyzes the data points from individual drives on the same road, and aggregates and aligns these data points with one another. After alignment has been performed, the data points are used to define a precise outline of the road infrastructure. Next, relevant semantics are identified that enable vehicles to understand the immediate driving environment, i.e. features and objects are defined that are linked to the classified data points. The features and objects defined in this manner may include, for instance, traffic lights, road arrows, signs, road edges, drivable paths, lane split points, stop lines, lane markings, etc. to the driving environment so that a vehicle may readily identify these features and objects using the AV map data. This information is then compiled into a Roadbook Map, which constitutes a bank of driving paths, semantic road information such as features and objects, and aggregated driving behavior.

A map database 1404, which may be stored as part of the one or more memories 1402 or accessed via the computing system 1350 via the link(s) 1340, for instance, may include any suitable type of database configured to store (digital) map data for the vehicle 1300, e.g., for the safety system 1400. The one or more processors 1302 may download information to the map database 1404 over a wired or wireless data connection (e.g. the link(s) 1340) using a suitable communication network (e.g., over a cellular network and/or the Internet, etc.). Again, the map database 1404 may store the AV map data, which includes data relating to the position, in a reference coordinate system, of various landmarks such as objects and other items of information, including roads, water features, geographic features, businesses, points of interest, restaurants, gas stations, etc.

The map database 404 may thus store, as part of the AV map data, not only the locations of such landmarks, but also descriptors relating to those landmarks, including, for example, names associated with any of the stored features, and may also store information relating to details of the items such as a precise position and orientation of items. In some cases, the AV map data may store a sparse data model including polynomial representations of certain road features (e.g., lane markings) or target trajectories for the vehicle 1300. The AV map data may also include stored representations of various recognized landmarks that may be provided to determine or update a known position of the vehicle 1300 with respect to a target trajectory. The landmark representations may include data fields such as landmark type, landmark location, etc., among other potential identifiers. The AV map data may also include non-semantic features including point clouds of certain objects or features in the environment, and feature point and descriptors.

The map database 1404 may be augmented with data in addition to the AV map data, and/or the map database 1404 and/or the AV map data may reside partially or entirely as part of the remote computing system 1350. As discussed herein, the location of known landmarks and map database information, which may be stored in the map database 1404 and/or the remote computing system 1350, may form what is referred to herein as “AV map data,” “REM map data” or “Roadbook Map data.” The one or more processors 1302 may process sensory information (such as images, radar signals, depth information from LIDAR or stereo processing of two or more images) of the environment of the vehicle 1300 together with position information, such as GPS coordinates, the vehicle's ego-motion, etc., to determine a current location, position, and/or orientation of the vehicle 1300 relative to the known landmarks by using information contained in the AV map. The determination of the vehicle's location may thus be refined in this manner. Certain aspects of this technology may additionally or alternatively be included in a localization technology such as a mapping and routing model.

### IV. An Example Safety Driving Model

Furthermore, the safety system 1400 may implement a safety driving model or SDM (also referred to as a “driving policy model,” “driving policy,” or simply as a “driving model”), e.g., which may be utilized and/or executed as part of the ADAS system as discussed herein. By way of example, the safety system 1400 may include (e.g. as part of the driving policy) a computer implementation of a formal model such as a safety driving model. A safety driving model may include an implementation of a mathematical model formalizing an interpretation of applicable laws, standards, policies, etc. that are applicable to self-driving (e.g., ground) vehicles. In some embodiments, the SDM may comprise a standardized driving policy such as the Responsibility Sensitivity Safety (RSS) model. However, the embodiments are not limited to this particular example, and the SDM may be implemented using any suitable driving policy model that defines various safety parameters that the AV should comply with to facilitate safe driving.

For instance, the SDM may be designed to achieve, e.g., three goals: first, the interpretation of the law should be sound in the sense that it complies with how humans interpret the law; second, the interpretation should lead to a useful driving policy, meaning it will lead to an agile driving policy rather than an overly-defensive driving which inevitably would confuse other human drivers and will block traffic, and in turn limit the scalability of system deployment; and third, the interpretation should be efficiently verifiable in the sense that it can be rigorously proven that the self-driving (autonomous) vehicle correctly implements the interpretation of the law. An implementation in a host vehicle of a safety driving model (e.g. the vehicle 1300) may be or include an implementation of a mathematical model for safety assurance that enables identification and performance of proper responses to dangerous situations such that self-perpetrated accidents can be avoided.

A safety driving model may implement logic to apply driving behavior rules such as the following five rules:
Do not hit someone from behind.
Do not cut-in recklessly.
Right-of-way is given, not taken.
Be careful of areas with limited visibility.
If you can avoid an accident without causing another one, you must do it.

It is to be noted that these rules are not limiting and not exclusive, and can be amended in various aspects as desired. The rules thus represent a social driving “contract” that might be different depending upon the region, and may also develop over time. While these five rules are currently applicable in most countries, the rules may not be complete or the same in each region or country and may be amended.

As described above, the vehicle 1300 may include the safety system 1400 as also described with reference to FIG. 14. Thus, the safety system 1400 may generate data to control or assist to control the ECU of the vehicle 1300 and/or other components of the vehicle 1300 to directly or indirectly navigate and/or control the driving operation of the vehicle 1300, such navigation including driving the vehicle 1300 or other suitable operations as further discussed herein. This navigation may optionally include adjusting one or more SDM parameters, which may occur in response to the detection of any suitable type of feedback that is obtained via image processing, sensor measurements, etc. The feedback used for this purpose may be collectively referred to herein as “environmental data measurements” and include any suitable type of data that identifies a state associated with the external environment, the vehicle occupants, the vehicle 1300, and/or the cabin environment of the vehicle 1300, etc.

For instance, the environmental data measurements may be used to identify a longitudinal and/or lateral distance between the vehicle 1300 and other vehicles, the presence of objects in the road, the location of hazards, etc. The environmental data measurements may be obtained and/or be the result of an analysis of data acquired via any suitable components of the vehicle 1300, such as the one or more image acquisition devices 1304, the position sensors 1306, the speed sensor 1308, the one or more radar sensors 1310, the one or more LIDAR sensors 1312, etc. To provide an illustrative example, the environmental data may be used to generate an environmental model based upon any suitable combination of the environmental data measurements. Thus, the vehicle 1300 may utilize the tasks performed via trained model(s) to perform various navigation-related operations within the framework of the driving policy model.

The navigation-related operation may be performed, for instance, by generating the environmental model and using the driving policy model in conjunction with the environmental model to determine an action to be carried out by the vehicle. That is, the driving policy model may be applied based upon the environmental model to determine one or more actions (e.g. navigation-related operations) to be carried out by the vehicle. The SDM can be used in conjunction (as part of or as an added layer) with the driving policy model to assure a safety of an action to be carried out by the vehicle at any given instant. For example, the ADAS may leverage or reference the SDM parameters defined by the safety driving model to determine navigation-related operations of the vehicle 1300 in accordance with the environmental data measurements depending upon the particular scenario. The navigation-related operations may thus cause the vehicle 1300 to execute a specific action based upon the environmental model to comply with the SDM parameters defined by the SDM model as discussed herein. For instance, navigation-related operations may include steering the vehicle 1300, changing an acceleration and/or velocity of the vehicle 1300, executing predetermined trajectory maneuvers, etc. In other words, the environmental model may be generated, and the applicable driving policy model may then be applied together with the environmental model to determine a navigation-related operation to be performed by the vehicle.

### V. Uncertainty Aware Vehicle Trajectory Prediction

The aspects as described in this Section may be implemented as independent embodiments or combined with any of those discussed above to provide additional improvements by leveraging the use of certainty and uncertainty score computations with respect to trained behavioral models or other suitable trained models. For instance, many conventional trajectory prediction algorithms fail to consider visual cues, and uncertainties in trajectory prediction presents unique difficulties to overcome. The aspects described in this Section may outperform conventional systems, in terms of both prediction and uncertainty metrics, using a public dataset. To do so, and as further discussed below, new uncertainty metrics are implemented that provide better out-of-distribution data detection. The uncertainty metrics as discussed in further detail below are provided in the context of path planning for a vehicle (e.g. via the safety system 1400 as described herein) using predicted trajectories of other road agents (e.g. other vehicles) within a navigated environment. However, it is noted that this is an example usage of the trained behavior models as discussed herein, which may be applied to any suitable application for which multiple predictions may be performed and relied upon to perform various functions, which may or may not be vehicle-based functions depending upon the particular application.

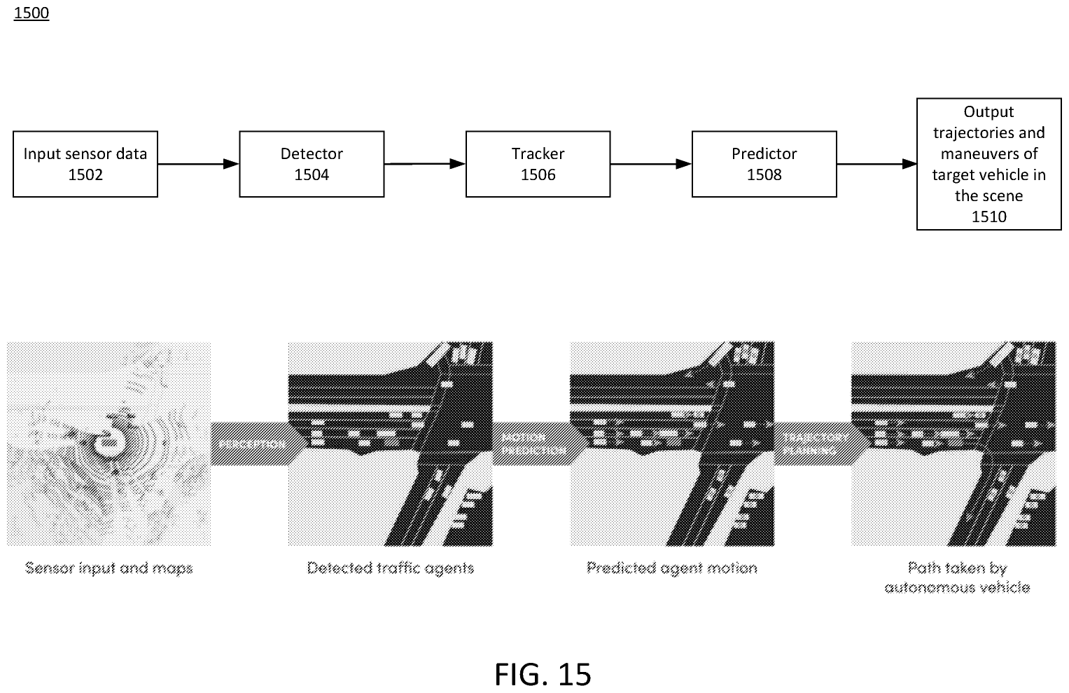

FIG. 15 illustrates an example trajectory maneuver computational process, in accordance with one or more aspects of the present disclosure. The process as shown in FIG. 15 illustrates a general training flow or “pipeline” that may be implemented to train a model in accordance with the aspects as discussed in further detail herein to determine one or more output trajectories for a target road agent, which may be a vehicle within a driving environment. The process flow as shown in FIG. 15 may be identified with a process that is used to train a model that is subsequently deployed and locally executed by the vehicle 1300 at inference in accordance with any of the aspects as discussed herein.

For example, the trained behavioral model (also referred to herein as simply a “trained model”) may output predicted trajectories of a target agent (e.g. another vehicle or the “ego” vehicle, i.e. the vehicle in which the trained model is deployed), which may then be used (e.g. via the safety system 1400) to determine and/or execute a vehicle-based function, such as a path to take via the use of controlled steering, braking, acceleration, etc. The process as shown in FIG. 15, as well as any of the processes discussed throughout is Section, may be implemented via any suitable combination of computing devices (e.g. the computing devices 1100, 1200 as discussed herein with reference to FIGS. 11 and 12, any components of the safety system 1400 such as the one or more processors 1302), processing circuitry, and/or may be implemented using any suitable network architecture, which may include any suitable type of network architecture used to train and/or use (e.g. at inference) the machine learning models as discussed herein.

As shown in FIG. 15, input sensor data 1502 may be received from one or more sources, such as on-vehicle sensor inputs and/or accessed map data. Thus, the input sensor data may comprise any suitable number of input images and map data, which may identify various map features. As part of the training process, a computing system may execute one or more perception algorithms (e.g. via execution of stored instructions via the one or more processors as noted herein). The perception algorithms may be of any suitable type, including known types, which may function to identify various traffic agents using classification techniques. Thus, the perception algorithms are then applied to the input images to detect traffic agents, as represented by the detector block 1504. The tracker block 1506 represents the use of the traffic agent detection to detect and track the motion of detected traffic agents over time.

The flow 1500 further includes the execution of motion prediction algorithms to perform agent motion prediction, as represented by the predictor block 1508. The predictor block 1508 thus functions to identify sets of predicted trajectories for each target road agent, which are represented in FIG. 15 as block 1510. Once trained in this manner, the computed output trajectories and maneuvers of each target road agent may be further correlated with certainty scores and uncertainty scores, as discussed in further detail below. Then, a vehicle (e.g. vehicle 1300) may utilize the predicted trajectories of the target road agents in conjunction with their corresponding certainty and uncertainty scores to compute a vehicle-based function, e.g. a path to be taken by the vehicle 1300.

In this way, the model that is trained in accordance with the process as described by the process flow 1500 functions to improve safety, as the AV planning algorithms depend upon the traffic agents' next movements as opposed to their currently-detected state. Thus, the trajectory planning algorithms may be implemented using the results of the motion prediction to output the maneuvers of a target vehicle within a road scene that follow a particular trajectory. The manner in which the trajectories are computed, as well as the path taken by the AV and maneuvers executed to follow these computed trajectories (e.g. blocks 1508, 1510), is one focus of this Section. For instance, and as further discussed below, the aspects may implement uncertainty estimation to add an additional safety layer of informed decision making. As an illustrative example, an AV may give control of the vehicle to a human driver when the uncertainty regarding the next trajectory exceeds a threshold uncertainty value.

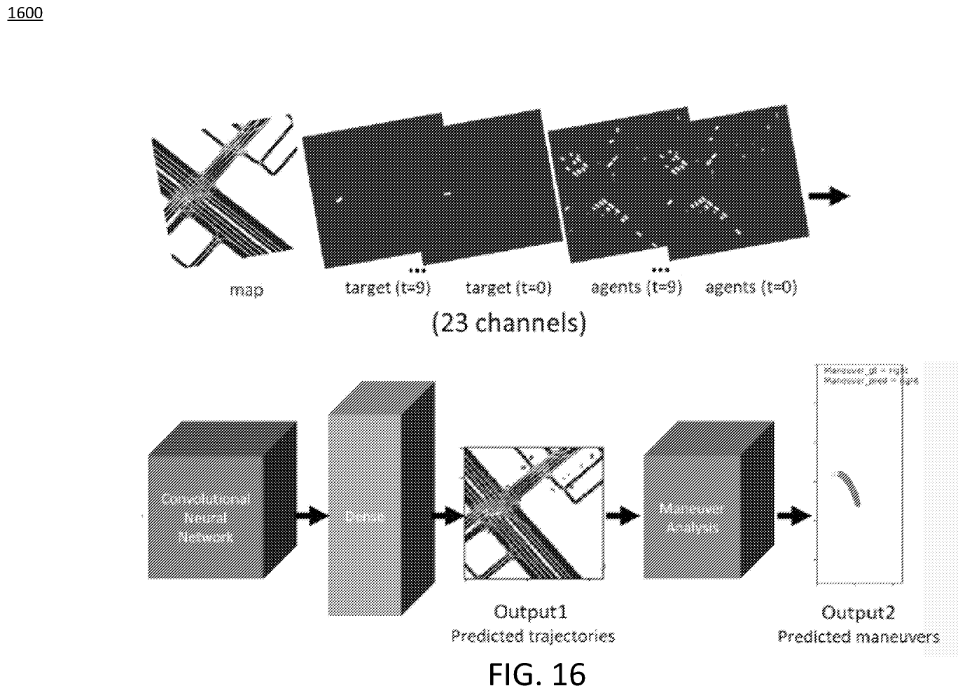

FIG. 16 illustrates an example trajectory and maneuver analysis flow, in accordance with one or more aspects of the present disclosure. The flow 1600 as shown in FIG. 16 implements a conventional convolutional neural network (CNN) to compute target object trajectories for path planning. That is, in contrast with the aspects as described in further detail below, which utilizes correlated certainty and uncertainty scores, the process flow 1600 utilizes a trained CNN to predict target object trajectories to perform path planning without considering such metrics.

For example, the flow 1600 as shown in FIG. 16 identifies 23 channels as inputs to a convolutional neural network, although this is by way of example and not limitation. The CNN may be part of a vehicle (e.g. an AV and/or the vehicle 1300) or other suitable device, which receives any suitable number and/or type of inputs to perform trajectory prediction. For example, the CNN may include any suitable number of input layers configured to receive map data and/or sensor data that identifies (e.g. detects) any suitable number of road agents, which may include a subset of targets for which the trajectories are to be predicted. One or more of the 23 channels as shown in FIG. 16 may represent, for instance, agent masks.

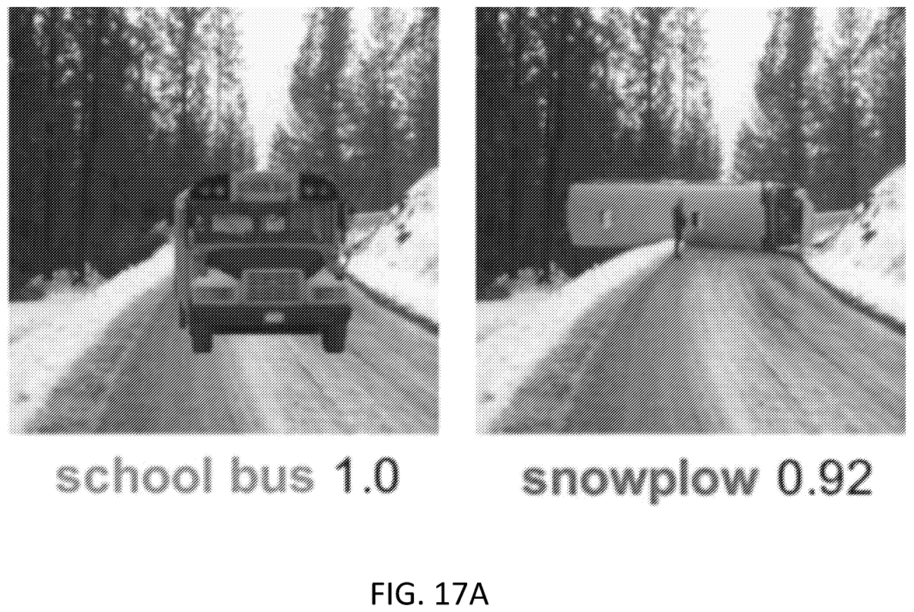

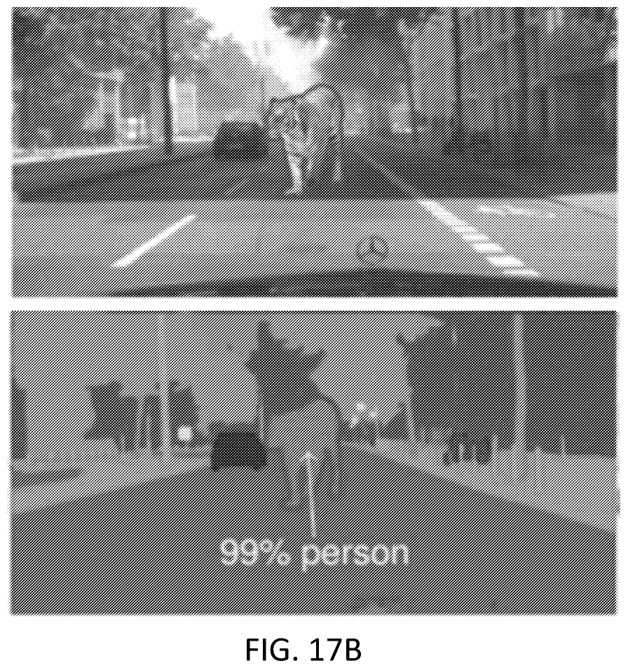

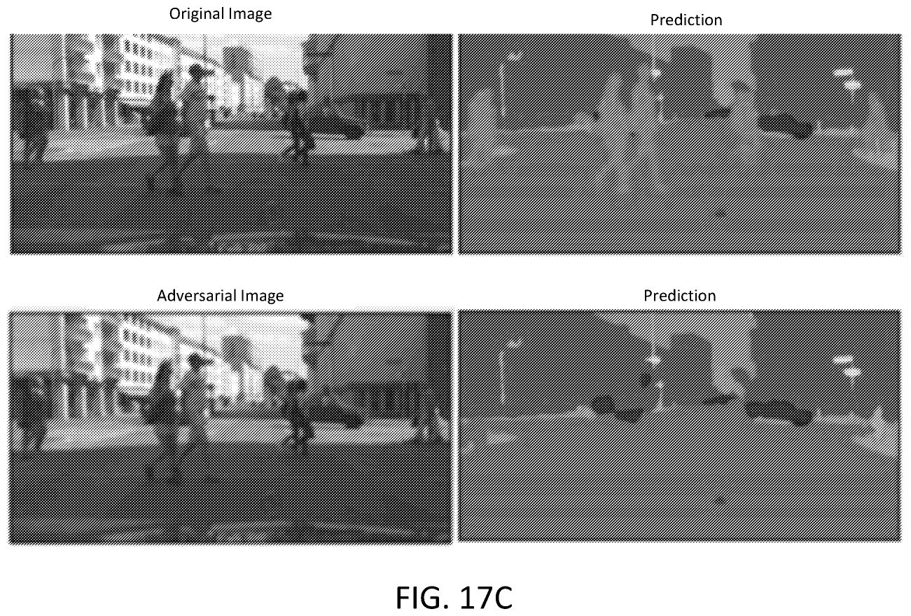

FIGS. 17A-17C illustrate examples of the limitations of conventional deep learning systems, such as those used to perform trajectory estimation and path planning as discussed above with respect to FIG. 16. As shown in FIGS. 17A-17C, conventional deep learning algorithms only provide deterministic point estimates, and fail to perform uncertainty estimates. However, predictive uncertainty includes both aleatoric uncertainty with respect to the input and/or data, as well as epistemic uncertainty with respect to the model. For example, a higher uncertainty on anomalous objects indicates that the model cannot be trusted to make accurate predictions on these pixels.

Due to this uncertainty, the resulting model predictions may be inaccurate, as shown in FIGS. 17A-17C. For instance, conventional CNN models may output predictions, but fail to output information regarding the novelty of the input data with respect to the training data used to train the CNN model to make those predictions. Thus, and as shown in FIG. 17A, conventional CNNs and other deep learning algorithms may provide a high probability (e.g. likelihood) with respect to a particular prediction (e.g. a classification in this case) being correct, but this prediction may still be incorrect because the data used to make the prediction was not present (or was rarely present) in the training dataset. For instance, FIG. 17B provides a further example in which an object is incorrectly classified, although the probability of the prediction being correct that is output is still a high value. Furthermore, FIG. 17C demonstrates an example of these phenomena being a weakness of conventional CNN algorithms that may be exploited using adversarial images to prevent objects from being correctly classified or detected.

Thus, to remedy these issues with respect to conventional deep learning models, the aspects as described herein utilize a trained model that allows for certainty and uncertainty scores to be correlated with each one of a set of predicted trajectories. This enables a relevant computing system (e.g. the safety system 1400) to utilize these scores at inference to improve the accuracy of the path planning maneuvers that are performed in response to the selected trajectories, as further discussed herein. Thus, the aspects as described herein utilize a model training process that enables outputs at inference to indicate a higher uncertainty for anomalous objects that indicate that model should not be “trusted” in this scenario.

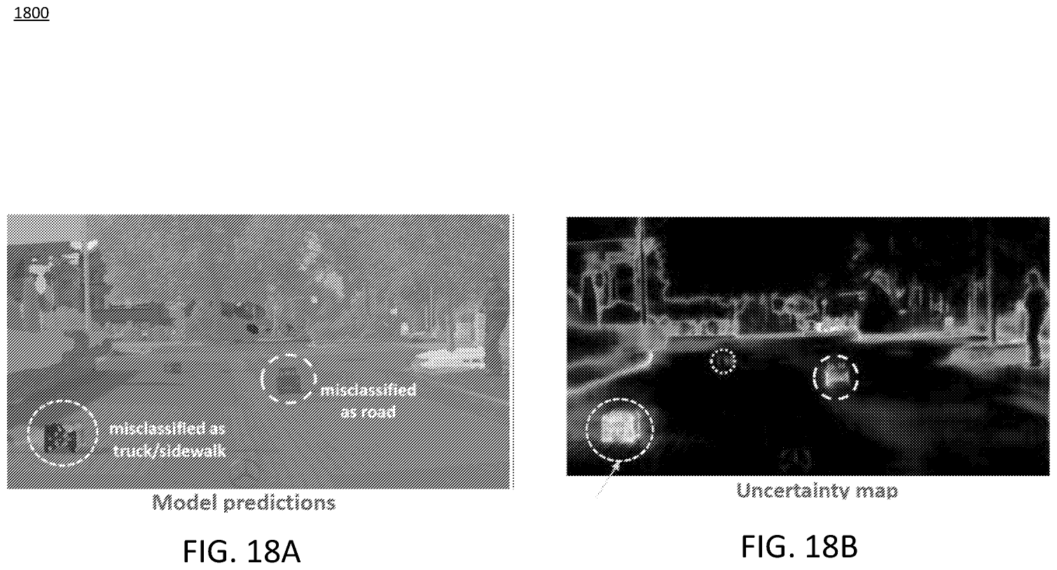

For example, FIG. 18A provides an image that comprises model predictions that indicate misclassifications, whereas the uncertainty map as shown in FIG. 18B indicates an uncertainty map with brighter colors indicative of a higher uncertainty per pixel prediction. That is, for the example image shown in FIG. 18A, the pixels identified with the two different objects may be incorrectly classified. Therefore, FIG. 18B represents an uncertainty analysis in accordance with the same trained model that performed the object classifications as shown in FIG. 18A. The color coding as shown in FIG. 18B indicates a level of uncertainty with respect to the object classifications of the classification tasks. Thus, the brighter images in the uncertainty map as shown in FIG. 18B indicate that the misclassified pixels are also identified with a high uncertainty. As discussed in further detail directly below, the aspects as further described herein expand this use of uncertainty to the computation of the trajectories for use in path planning. That is, the aspects as further discussed herein recognize that a model may be trained to output the uncertainty computations as represented in FIG. 18B in addition to the trajectory predictions, such that a more intelligent path planning process may be performed that considers the uncertainty metrics.

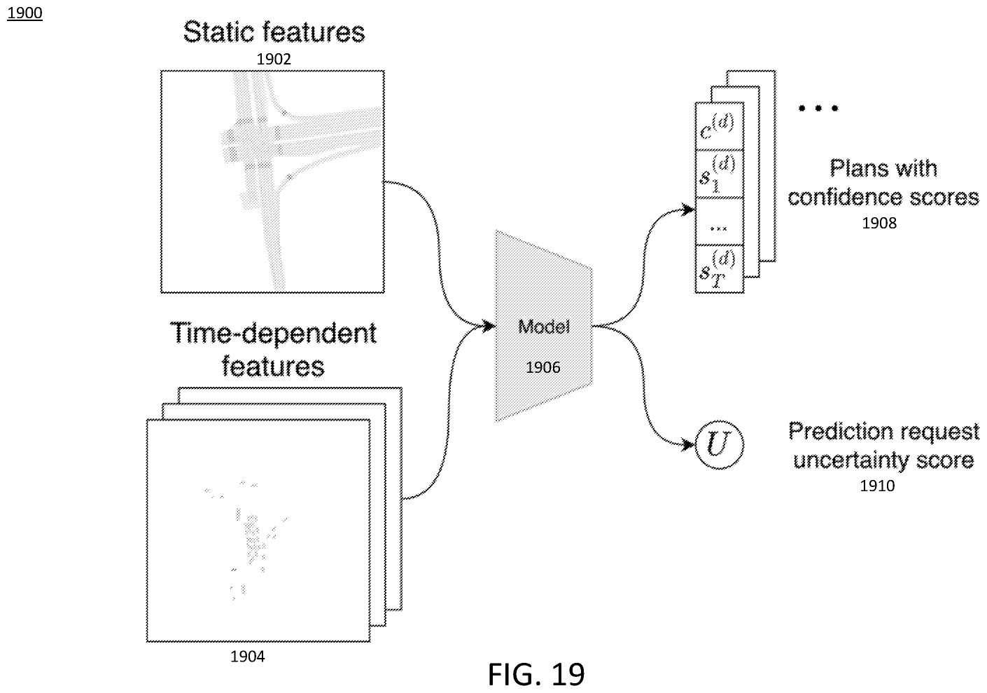

FIG. 19 illustrates an example flow for generating certainty and uncertainty scores, in accordance with one or more aspects of the present disclosure. The flow 1900 as shown in FIG. 19 illustrates a set of static features 1902 and a set of time-dependent features 1904, each being provided as inputs to a trained model 1906. As noted in Section I above, the aspects herein function to derive local driving behaviors from naturalistic data, which are then incorporated as guidance into the behavioral layer of an Automated Vehicle (AV) or other suitable computing system (e.g. the safety system 1400) for adaptation to local traffic. Thus, the machine learning trained model 1906 may represent a model that is trained in accordance with these techniques, and thus the machine learning trained model 1906 may alternatively be referred to herein as a trained behavioral model.

However, it has been recognized that learning methods to produce such trained behavioral models require large amounts of training data. Thus, data from various sources may be incorporated as part of this process, which may include publicly-available data, an aggregation of data collected/reported via other vehicles on the road, data collected via infrastructure such as drones, highway cameras, etc. Alternatively, the trained model 1906 may be any suitable type of trained model that is trained in accordance with a suitable application for which trajectory predictions or other suitable predictions are generated and used in accordance with a specific application.

In any event, these data sets provide labeled boxes of data representing the behavior of various vehicles. These data sets may be imported into any suitable simulation framework (e.g. CARLA) to replay the data sets with respect to any suitable target road agent. This enables the synthetic generation of sensor data input to train any suitable type of model for a particular vehicle. The type of input data used to perform the behavioral model training as discussed herein may be implemented in this way using any suitable combination of the naturalized data and this simulated data.

However, an issue with training behavioral models in this way is that there is a set of observed inputs that indicate the position of a road agent at a particular frame in time. The task then becomes predicting where the target road agent is going to move over a predetermined time period, e.g. a set of future frames. This may be accomplished in accordance with the aspects described herein via the use of context information (e.g. a map) that is rasterized as part of the input images to the training system, which may have any suitable architecture and/or implementation (e.g. a CNN, a DL system, a neural network, an LSTM, etc.). The map images thus provide information regarding which areas are navigable or non-navigable, and this information may be leveraged to derive behaviors, i.e. vehicles drive within lanes identified in the map.

Thus, the trained behavioral model 1906 may be trained by providing, as inputs, the position of a target road agent that predictions are to be made over the past N image frames, as well as separate inputs of road agents surrounding the target road agent. The trained behavioral model 1906 may then provide predictions that indicate, for a target road agent, the points in space and time that yield a predicted trajectory (e.g. a sequence of maneuvers) of that target road agent. The following pseudocode snippet provides an example coded implementation identified with the behavioral model 1906.

```
‘road_graph’ : [
  ‘crosswalk_occupancy’,
  ‘crosswalk_availability’,
  ‘lane_availability’,
  ‘lane_direction’,
  ‘lane_occupancy’,
  ‘lane_priority’,
  ‘lane_speed_limit’,
  ‘road_polygons’,
# each value is rendered at its own channel
# occupancy - 1 channel
# velocity - 2 channels (x,y)
# acceleration - 2 channels (x,y)
#yaw - 1 channel
{‘vehicles’ : [‘occupancy’, ‘velocity’, ‘acceleration’, ‘yaw’]},
# only occupancy and velocity are available for pedestrians
{‘pedestrians’ : [‘occupancy’, ‘velocity’]}, . . .
```

The training process may be performed in accordance with any suitable network architecture, such as those described herein. Some examples, which are also discussed further below, include recurrent neural networks (RNNs), stochastic models, Long-term Short-term Memory neural networks (LSTM), and transformer-based models. LSTMs may be particularly useful given that the maneuvers are sequential in nature. However, LSTMs are typically not generalizable. Thus, CNNs may be implemented as one example to perform behavioral model training in a more generalizable manner. For example, a baseline model may be used such as ResNet50 for instance, which is a CNN that is 50 layers deep. The ResNet50 architecture enables loading of a pretrained version of the network trained on more than a million images from an ImageNet database. The pretrained network can classify images into 1000 object categories. The ResNet50 architecture may be implemented using the image inputs as discussed above, i.e. the map images (static features) and other images that identify the position and movement of the target object and surrounding agents (time-dependent features). The ResNet50 model trained in this way may perform predictions regarding a road agent (e.g. a vehicle) driving straight ahead, lane changing to the left or right, etc.

However, the conventional use of such pre-trained models only provides a single output regarding the predicted trajectories, and does not provide probabilistic results. That is, predictions may be incorrect when there is a lack of adequate training data to accurately perform specific predictions. Thus, the aspects described herein are directed to providing a trained behavioral model 1906 that provides a range of possible predictions, from which the data may be sampled to select a desired prediction that forms the basis of an AV task such as trajectory prediction and an accompanying navigational response. In other words, the aspects described in this Section represent a shift from the use of traditional neural networks to Bayesian neural networks, in which each of the learned parameters represent distributions versus specific values.

That is, traditional neural networks have an architecture that implements a number of layers, each having an associated scalar weighting (e.g. 0.1). A Bayesian neural network, however, uses a range of weightings instead of these scalar weightings and thus is identified with a probability density function (PDF). Thus, a Bayesian neural network may advantageously provide an indication by way of the use of such PDFs that indicates a confidence of the predictions being performed based upon a representation of data used to perform the prediction in the training data. In other words, the aspects as described herein enable the use of a Bayesian neural networks (and other neural network architectures) to allow for trajectory predictions to be made that are correlated with confidence scores (one implementation of the certainty scores, as further discussed below), as well as the computation of a prediction request uncertainty score. In accordance with these aspects, the output of the model also represents a range of distributions, from which a selective sampling may be made. This advantageously enables a generalization of a model that has been trained on a generic set of behaviors, which is then applied to a specific and new set of parameters that are implemented to perform predictions. Thus, in some aspects, the certainty scores as discussed herein may be identified with confidence scores, and in such a case the term confidence scores may be used synonymously with the certainty scores. However, this is by way of example, as the certainty scores may, in some instances, be alternatively represented as other suitable metrics, with additional examples discussed in further detail below.

For example, a behavioral model that is trained in one region may include training data that represents road features of that region, which may be absent in other regions due to differences in road infrastructure, for instance. The aspects described in this Section address this issue by adding safety constraints as a functional layer to the trained behavioral model. Thus, the trained behavioral model provides predictions that are bounded by these safety constraints. For example, the safety constraints may represent the specific parameters and techniques with respect to safety considerations or safety restrictions as defined by the SDM as noted above, or alternatively or additionally include any other suitable types of safety constraints. As an illustrative example, the safety constraints may specify that a vehicle should not change lanes when too close to another vehicle. In this way, the safety constraints function to override an action that would otherwise be taken by the vehicle in response to a predicted trajectory such that, even if the output of the behavioral model is an incorrect prediction, the safety constraints still function to prevent the vehicle from executing a maneuver that would follow a predicted trajectory that would violate the safety constraints.

Moreover, the aspects described in this Section enable the sampling of the range of predictions provided by a behavioral model for specific purposes. This might include, for example, ensuring safety or acquiring data for “corner” cases that are directed to more extreme scenarios that are less likely to occur within a training dataset. For example, at inference, the trained model may be utilized (e.g. via the safety system 1400) to identify sets of predicted trajectories, confidence scores, and uncertainty scores. Additional details regarding these metrics are further discussed below. However, it is noted that any suitable combination of these metrics may be implemented to enable the relevant computing system at inference to flag or otherwise identify data that resulted in one or more such metrics being below a threshold value. In this way, the acquired images, sensor data, etc., identified with the input data may be stored and/or identified for use in further training data sets. Doing so improves upon the training of future models by providing a more comprehensive training data set that encompasses more rare instances that may be used for future predictions.

In an aspect, the trained behavioral model 1906 may be trained in accordance with a Bayesian neural network as described above. However, this is by way of example and not limitation, and the aspects as described herein may utilize any suitable architecture that allows for the derivation of the certainty scores and the uncertainty scores as discussed herein. Referring back to FIG. 19, the trained behavioral model 1906 may be trained by using images identified with both static features (e.g. map image data) and time-dependent features (e.g. the position and movement) of road agents within the road corresponding to the static features. This training process may utilize sets of static and time-dependent features that are part of a training dataset to output sets of predicted trajectories and, from a verification of these predictions to ground truth data, allows the trained behavioral model 1906 to build a probability density function (PDF) “inside” the model. That is, in contrast with conventional model training that use scalar weights, the use of a Bayesian neural network allows for the model to learn sets of scalar value ranges as part of the training process, which in the aggregate constitute the PDF of the trained behavioral model 1906.

Then, at inference, the trained behavioral model 1906 may receive the static features 1902 and the time-dependent features 1904 via a suitable computing system. For example, if deployed as part of the safety system 1400 of the vehicle 1300, the static features 1902 may be derived from the AV map data or other suitable map data that is accessed via the safety system 1400. The time-dependent features 1904 may be derived, for instance, via any suitable combination of sensors used by the vehicle 1300 to detect and classify objects, to track the motion of such objects, etc. Thus, the time-dependent features 1904 may be the result of the safety system 1400 receiving and processing data from the image acquisition devices 1304, the position sensors 1306, the speed sensors 1308, the one or more RADAR sensors 1310, the one or more LIDAR sensors 1312, etc. The trained behavioral model 1906 may have any suitable number of inputs. For example, the trained behavioral model 1906 may have 9 channels for time-dependent features, 8 channels for static features, and thus 17 channels in total. The trained behavioral model 1906 is thus trained to output a range of trajectories and corresponding certainty scores, as well as uncertainty scores, as discussed in further detail below.

As shown in FIG. 19, the trained behavioral model 1906 is configured to output a range of any suitable number of trajectories s₁^{(d)} . . . s_{T}^{(d)} 1908. Each one of the trajectories s₁^{(d)} . . . s_{T}^{(d)} may comprise any suitable number of points (e.g. x, y coordinates) in space that are identified with a particular object for which a trajectory is to be predicted over a specific time horizon (e.g. five seconds, ten seconds, etc.). Thus, each one of the trajectories s₁^{(d)} . . . s_{T} describes the movement of any suitable number of coordinates identified with a target road agent over a time horizon, which is based upon the particular configuration of the trained behavioral model 1906.

Thus, each one of the trajectories s₁^{(d)} . . . s_{T}^{(d)} may comprise similar data points with respect to one another at the start of each time horizon, but deviate from one another at the end of each time horizon due to an accumulation of different predictions that are made over time by the trained behavioral model 1906 with respect to each trajectory. For example, each one of the trajectories s₁^{(d)} . . . s_{T}^{(d)} may comprise a set of x,y concatenated positions, with the length of the set of positions representing the time horizon. For example, s₁^{(d)} may contain the set of concatenated positions of x,y coordinates [(0,0),(0,0.1),(0.1,0.2),(0.1,0.3)], which represent movement in both the x, y directions in the following 4 timesteps within the overall time horizon in terms of relative location. Using a timestep equal to one second as an example, then that predicted trajectory would be for a time horizon for the next 4 seconds. To provide additional illustrative examples, the trajectory s₁^{(d)} may correspond to a target road agent moving straight ahead for the next ten seconds, the trajectory s₂^{(d)} may correspond to the target road agent moving into the right lane within the next ten seconds, the trajectory s₃^{(d)} may correspond to the target road agent moving into the left lane within the next ten seconds, etc.

Therefore, the range of trajectories s₁^{(d)} . . . s₃^{(d)} may represent all of the possible variations (or a smaller subset thereof) that a target road agent may follow from a reference time (e.g. the present time or a previous time) to a future point in time in accordance with the time horizon, which consider the static features 1902 that may guide these determinations based upon the limitations of the road, the current lane a target road agent is in, etc. In other words, when the target road agent is a vehicle, then each trajectory that is predicted via the trained behavioral model 1906 comprises a set of coordinates for the vehicle to follow corresponding to a respective vehicle maneuver.

In various embodiments, the trained behavioral model 1906 may be configured to output at inference a range of predicted trajectories for any suitable number of target road agents. Thus, in accordance with such embodiments, each column as shown in FIG. 19 may be identified with a range of trajectories for a different road agent. For example, the trained behavioral model 1906 may provide a range of trajectory predictions for the ego vehicle as well as any suitable number of surrounding road agents in a driving environment. However, in other embodiments, the trained behavioral model 1906 may be trained to provide multiple ranges of trajectory predictions for the same target road agent. Thus, the trained behavioral model 1906 may be trained to output a number of trajectory ranges based upon any suitable metrics, such as the confidence score c^{(d)} (also referred to herein as a confidence-aware metric) for example as shown in FIG. 19 and further discussed below. As an illustrative example, the trained behavioral model 1906 may output a number of trajectory ranges identified with the N best three, five, etc., of trajectory ranges having the highest prediction confidence-aware metric c^{(d . . . N)}.

As shown in FIG. 19, each trajectory as shown also includes one or more prediction confidence-aware metrics c^{(d)}, which again are also referred to herein as “scores” or “certainty scores.” To this end, it is noted that although FIG. 19 illustrates a single prediction confidence-aware metric c^{(d)} for a range of trajectories, the trained behavioral model 1906 may compute and/or output a per-trajectory prediction confidence-aware metric, i.e. a prediction confidence aware metric corresponding to each one of the trajectories s₁^{(d)} . . . s_{T}^{(d)}.

Thus, the prediction confidence aware metric c^{(d)} as shown in FIG. 19 may represent an aggregation of the prediction confidence-aware metrics c^{(d)} for the entire range of trajectories or, alternatively, each trajectory within the range of trajectories may be identified with its own respective prediction confidence-aware metric c. For example, when c represents a confidence score for each prediction, it may be computed by applying either softmax or computing the negative log-likelihood of the predicted trajectory. As another example, when c represents an aggregation of the prediction confidence scores for several trajectory predictions, then an averaging may be performed across each of the per-plan log-likelihoods. Any suitable metric for measuring accuracy of the prediction during training may be utilized for this purpose. As an example, the metric may comprise a weighted ADE (average displacement error). That is the accumulated error, in this case in pixels, between the ground truth of where the vehicle went at every timestep versus what the model predicted. As another example, a mean square error may be implemented.

In any event, the range of trajectories as shown in FIG. 19 represent a weighted set of predicted trajectories in that each trajectory is weighted in accordance with its respective confidence-aware metric that indicates a certainty with respect to that particular trajectory to be followed at a specific point in time. That is, in some embodiments, the prediction confidence-aware metric c indicates, for each predicted trajectory, a likelihood of the trajectory being output by the trained behavioral model 1906 based upon an originally-trained dataset. For example, trajectories that were more often represented in the training data set, e.g. moving straight ahead, may have higher confidence scores compared with predicted trajectories that are learned from a less frequent representation in the training data set, e.g. turning left or right. Thus, lower confidence scores may indicate trajectories that are predicted by the trained behavioral model 1906 with a less represented set of training data. In other words, each confidence score represents a likelihood of each respective trajectory being selected based upon the training data for which the behavioral model was trained.

The trained behavioral model 1906 also outputs a prediction request confidence-aware metric 1910 (U), which is alternatively referred to herein as an uncertainty score U. The uncertainty score U represents the overall uncertainty based upon the particular features that are input into the trained behavioral model 1906 at a particular instant in time (e.g. the static and time-dependent features 1902, 1904 derived from the input data), as well as an average of the internal PDF that is calculated for all elements of the Bayesian (or other suitable network) implemented by the trained behavioral model 1906. In other words, the uncertainty score U may represent an aggregation of the probabilities for the trained behavioral model 1906 based upon the excitation of the neurons of the neural network for a given input. For example, the uncertainty score U may be computed by aggregating the “D” top per-trajectory confidence scores (as noted above using e.g. the negative log-likelihood) to a single uncertainty score, which represents model's uncertainty in making any prediction for a target agent. D may be defined as a hyperparameter that may be set and/or adjusted, and depends on the available computational resources. Typical D values may comprise a range between 3 and 11, for instance.

Thus, the uncertainty score U may identify, based upon the particular set of input features (e.g. the static features 1902 and the time-dependent features 1904), how “novel” these features are. That is, if these features been used for previous computations of trajectory predictions, then a low uncertainty score U is computed, and if such features have not commonly been encountered in the computation of previous trajectory predictions, the uncertainty score U is a high uncertainty score. This computation may be, for example, based upon the PDF of the trained behavioral model 1906, which may be identified upon completion of training and thus accessed as the additional trajectories are computed with newly received input data at inference. The uncertainty score U may thus have any suitable scaling system to represent the uncertainty of the output of the trained behavioral model 1906 at any time based upon the current inputs to the trained behavioral model 1906.

Because the computation of the uncertainty score U may consume processing resources and create computational overhead, embodiments include the relevant computing system in which the trained behavioral model 1906 is deployed requesting the uncertainty score U be computed in response to one or more suitable conditions being met. For instance, the uncertainty score U may be computed each time a range of trajectories is output for a particular object, although this may be unnecessary when the input data has not changed significantly between computations. Thus, as another example, the safety system 1400, the one or more processors 1302, etc., may be configured to determine whether such conditions have been met, and request for the uncertainty score U to be computed when this is the case. Thus, the embodiments described herein recognize that the uncertainty score U may not change significantly when the input features (e.g. the static features 1902 and the time-dependent features 1904) have not changed significantly, and leverage conditions that ensure a sufficient change to these input features have occurred. To provide an illustrative example, the conditions may comprise a threshold time period elapsing, which may include the trained behavioral model 1906 periodically computing the uncertainty score U after the expiration of a predetermined (e.g. threshold) time period such as every three seconds, every five seconds, every ten seconds, etc. This threshold time period may also be adjustable, and such adjustments may be in response to other suitable conditions being met. For instance, the location of the vehicle moving into an urban environment (which may be identified via map data) may trigger a more frequent computation of the uncertainty score U, recognizing that such environments may be correlated with more frequent changes to the input data.

The computation of the uncertainty score U may provide various advantages with respect to the deployment and usage of the trained behavioral model 1906, as well as to determine valuable input data that may be used for future training to provide improvements to subsequently trained models. For example, a threshold may be identified in accordance with the certainty scores and/or the uncertainty scores to influence the manner in which the planner of the vehicle in which the trained behavioral model 1906 is deployed may make planning decisions. Such a planner, as discussed above, may be implemented via the safety system 1400, which may use an output trajectory having the highest confidence score to determine a responsive vehicle-based function. For instance, when the trajectory is of the same vehicle, the planner may compute the steering, acceleration, braking, etc., to enable the vehicle 1300 to match the position and timing of the predicted trajectory at a point in time matching that of the time horizon of the predicted trajectory. As another example, when the predicted trajectory is of a different vehicle (or other object), then the planner may compute the steering, acceleration, braking, etc., to enable the vehicle 1300 to follow a trajectory that reacts to the predicted trajectory of the other road agent, e.g. by avoiding a collision, slowing the vehicle, maintain minimum latitudinal and longitudinal safe distances, etc.

In any event, the uncertainty score U may be used in conjunction with the confidence scores c such that, even for a high confidence score c for a particular trajectory, the planner may perform an alternate vehicle-based function. In other words, a first vehicle-based function may be executed when the uncertainty score U is higher than a predetermined threshold value, and a second, different vehicle-based function may be executed when the uncertainty score U is less than the predetermined threshold value. That is, in the event that the uncertainty score U indicates that the predicted trajectory is based upon novel input data not well represented in the training dataset (despite the confidence score c being high), then the planner may elect to execute a different vehicle-based function or to modify the vehicle-based function. As illustrative examples, an uncertainty score U exceeding a threshold value may trigger manual control being handed off to the driver of the vehicle 1300, or the vehicle 1300 following a more “conservative” path such as by increasing following distance thresholds between other vehicles to execute the path.

Furthermore, the uncertainty score U may be tracked over time as it is computed, and instances in which the uncertainty score U exceeds a threshold value may be logged or otherwise identified. This may include a timestamp or other suitable identification such that the input data that was provided to the trained behavioral model 1906 that caused the uncertainty score to exceed the predetermined threshold may likewise be later identified. Thus, the input data that was novel enough to trigger the uncertainty score U to exceed the predetermined threshold may be stored, tagged, or otherwise saved for later use as part of a future training dataset to refine the development of future models.

In this way, in accordance with the embodiments of the disclosure, the trained behavioral model 1906 may advantageously be used as a single model to provide a wide variety of data for various use cases. For instance, the output of the range of trajectories, confidence scores, and uncertainty score enables the implementation of a controller that may receive the outputs of the model as shown in FIG. 19 in accordance with a particular application for which the predictions are to be used. Thus, the controller may guide the use of road geometry, the distance between the different precited trajectories, and the uncertainty score U to ensure that a distribution of trajectories is selected based upon the parameters of a particular application.

Thus, the sampling of the outputs of the trained behavioral model 1906 may provide a particular type of driving behavior based upon the selection of the predicted trajectories, which may represent a sampled data set that is guided by the uncertainty score U. The data set that is sampled in this manner may be used to perform one or more trajectory prediction tasks. For example, the selected subset of the predicted trajectories may be used to train another behavioral model using a specific subset of driving conditions, or to select other conditions that match the desired properties (e.g. sensor types) of a vehicle in which the trained behavioral model 1906 is then deployed. As another example, the data set that is sampled in this manner may be implemented to test a trained model regarding performance for verify a trained model under extreme, underrepresented conditions. Another example is to identify variations in predicted trajectories by a trained model based upon an underrepresented training data set.

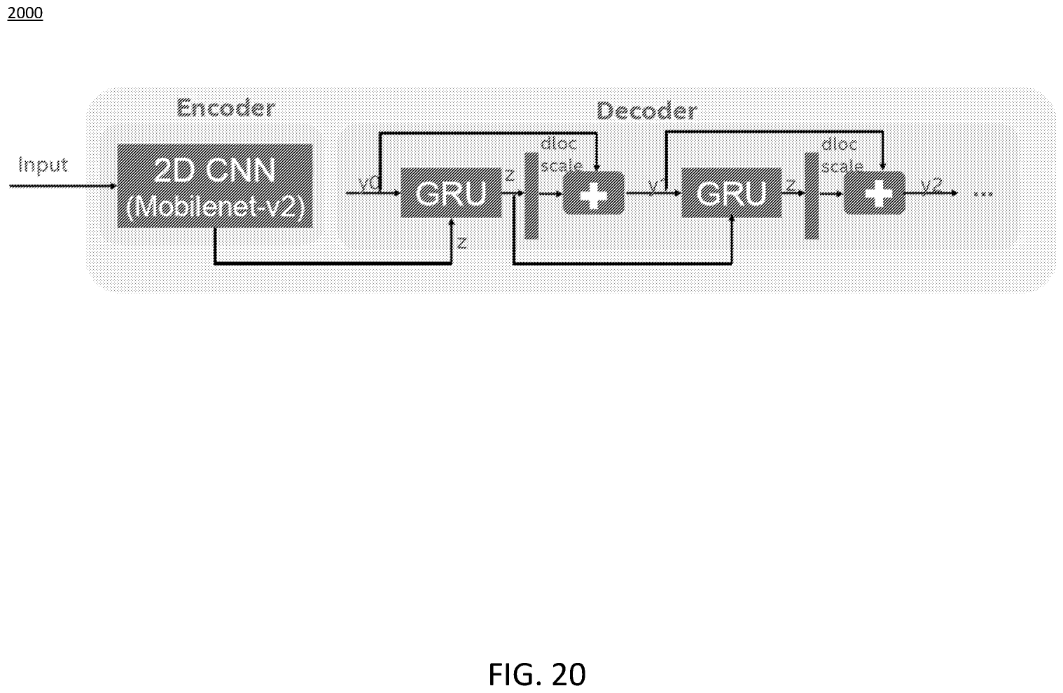

FIG. 20 represents a behavioral cloning model, in accordance with one or more aspects of the present disclosure. The behavioral cloning model as shown in FIG. 20 may represent, for instance, a stochastic model. The behavioral cloning model as shown in FIG. 20 provides an example of a model that may be used to train the trained behavioral model 1906 as shown and discussed herein with reference to FIG. 19. Thus, the trained behavioral model 1906 as discussed herein may be implemented as a Bayesian neural network (BNN) or, alternatively, as a non-BNN. However, it may be particularly advantageous to implement BNNs, as such architectures allow for a use of the uncertainty score U based upon the PDFs, which are already generated with BNN architectures.

Thus, the behavioral cloning model as shown in FIG. 20 may comprise an encoder and a decoder, which may facilitate the adaptation of input data for use with a BNN architecture. The encoder transforms the input data (e.g. the images having the static features and time-dependent features) into latent space that is smaller in nature. For example, the encoder may receive as inputs one or more data arrays, each representing a respective input image to be used by the model (e.g. one of the images to a channelized input as discussed herein), having a size of M×N pixels. The encoder thus transforms each data array into a smaller vector that maintains a significant amount of features, which is denoted as ‘z’ in FIG. 20. Thus, the encoder may be a separate neural network (e.g. a CNN) that is trained for this purpose. The encoder may repeat this process for any suitable number of input images, and provide the latent data vectors z into respective layers of the decoder, with one of these layers being shown in FIG. 20.

As shown in FIG. 20, the behavioral cloning model 2000 utilizes any suitable number of gate recurring unit cells (GRUs), although this is by way of example and not limitation. As further discussed herein, the behavioral cloning model 2000 may be implemented using alternative architectures, such as transformer architectures for instance. For example, the GRU cells may be implemented as recurrent neural network (RNN) cells, or as LSTM cells. It is noted that the RNN has drawbacks with respect to the vanishing gradient problem (short-term memory). Thus, gates may be introduced in the gated recurrent unit (GRU) and LSTM approaches. A GRU cell architecture may implement a reset gate (to decide whether the previous cell state is important or not), and an update gate (i.e. the cell state to be updated with candidate state or not). An LTSM cell architecture may implement an update (input) gate, a forget gate (controls what is kept vs forgotten, from previous cell state), and an output gate (controls which parts of the cell are output to the hidden state).

In any event, the decoder has multiple cells, which are illustrated in FIG. 20 as GRU cells as a non-limiting example, and each cell is configured to execute a specific predetermined function such as a sigmoid function, a hyperbolic tangent (tanh) function, a mathematical operation such as a product operation, a concatenation operation, etc. Thus, each cell receives the latent data z, which again represents a distilled version of the input data used to train the model. Each cell also receives a set of predictions that have been computed in accordance with the model application. For instance, the data y0 may represent an initial predicted trajectory. As shown in FIG. 20, the initial predicted trajectory y0 is then provided to the next GRU cell in the sequence via the dloc scale block, which is added to the output of the previous GRU cell. In this way, the decoder provides each GRU cell with information regarding the previous predictions, allowing the decoder to “remember” previous trajectory predictions. This architecture enables an output that comprises a range of predicted trajectories over a particular time horizon.

The aspects described herein may implement an ensemble-based approach, where members are generated changing the torch seed value. The goal of this is to learn distributions capturing uncertainty during training to better estimate epistemic uncertainty during inference through sampling. The distributions may be predicted either by teacher-forcing or sampling-based approaches. The output at each time step includes Dloc and Scale: (x, y) coordinates and standard deviation of multivariate normal (MVN) distribution. In the example shown, the length of yn (prediction) is 25 considering the next 5 seconds within a sampling rate of 5 Hz.

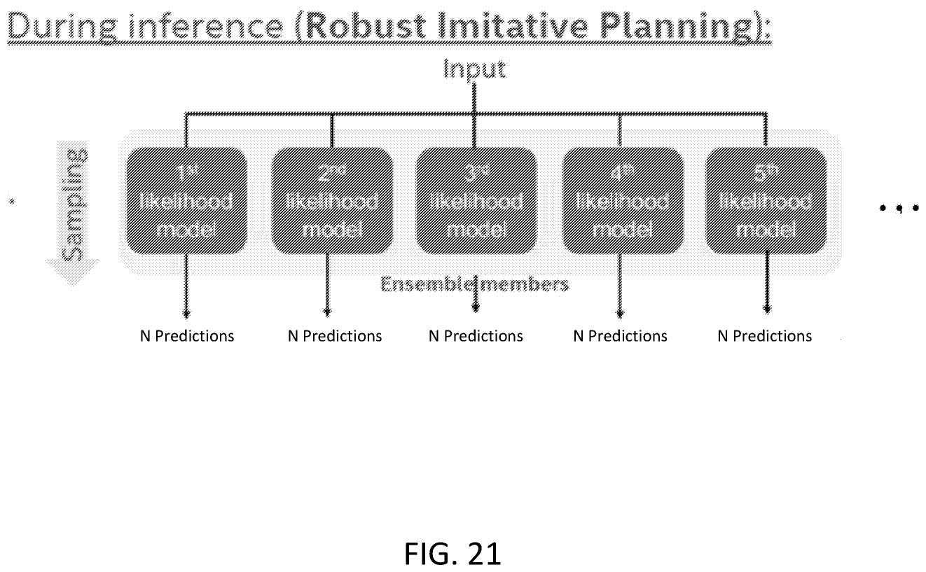

FIG. 21 illustrates the implementation of multiple likelihood models to compute the confidence scores and the uncertainty score U as trajectories are predicted. It is noted that in an aspect, the behavioral model 1906 may be trained by computing trajectory predictions as part of any suitable sampling process. A density estimator (e.g. a likelihood model) may be generated to facilitate this process, which may utilize teacher-forcing or sampling, for example. An optimization process may then be performed, for example, based on negative log likelihood (NLL) objective. All corresponding NLL, average displacement error (ADE), and frequency-domain equalization (FDE) metrics may then be logged as part of the training process.

The ensemble members as shown in FIG. 21 are identified with the trajectory predictions and accompanying computations as discussed herein. The ensemble process may comprise any suitable number of likelihood models, with five being illustrated in FIG. 21 for ease of explanation. The ensemble process as shown in FIG. 21 may be performed by the behavioral model 1906 at inference to compute the confidence scores and the uncertainty score U based upon an aggregation of per-trajectory confidence scores (i.e. a selection of confidence scores for each trajectory prediction). This ensemble process may also be implemented to compute the uncertainty score U. The details of these computational processes are further discussed below.

The use of an ensemble process ensures robustness of the results provided by the behavioral model 1906, and comprises the use of any suitable number M of likelihood models versus a single likelihood model to perform trajectory predictions. This may be implemented, for instance, by tuning the various parameters of the behavioral model 1906 such that each likelihood model outputs a different trajectory prediction for the same input data (e.g. the same static and time-dependent features as noted herein). The parameters that are tuned may comprise, for example, weightings or other suitable adjustments to the operations that are executed via the unit cells of the behavioral model 1906, as noted above.

Thus, the use of an ensemble process enables the generation of N different trajectory predictions for the same input, with the number of predictions N being output by each likelihood model providing a total of M×N predictions for the entire ensemble. Each of these M×N trajectory predictions may be identified with a separate confidence score as noted herein, and model averaging may be used among the different likelihood models to provide N confidence scores for each prediction. In an aspect, a subset of the M×N predictions may be selected having the highest corresponding confidence scores, which may be a predetermined number. For example, the predicted trajectories identified with the highest 5, 10, 20, etc. confidence scores from among the M×N trajectories may be selected to be output by the behavioral model 1906, which may be identified with those as shown and discussed above with reference to FIG. 19. Thus, the confidence score as shown and discussed with respect to FIG. 19 may represent an aggregation or average of the confidence scores for the range of predicted trajectories. Moreover, a “final” uncertainty score U may be computed by aggregating the confidence scores of the output trajectory predictions, i.e. with respect to the predetermined number of trajectory predictions identified with the highest confidence scores.

To provide an illustrative example, the final aggregation to provide the final uncertainty score U may be computed using a mean averaging technique, i.e. a mean averaging of the uncertainty scores for the predicted trajectories identified with the highest (e.g. “D” or other suitable hyperparameter) 5, 10, 20, etc. confidence scores from among the M×N trajectories. As another example, samples may be divided into any suitable number of classifications during training, which are based on a certainty/uncertainty and low/high accuracy tradeoff. Using four classifications as an example, this may achieve classifications of a Low Certainty (LC), a Low Uncertainty (LU), a High Certainty (HC), and a High Uncertainty (HU). In this scenario, the uncertainty score U may be computed in accordance with Equation 2 below as follows:

$$U = \frac{{n}_{L C} + {n}_{UH}}{{n}_{L C} + {n}_{L U} + {n}_{H C} + {n}_{H U}} , \qquad Eqn . 2$$

Where n represents an average of sampling in each of the classification buckets using the following form as shown in Equations 3-6 below:

$${n}_{L U} := {\sum }_{i} 1 ( {ade}_{i} \leq {ade}_{t h} and {c}_{i} \leq {c}_{th} ) ; \qquad Eqn . 3$$

$${n}_{H C} := {\sum }_{i} 1 ( {ade}_{i} > {ade}_{t h} and {c}_{i} > {c}_{t h} ) ; \qquad Eqn . 4$$

$${n}_{L C} := {\sum }_{i} 1 ( {ade}_{i} \leq {ade}_{t h} and {c}_{i} > {c}_{th} ) ; and \qquad Eqn . 5$$

$${n}_{H U} := {\sum }_{i} 1 ( {ade}_{i} > {ade}_{th} and {c}_{i} \leq {c}_{t h} ) \qquad Eqn . 6$$

In accordance with such embodiments, adeₜₕ represents a threshold ADE metric and cₜₕ represents a threshold certainty score (e.g. confidence score), each being hyperparameters that may be established during the training process. Thus, the threshold ADE and the threshold certainty score may be set during the training process in response to an identification of respective threshold values that result in behavior prediction that meets predefined criteria, e.g. such that the behavior prediction is considered accurate, and which depends on the complexity of the task of the prediction.

Although the example shown in FIG. 19 indicates a single aggregated confidence score being output by the behavioral model 1906, this is by way of example as the behavioral model 1906 may be configured to determine individual per-trajectory confidence scores as well, which again may be used by the planner to select a specific predicted trajectory as noted above. Furthermore, the planner of the computing device in which the behavioral model 1906 is deployed (e.g. the safety system 1400) may communicate with the computing device executing the behavioral model 1906 to dynamically adjust the manner in which the predicted trajectories are output. For instance, it may be desirable in some scenarios for the planner to only implement a vehicle-based function in accordance with the predicted trajectory having the highest confidence score. In such a case, the aggregation implemented in accordance with the ensemble process may generate a single predicted trajectory associated with the highest confidence score instead of a range of predicted trajectories as shown in FIG. 19.

Again, the certainty scores have been discussed herein with reference to the confidence scores, although this is by way of example and not limitation. Thus, it is noted that in alternate embodiments the certainty scores may be alternatively computed based upon a Mahalanobis distance identified with the range of trajectory predictions. Moreover, any of the techniques discussed above with respect to the aggregation and use of the confidence scores as the certainty scores, as well as the computation of the uncertainty score U, may be utilized when the certainty scores are alternatively implemented as the Mahalanobis distance. For example, the Mahalanobis distance is generally defined as a measure of the distance between a point P and a distribution D. Thus, for each predicted trajectory, a Mahalanobis distance may be computed by comparing the variations in the points representing the center of mass of each respectively predicted trajectory along its own time horizon. For example, if five trajectories are predicted over a time horizon of ten seconds, then the Mahalanobis distance may be computed by comparing, for each one of several time points within a respective predicted trajectory, the points identified with the center of mass of the distribution of points for the target object. In this way, the certainty scores c may alternatively be computed as or based upon a Mahalanobis distance instead of a likelihood score as discussed above (i.e. when identified with the confidence scores). The use of the Mahalanobis distance as the certainty scores may be particularly useful in detecting outlier trajectory predictions, i.e. out-of-distribution data.

Furthermore, the Mahalanobis distance that is computed among the different M×N predicted trajectories may additionally or alternatively be used to guide the aggregation process, i.e. the selection of the subset of the M×N predicted trajectories to be output by the behavioral model 1906. That is, the Mahalanobis distance identified with one or more of the set of M×N trajectory predictions may be used to identify the trajectory predictions that are output by the behavioral model 1906. For example, if the Mahalanobis distance is less than a predetermined threshold between two compared predicted trajectories, this indicates that the two predicted trajectories are similar to one another. In such a case, the predicted trajectories may be aggregated into a single predicted trajectory by averaging the points between the predicted trajectories, by randomly discarding other predicted trajectories, etc. In this way, the ensemble and aggregation process may ensure that the predicted trajectories output by the behavioral model 1906 are sufficiently “different” than one another, which implies different behaviors. This provides variability such that intelligent planning decisions may be made, as opposed to the planner only having the choice of selecting among marginally different planned trajectories.

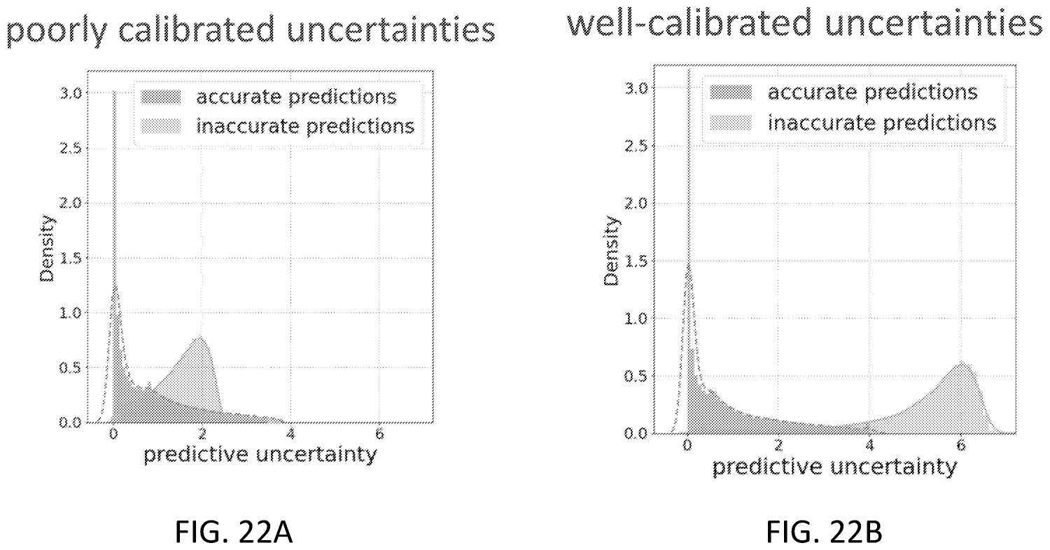

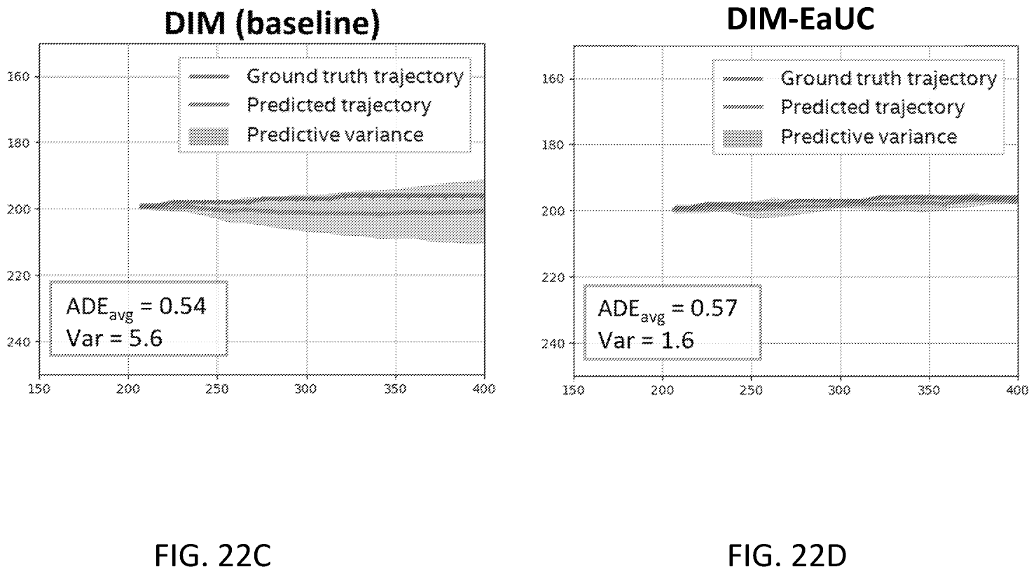

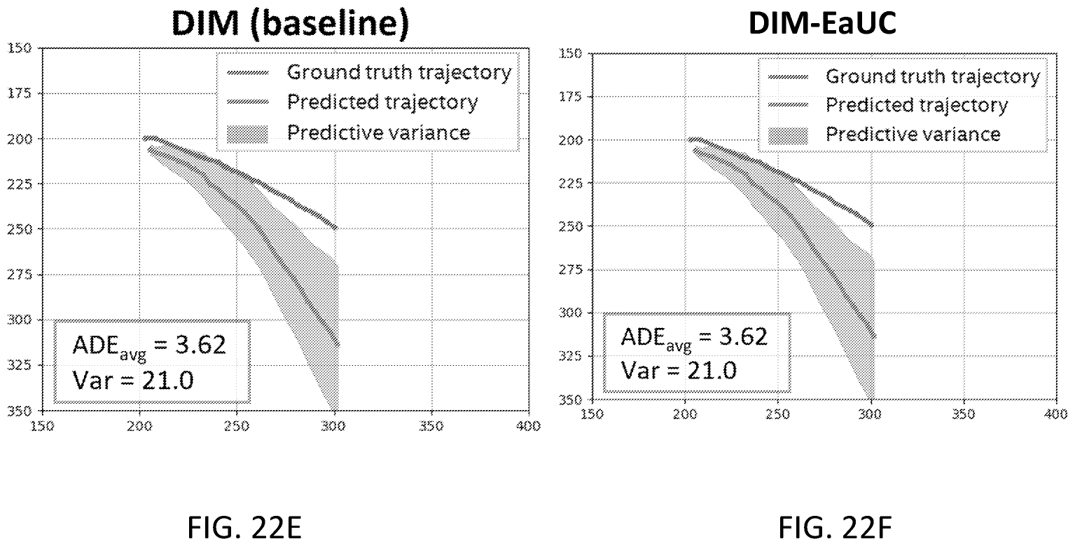

FIGS. 22A-22B illustrate the improved performance of a behavioral model, in accordance with one or more aspects of the present disclosure. FIG. 22A illustrates a plot of a density of predicted trajectories in accordance with a conventionally-trained model that does not utilize the uncertainty score U as discussed herein. Thus, the results of the output of such a model indicates that there is a high uncertainty with respect to a differentiation among the accurate and inaccurate predictions provided by the model.

Thus, each of the plots as shown in FIGS. 22A and 22B illustrate the density of trajectory predictions with respect to accurate/inaccurate predictions. The plot in FIG. 22A corresponds to an uncalibrated model in which there is a strong overlap between accurate predictions and inaccurate predictions. This means that there is no guarantee that the model “knows” if the predictions are actually reliable. The plot in FIG. 22B, on the other hand, corresponds to the density of trajectory predictions for a well-calibrated model, i.e. one that utilizes the uncertainty score U as discussed herein. In contrast with the plot as shown in FIG. 22A, the plot as shown in FIG. 22B illustrates a clear differentiation between accurate and inaccurate trajectory predictions, which means that the model will provide accurate predictions with high certainty and inaccurate prediction with low certainty.

In other words, the uncertainty score U may be used to provide feedback and calibration to the model in terms of adjusting the model's average displacement error (ADE) and accuracy versus uncertainty calibration (AvUC) loss functions. In other words, the use of the uncertainty score U in accordance with the aspects described herein enable for a differentiation to be made among the accurate and inaccurate predictions. Such analytical tools allow for improved feedback regarding the analysis of the trained model, as it allows for input data to be identified as yielding an in-band or out-of-band distribution of predicted trajectories. The area under the retention curves also enables an assessment of the joint quality of uncertainty estimates and robustness. As shown in FIG. 22B, the use of the uncertainty score U enables a better distribution of predicted trajectories in terms of their predictive uncertainty.

FIG. 22C-22F further illustrate the advantages of using the uncertainty score U as discussed herein. FIGS. 22C-22D illustrate the difference in performance of trained behavioral models providing accurate predictions, whereas FIG. 22E-22F illustrate the difference in performance of trained behavioral models providing inaccurate predictions. The left plot (i.e. FIGS. 22C and 22E each represent the performance of conventional solutions, whereas the right plots (i.e. FIGS. 22D and 22F) illustrate the performance of the trained behavioral models as discussed herein, which utilize the uncertainty score U. The accurate predictions as shown in FIGS. 22C-22D correspond to an average displacement error (ADE) that is less than or equal to a defined threshold ADE metric. The inaccurate predictions as shown in FIGS. 22E-22F, in contrast, correspond to an ADE that is greater than the threshold ADE metric.

It may be observed that the predicted trajectories (in the shaded regions) fall, in both cases, within the distribution (the shaded region). For the accurate predictions of FIGS. 22C-22D the predictions are close to the ground truth. However, for the inaccurate predictions of FIGS. 22E-22F, the predictions are further from the ground truth. This occurs in real-world scenarios when the model is operating in previously unseen conditions. In accordance with the aspects described herein, the use of the uncertainty score U enables an analysis of the model output to determine whether the model is simply “guessing,” or whether the model is more certain of its predictions. In other words, the aspects described herein enable the use of an uncertainty-calibrated prediction model.

Referring back to FIGS. 11 and 12, example computing devices 1100, 1200 are shown in accordance with one or more aspects of the disclosure. Again, the aspects described herein may be performed via any suitable computing device, which may be identified with a component of the safety system 1400 as discussed herein, as a separate computing device that may be implemented within the vehicle 1300, or in any separate suitable environment. The same computing device may be implemented to perform training of the trained behavioral model 1906 as well as the use of the trained behavioral model 1906 at inference. Alternatively, different computing devices may be implemented to perform the training of the behavioral model 1906 (e.g. a production facility computing device, cloud computing system, etc.) versus the use of the trained behavioral model 1906 upon its deployment (e.g. as part of the safety system 1400).

Thus, in an aspect, the computing devices 1100, 1200 as shown and described with respect to FIGS. 11-12 may be identified with a component of the safety system 1400 as discussed herein, or a separate computing device that may be implemented within the vehicle 1300 or in any separate suitable environment. In other aspects, the computing devices 1100, 1200 may be identified with any suitable type of standalone computing device such as a desktop computer, laptop, server computer, tablet computer, mobile device, a networked computer and/or computing system, a cloud computing device and/or architecture, or components thereof such as a GPU, CPU, etc. As further discussed below, the computing devices 1100, 1200 may perform the various functionality as described herein and as shown in the accompanying Figures.

Thus, the training, deployment, and or use (e.g. at inference) of the trained behavioral model 1906 as discussed above may be implemented, for example, via the computing device 1100 and/or the computing device 1200. To provide an illustrative example, the behavioral model generation engine 1206 may comprise executable instructions that, when executed by the processing circuitry 1202, enable training or otherwise generating the behavioral models as discussed herein (e.g. the trained behavioral model 1906). As another illustrative example, the behavioral models module 1107 of the computing device 1100 may comprise executable instructions that, when executed by the processing circuitry 1102, enable the deployment, storage, and/or execution of (e.g. at inference) the behavioral models as discussed herein (e.g. the trained behavioral model 1906). Thus, the processing circuitry 1102, 1202 may be identified, for example, with the one or more processors 1302, one or more of the processors 1414A, 1414B, 1416, 1418, etc. Of course, and as noted above, a single computing device may perform both model training and model execution.

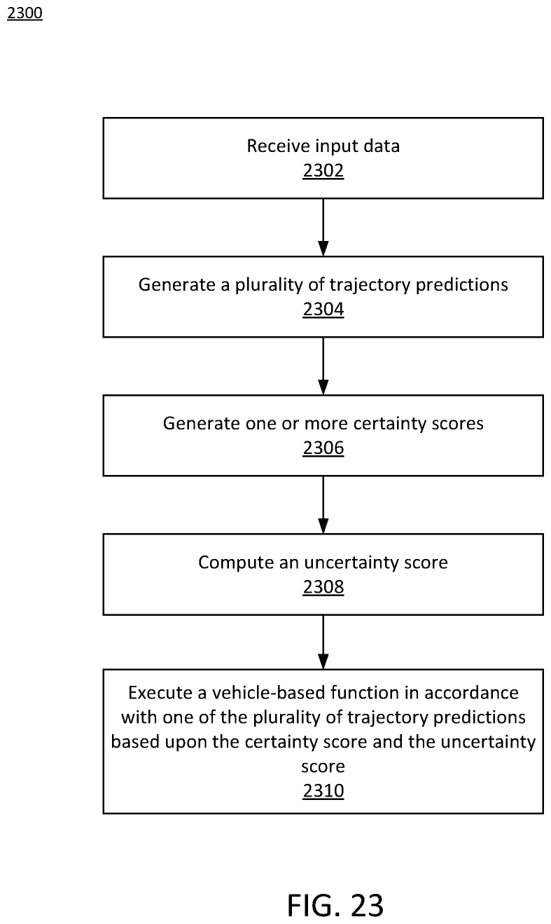

FIG. 23 illustrates an example of a process flow, in accordance with one or more aspects of the disclosure. The process flow 2300 may include alternate or additional steps that are not shown in FIG. 23 for purposes of brevity, and may be performed in a different order than the steps shown in FIG. 23.

With reference to FIG. 23, the process flow 2300 may be a computer-implemented method executed by and/or otherwise associated with one or more processors (processing circuitry) and/or storage devices. The functionality associated with the process flow 2300 as discussed herein may be executed, for instance, via a suitable computing device and/or processing circuitry identified with the computing device 1100, the computing device 1200, the vehicle 1300, and/or the safety system 1400. This may include, for example, the one or more processors 1302, one or more of the processors 1414A, 1414B, 1416, 1418, etc., executing instructions stored in a suitable memory (e.g. the one or more memories 1402). In other aspects, the functionality associated with the process flow 2300 as discussed herein may be executed, for instance, via processing circuitry identified with any suitable type of computing device that may be identified with the vehicle 1300 (e.g. a chip, an aftermarket product, etc.) or otherwise communicates with one or more components of the vehicle 1300.

The process flow 2300 may begin with receiving (block 2302) input data. The input data may comprise, for instance, the static features 1902 and the time-dependent features 1904 as discussed herein with respect to FIG. 19. Thus, the input data may comprise, for example, one or more first images including static features that identify map data, and one or more second images including time-dependent features that identify a position and movement of one or more road agents over time.

The process flow 2300 may include generating (block 2304) a plurality of trajectory predictions in accordance with a trained behavioral model. This may include, for example, generating the trajectory predictions for a target road agent, as discussed above with respect to FIG. 19 and the trained behavioral model 1906. Thus, the generation of the plurality of trajectory predictions may comprise generating, via a trained behavioral model, a plurality of trajectory predictions for a target road agent from among the one or more road agents based upon the input data, with each one of the plurality of trajectory predictions comprising a set of positions identified with a respective trajectory of the target road agent to follow over a period of time.

The process flow 2300 may include generating (block 2306) one or more certainty scores. These certainty scores may be, for example, generated via the trained behavioral model, and be identified with one or more of the plurality of trajectory predictions. For example, the certainty score(s) may be identified with the confidence scores and/or the Mahalanobis distance identified with the range of trajectory predictions, as discussed herein.

The process flow 2300 may include computing (block 2308) an uncertainty score. This uncertainty score may be, for example, computed periodically and/or in response to one or more conditions being met. Again, the uncertainty score may be identified with the uncertainty score U as discussed herein, which may be based upon the PDF of the trained behavioral model 1906. Thus, the computation of the uncertainty score may comprise computing, via the trained behavioral model, an uncertainty score that is indicative of a novelty of features obtained from the input data with respect to previous computations of trajectory predictions performed via the trained behavioral model.

The process flow 2300 may include executing (block 2310) a vehicle-based function in accordance with one of the plurality of trajectory predictions based upon the certainty score and the uncertainty score. This may include, for example, selecting a predicted trajectory in accordance with the certainty scores (e.g. one identified with the highest certainty score) and performing various vehicle-based actions based upon whether the uncertainty score exceeds a predetermined threshold value, as discussed herein.

### Examples

The following examples pertain to further aspects.

An example (e.g. example 1) relates to a method. The method comprises receiving input data comprising (i) one or more first images including static features that identify map data, and (ii) one or more second images including time-dependent features that identify a position and movement of one or more road agents over time; generating, via a trained behavioral model, a plurality of trajectory predictions for a target road agent from among the one or more road agents based upon the input data, each one of the plurality of trajectory predictions comprising a set of positions identified with a respective trajectory of the target road agent to follow over a period of time; generating, via the trained behavioral model, a certainty score identified with one or more of the plurality of trajectory predictions; computing, via the trained behavioral model, an uncertainty score that is indicative of a novelty of features obtained from the input data with respect to previous computations of trajectory predictions performed via the trained behavioral model; and executing a vehicle-based function in accordance with one of the plurality of trajectory predictions based upon the certainty score and the uncertainty score.

Another example (e.g. example 2) relates to a previously-described example (e.g. example 1), wherein the certainty score comprises a confidence score that is indicative of a likelihood of one or more respective ones of the plurality of trajectory predictions being selected based upon training data used to train the trained behavioral model.

Another example (e.g. example 3) relates to a previously-described example (e.g. one or more of examples 1-2), wherein the certainty score comprises a computed Mahalanobis distance identified with the plurality of trajectory predictions for the target road agent over the period of time.

Another example (e.g. example 4) relates to a previously-described example (e.g. one or more of examples 1-3), wherein the executing the vehicle-based function comprises executing a first vehicle-based function when the uncertainty score is higher than a predetermined threshold value, and executing a second vehicle-based function when the uncertainty score is less than the predetermined threshold value.

Another example (e.g. example 5) relates to a previously-described example (e.g. one or more of examples 1-4), wherein the uncertainty score is computed periodically in response to an expiration of a predetermined period of time.

Another example (e.g. example 6) relates to a previously-described example (e.g. one or more of examples 1-5), wherein the trained behavioral model comprises a Bayesian network architecture having a probability density function (PDF), and wherein the uncertainty score is computed based upon the PDF.

Another example (e.g. example 7) relates to a previously-described example (e.g. one or more of examples 1-6), wherein the trained behavioral model comprises an ensemble of likelihood models, each one of the likelihood models being configured to output, as a respective certainty score, a respective confidence score for each one of a set of trajectory predictions that include the plurality of trajectory predictions.

Another example (e.g. example 8) relates to a previously-described example (e.g. one or more of examples 1-7), wherein the trained behavioral model is configured to generate the plurality of trajectory predictions by selecting, from among the set of trajectory predictions, a predetermined number of trajectory predictions having a highest respective confidence score in the set of trajectory predictions.

Another example (e.g. example 9) relates to a previously-described example (e.g. one or more of examples 1-8), wherein the trained behavioral model is configured to generate the plurality of trajectory predictions by selecting, from among the set of trajectory predictions, a number of trajectory predictions based upon a Mahalanobis distance identified with one or more of the set of trajectory predictions.

Another example (e.g. example 10) relates to a previously-described example (e.g. one or more of examples 1-9), further comprising: selecting, based upon the uncertainty score, a subset of the plurality of trajectory predictions; and training a further behavioral model using the subset of the plurality of trajectory predictions.

An example (e.g. example 11) relates to a system. The system comprises a processor; and a memory configured to store instructions that, when executed by the processor, cause the system to: receive input data comprising (i) one or more first images including static features that identify map data, and (ii) one or more second images including time-dependent features that identify a position and movement of one or more road agents over time; generate, via a trained behavioral model, a plurality of trajectory predictions for a target road agent from among the one or more road agents based upon the input data, each one of the plurality of trajectory predictions comprising a set of positions identified with a respective trajectory of the target road agent to follow over a period of time; generate, via the trained behavioral model, a certainty score identified with one or more of the plurality of trajectory predictions; compute, via the trained behavioral model, an uncertainty score that is indicative of a novelty of features obtained from the input data with respect to previous computations of trajectory predictions performed via the trained behavioral model; and cause an execution of a vehicle-based function in accordance with one of the plurality of trajectory predictions based upon the certainty score and the uncertainty score.

Another example (e.g. example 12) relates to a previously-described example (e.g. example 11), wherein the certainty score comprises a confidence score that is indicative of a likelihood of one or more respective ones of the plurality of trajectory predictions being selected based upon training data used to train the trained behavioral model.

Another example (e.g. example 13) relates to a previously-described example (e.g. one or more of examples 11-12), wherein the certainty score comprises a computed Mahalanobis distance identified with the plurality of trajectory predictions for the target road agent over the period of time.

Another example (e.g. example 14) relates to a previously-described example (e.g. one or more of examples 11-13), wherein the instructions, when executed by the processor, cause the system to cause an execution of a first vehicle-based function when the uncertainty score is higher than a predetermined threshold value, and to cause an execution of a second vehicle-based function when the uncertainty score is less than the predetermined threshold value.

Another example (e.g. example 15) relates to a previously-described example (e.g. one or more of examples 11-14), wherein the instructions, when executed by the processor, cause the system to compute the uncertainty score periodically in response to an expiration of a predetermined period of time.

Another example (e.g. example 16) relates to a previously-described example (e.g. one or more of examples 11-15), wherein the trained behavioral model comprises a Bayesian network architecture having a probability density function (PDF), and
wherein the uncertainty score is computed based upon the PDF.

Another example (e.g. example 17) relates to a previously-described example (e.g. one or more of examples 11-16), wherein the trained behavioral model comprises an ensemble of likelihood models, each one of the likelihood models being configured to output, as a respective certainty score, a respective confidence score for each one of a set of trajectory predictions that include the plurality of trajectory predictions.

Another example (e.g. example 18) relates to a previously-described example (e.g. one or more of examples 11-17), wherein the instructions, when executed by the processor, cause the trained behavioral model to generate the plurality of trajectory predictions by selecting, from among the set of trajectory predictions, a predetermined number of trajectory predictions having a highest respective confidence score in the set of trajectory predictions.

Another example (e.g. example 19) relates to a previously-described example (e.g. one or more of examples 11-18), wherein the instructions, when executed by the processor, cause the trained behavioral model to generate the plurality of trajectory predictions by selecting, from among the set of trajectory predictions, a number of trajectory predictions based upon a Mahalanobis distance identified with one or more of the set of trajectory predictions.

Another example (e.g. example 20) relates to a previously-described example (e.g. one or more of examples 11-19), wherein the instructions, when executed by the processor, cause the system to: select, based upon the uncertainty score, a subset of the plurality of trajectory predictions; and train a further behavioral model using the subset of the plurality of trajectory predictions.

A method as shown and described.

An apparatus as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processing circuitry” or “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

1. A method, comprising:
receiving input data comprising (i) one or more first images including static features that identify map data, and (ii) one or more second images including time-dependent features that identify a position and movement of one or more road agents over time;
generating, via a trained behavioral model, a plurality of trajectory predictions for a target road agent from among the one or more road agents based upon the input data, each one of the plurality of trajectory predictions comprising a set of positions identified with a respective trajectory of the target road agent to follow over a period of time;
generating, via the trained behavioral model, a certainty score identified with one or more of the plurality of trajectory predictions;
computing, via the trained behavioral model, an uncertainty score that is indicative of a novelty of features obtained from the input data with respect to previous computations of trajectory predictions performed via the trained behavioral model; and
executing a vehicle-based function in accordance with one of the plurality of trajectory predictions based upon the certainty score and the uncertainty score.

2. The method of claim 1, wherein the certainty score comprises a confidence score that is indicative of a likelihood of one or more respective ones of the plurality of trajectory predictions being selected based upon training data used to train the trained behavioral model.

3. The method of claim 1, wherein the certainty score comprises a computed Mahalanobis distance identified with the plurality of trajectory predictions for the target road agent over the period of time.

4. The method of claim 1, wherein the executing the vehicle-based function comprises executing a first vehicle-based function when the uncertainty score is higher than a predetermined threshold value, and executing a second vehicle-based function when the uncertainty score is less than the predetermined threshold value.

5. The method of claim 1, wherein the uncertainty score is computed periodically in response to an expiration of a predetermined period of time.

6. The method of claim 1, wherein the trained behavioral model comprises a Bayesian network architecture having a probability density function (PDF), and wherein the uncertainty score is computed based upon the PDF.

7. The method of claim 1, wherein the trained behavioral model comprises an ensemble of likelihood models, each one of the likelihood models being configured to output, as a respective certainty score, a respective confidence score for each one of a set of trajectory predictions that include the plurality of trajectory predictions.

8. The method of claim 7, wherein the trained behavioral model is configured to generate the plurality of trajectory predictions by selecting, from among the set of trajectory predictions, a predetermined number of trajectory predictions having a highest respective confidence score in the set of trajectory predictions.

9. The method of claim 7, wherein the trained behavioral model is configured to generate the plurality of trajectory predictions by selecting, from among the set of trajectory predictions, a number of trajectory predictions based upon a Mahalanobis distance identified with one or more of the set of trajectory predictions.

10. The method of claim 1, further comprising:
selecting, based upon the uncertainty score, a subset of the plurality of trajectory predictions; and
training a further behavioral model using the subset of the plurality of trajectory predictions.

11. A system, comprising:
a processor; and
a memory configured to store instructions that, when executed by the processor, cause the system to:
receive input data comprising (i) one or more first images including static features that identify map data, and (ii) one or more second images including time-dependent features that identify a position and movement of one or more road agents over time;
generate, via a trained behavioral model, a plurality of trajectory predictions for a target road agent from among the one or more road agents based upon the input data, each one of the plurality of trajectory predictions comprising a set of positions identified with a respective trajectory of the target road agent to follow over a period of time;
generate, via the trained behavioral model, a certainty score identified with one or more of the plurality of trajectory predictions;
compute, via the trained behavioral model, an uncertainty score that is indicative of a novelty of features obtained from the input data with respect to previous computations of trajectory predictions performed via the trained behavioral model; and
cause an execution of a vehicle-based function in accordance with one of the plurality of trajectory predictions based upon the certainty score and the uncertainty score.

12. The system of claim 11, wherein the certainty score comprises a confidence score that is indicative of a likelihood of one or more respective ones of the plurality of trajectory predictions being selected based upon training data used to train the trained behavioral model.

13. The system of claim 11, wherein the certainty score comprises a computed Mahalanobis distance identified with the plurality of trajectory predictions for the target road agent over the period of time.

14. The system of claim 11, wherein the instructions, when executed by the processor, cause the system to cause an execution of a first vehicle-based function when the uncertainty score is higher than a predetermined threshold value, and to cause an execution of a second vehicle-based function when the uncertainty score is less than the predetermined threshold value.

15. The system of claim 11, wherein the instructions, when executed by the processor, cause the system to compute the uncertainty score periodically in response to an expiration of a predetermined period of time.

16. The system of claim 11, wherein the trained behavioral model comprises a Bayesian network architecture having a probability density function (PDF), and wherein the uncertainty score is computed based upon the PDF.

17. The system of claim 11, wherein the trained behavioral model comprises an ensemble of likelihood models, each one of the likelihood models being configured to output, as a respective certainty score, a respective confidence score for each one of a set of trajectory predictions that include the plurality of trajectory predictions.

18. The system of claim 17, wherein the instructions, when executed by the processor, cause the trained behavioral model to generate the plurality of trajectory predictions by selecting, from among the set of trajectory predictions, a predetermined number of trajectory predictions having a highest respective confidence score in the set of trajectory predictions.

19. The system of claim 17, wherein the instructions, when executed by the processor, cause the trained behavioral model to generate the plurality of trajectory predictions by selecting, from among the set of trajectory predictions, a number of trajectory predictions based upon a Mahalanobis distance identified with one or more of the set of trajectory predictions.

20. The system of claim 11, wherein the instructions, when executed by the processor, cause the system to:
select, based upon the uncertainty score, a subset of the plurality of trajectory predictions; and
train a further behavioral model using the subset of the plurality of trajectory predictions.
